(19) United States
(12) Patent Application Publication
(10) Pub. No.: US 2006/0148646 A1
(43) Pub. Date: Jul. 6, 2006

(54) Controlled release fertilizers containing calcium sulfate and processes for making same

(76) Inventors: Taylor Pursell, Birmingham, AL (US); Arthur R. Shirley JR., Florence, AL (US); Keith D. Cochran, Killen, AL (US); Timothy G. Holt, Florence, AL (US); Gregory S. Peeden, Killen, AL (US)

Correspondence Address: MANELLI DENISON & SELTER, 2000 M STREET NW SUITE 700, WASHINGTON, DC, 20036-3307, US

(21) Appl. No.: 11/231,946

(22) Filed: Sep. 22, 2005

Related U.S. Application Data
(60) Provisional application No. 60/612,175, filed on Sep. 23, 2004.

(51) Int. Cl. A01N 59/04; A01N 25/12

(52) U.S. Cl. 504/101; 504/367

(57) ABSTRACT

An extended release fertilizer that includes an absorbent material containing capillaries/voids between 10-200 microns in cross-sectional diameter which is impregnated in an amount of 40-95% of the capillaries/voids volume with an agriculturally beneficial material, or alternatively includes a holding agent retaining an agriculturally beneficial material, wherein the beneficial material at least includes calcium sulfate, and the beneficial material is selected from the group consisting of fertilizers, insecticides, herbicides and fungicides, with the resulting material being agglomerated into granules.

### BACKGROUND OF THE INVENTION

This invention relates to controlled release agricultural products that include various forms of calcium sulfate and processes for making such products.

Pollution is an ever increasing problem with respect to both air pollution and water pollution. Water pollution occurs when readily soluble fertilizer is solubilized and washed into streams during rains or is solubilized and is leached into the ground water before its intended target vegetation is able to capture. Failure to capture the fertilizer occurs because the target vegetation is not in need of it when it becomes soluble or because the leaching rate is too rapid. Some fertilizers, in particular urea, are lost to the atmosphere through volatilization where urea decomposes to ammonia, carbon dioxide, biuret, and other volatile compounds. Therefore, since the vast majority of fertilizer used has no controlled release properties because they are not available at a low cost, pollution problems are being caused by inefficient use of soluble and volatile fertilizers, which must be applied in excess amounts over the crop's need.

Those who are familiar with the production, storage, transportation, and application of fertilizers know that the nutrient concentration and the physical properties of a fertilizer are extremely important in its acceptance and use by the agricultural community.

Our invention provides a controlled release fertilizer that addresses the problems of production, storage, shipping, and application costs, as well as the need for moderation in the length of nutrient availability from slow and controlled release fertilizers. Our invention provides a process that produces a high analysis granular material at an extremely low production cost for a controlled release fertilizer. Concurrently, the invention provides a product with physical properties equal to and for the most part more desirable than commercially available urea.

There are many slow and extended release fertilizers with their nutrient release based on time and event related coating failures or coating permeability, and/or low solubility, and/or microbial activity in the soil, and/or a ratio of surface area to nutrient weight of the particle. The present invention employs the slow release characteristics of calcium sulfate in a fertilizer and in additional embodiments, in combination with and employing the slow release properties of a solubility inhibiting agent and/or a porous absorbent with or without an interspatial blocking composition.

### BRIEF SUMMARY OF THE INVENTION

The present invention is directed to extended or more generally, controlled release fertilizers that employ forms of calcium sulfate compounds. The fertilizers may advantageously include solubility inhibiting agents, and/or particulate, porous absorbents in particulate form and interspatial blocking agents in particulate or water insoluble form that provide for controlled release of agriculturally beneficial materials such as fertilizers, insecticides, herbicides and fungicides.

### BRIEF DESCRIPTION OF THE DRAWINGS

Further objects and advantages of the present invention will be better understood by carefully reading the following detailed description of the presently preferred exemplary embodiments of this invention in conjunction with the accompanying drawings, of which:

FIG. 1 is a flow chart showing one embodiment of the process of the present invention wherein a controlled release agricultural absorbent based product is produced containing fertilizer and a gel forming interspatial blocker.

FIG. 2 is a photomicrograph showing expanded perlite wherein the particles appear to be covered with a thin shell.

FIG. 3 is a photomicrograph showing exfoliated perlite wherein the internal capillaries and voids are exposed.

FIG. 4 is a photomicrograph showing the exfoliated perlite of FIG. 3 at higher magnification to observe the greater exposure of internal capillaries and voids.

FIG. 5 is a photomicrograph showing the expanded perlite of FIG. 2 at the higher magnification as in FIG. 4 in order to compare the relatively closed surface compared to the exfoliated perlite of FIG. 4.

FIG. 6 shows results of grass color measurement for tests described in Example 19.

FIG. 7 shows results of grass nitrogen uptake for tests described in Example 19.

FIG. 8 shows results of grass injury measurement for tests described in Example 20.

### DETAILED DESCRIPTION OF THE INVENTION

The present invention includes the composition, production and use of controlled release fertilizers, including slow release fertilizers, that contain forms of calcium sulfate, such as calcium sulfate dihydrate (i.e. gypsum, (CaSO₄.2H₂O)), anhydrous calcium sulfate (CaSO₄), and hemihydrate calcium sulfate (CaSO₄.0.5H₂O). The present fertilizers are generally produced by a granulation process employing at least one of CaSO₄, CaSO₄.0.5H₂O, and CaSO₄.2H₂O with or without the use of such slow release additives as starch and/or other blocking or binding additives; with or without the use of absorbent particles such as perlite (either expanded or expanded-exfoliated); and fertilizer nutrients including at least one of nitrogen (N), phosphorus (P), potassium (K), and sulfur (S), with or without minor nutrients (micro and macro nutrients). The composition of the invention also includes micronutrients, secondary nutrients, growth regulators, nitrification regulators, as well as insecticides, herbicides and fungicides. Thus, the composition of the present invention includes an agriculturally beneficial material, at least including calcium sulfate with the beneficial material being selected from the group consisting of fertilizers, insecticides, herbicides and fungicides.

The nitrogen compounds include ureaform, water soluble urea formaldehyde polymer, water insoluble urea formaldehyde polymer, methylene urea, methylene diurea, dimethylenetriurea, urea formaldehyde, urea, ammonia, ammonium nitrate, ammonium sulfate, calcium nitrate, diammonium phosphate, monoammonium phosphate, potassium nitrate and sodium nitrate. The phosphorous compounds include diammonium phosphate, monoammonium phosphate, calcium phosphate, dicalcium phosphate, monopotassium phosphate, dipotassium phosphate, tetrapotassium pyrophosphate, and potassium metaphosphate. The potassium compound includes potassium chloride, potassium nitrate, potassium sulfate, monopotassium phosphate, dipotassium phosphate, tetrapotassium pyrophosphate, and potassium metaphosphate.

When using ammonium sulfate ((NH₄)₂SO₄) as the primary nutrient source, granulation is possible up to 80% slurries of (NH₄)₂SO₄ with gypsum concentration from 5 to 25% and provides a slow release fertilizer product with increase of extended release of 25% more than that achieved when using urea.

The present invention includes controlled release fertilizers containing various mixtures of nitrogen, phosphorus, and potassium as well as incorporation of various secondary nutrients (e.g. sulfur, calcium, and magnesium) and micronutrients (e.g. boron, copper, iron, manganese, molybdenum, zinc) if not all of the secondary and micronutrients, and secondary and micronutrients as well as growth regulators such as, but not limited to, potassium azide, 2 amino-4-chloro-6-methylpyrimidine, N-3, 5-dichlorophenyl succinimide, 3-amino-1,2,4-triazole and nitrification regulators such as, but not limited to, 2-chloro-6-(trichloromethyl)pyridine, sulfathiazole, dicyandiamide, thiourea, and guanylthiourea.

In further embodiments of this invention, insecticides such as 0,0-diethyl O-(2-isopropyl-6 methyl-4 pyrimidinyl) phosphorothioate), herbicides such as 2,4-dichlorophenoxyacetic acid, fungicides such as ferric-di-methyl-dithiocarbamate, growth regulators such as gibberellic acid, and other agricultural chemicals such as methiocarb can be added to obtain controlled release characteristics to a complete set of a crop's chemical and nutrient needs.

A solubility inhibiting agent that may also act as a chemical holding substance can be added to the composition of the present invention, with or without absorbent particles, for enhanced slow release properties. Such agents include plant starches, protein gels and glues, gumming products, crystallizing compounds, gelling clays, and synthetic gel forming compounds also work as the gelling and/or inter-spatial blocking compound. These include but are not limited to the following: rice starch, potato starch, wheat starch, tapioca starch, and any starch which contains the D-glucopyranose polymers, amylose and amylopectin; modified starch of the former listing (also including corn starch) by acetylation, chlorination, acid hydrolysis, or enzymatic action which yield starch acetates, esters, and ethers; starch phosphate, an ester made from the reaction of a mixture of orthophosphate salts (sodium dihydrogen phosphate and disodium hydrogen phosphate) with any of the listed (also including corn starch) starch/or starches; gelatin as made by hydrolysis of collagen by treating raw materials with acid or alkali; glue as made from any of the following: collagen, casein, blood, and vegetable protein such as that of soybeans; gumming products such as cellulosics, rubber latex, gums, terpene resins, mucilages, asphalts, pitches, hydrocarbon resins; crystallizing compounds such as sodium silicate, phosphate cements, calcium-oxide cements, hydraulic cements (mortar, gypsum); gelling clays in the form of very fine powders; synthetic gel forming compounds such as polysulfide sealants, polyethylene, isobutylene, polyamides, polyvinyl acetate, epoxy, phenolformaldehyde, urea formaldehyde, polyvinyl butyral, cyanoacrylates, and silicone cements. Plant starches are particularly preferred, especially corn and wheat starches.

When CaSO₄ is employed and the hydration properties of CaSO₄.0.5H₂O, and CaSO₄.2H₂O are not required, then inorganic additives may be added, including the following: finely ground limestone, fine sand, clays, and various other fine soils or minerals.

In the compositions of the present invention, calcium sulfate is present in amounts of 1-50% wt, preferably in amounts of 10-40% wt, and most preferably in amounts of 15-35% wt.

The absorbent particles are composed of particles of at least one of perlite, ground-up paper waste, diatomaceous earth, bark, peat moss, and other similar absorbent materials.

The fertilizer nutrients are employed in the granulation process in melt, slurry, or solution form. Granulation can be performed using various techniques such as prilling, fluid-bed granulation, pan granulation, drum granulation, extrusion, pin-mill granulation, pugmill granulation, and forming techniques with and without milling through the use of agglomeration, accretion, pressure formation, solidification, and controlled drying. The foregoing granulation and forming processes can be performed with or without the steps of screening, recycling, and/or milling.

Particularly significant embodiments of the invention are enhanced slow release fertilizers employing absorbent particulates and are composed of starch, perlite, and urea with or without monoammonium phosphate (MAP), diammonium phosphate (DAP), and potassium chloride (KCl) and contain CaSO₄.2H₂O at concentrations of 2% to 75% of the final product and preferably at concentrations of 6% to 23% of the final product.

The process of the present invention makes use of the characteristic of CaSO₄.2H₂O wherein that when employing urea in the composition of the invention, and granulating a urea melt at a temperature of 262° F. and above, the CaSO₄.2H₂O loses 1.5 moles of water. This results in the viscous suspension of the urea melt becoming much less viscous and more sprayable, thus assisting granulation. Once the composition is cooled below about 257° F. when using commercial fertilizer grade urea and 10% CaSO₄.2H₂O, the mixture solidifies with reformation of a hydrate, helping to harden the resulting granules. This step can be done without significant damage to other possible components of the composition, such as starch, nor result in unacceptable amounts of biuret formation of the urea. Further, if the composition contains an absorbent such as perlite, then this step does not affect absorption into the perlite by the starch and urea mixture, which are already in the mixture prior or after the introduction of the CaSO₄.2H₂O. In general, the agriculturally beneficial material is in a solution (e.g. aqueous) or molten state and at least includes a form of calcium sulfate.

When either (1) KCL or (2) potassium nitrate (KNO₃) are added to urea melt, the melting point is depressed; however, when CaSO₄.2H₂O is added to one of theses mixtures, 1.5 moles of water are released from the CaSO₄.2H₂O at a lower temperature than 262° F., further lowering the melting point because of the water release. Thus, when KCL is added to fertilizer grade urea at 6.7%, the melting point is lowered to 240° F. When CaSO₄.2H₂O is added to the melt in an amount of 10% of the resulting mixture without further heating, it loses hydrated water to the mixture, thus lowering the melting point of the mixture to 226° F. In a similar manner, when KNO₃ is added to fertilizer grade urea at 25%, it lowers the melting point to 230° F. When CaSO₄.2H₂O is added to the melt in an amount of 10% of the resulting mixture, it loses hydrated water to the mixture, thus further lowering the melting point to 205° F. When potassium sulfate (K₂SO₄) is added to fertilizer grade urea at its level of solubility of 3.7%, the resulting melting point is 266° F. The addition of CaSO₄.2H₂O to the mixture, in an amount of 10%, lowers the melting point of the mixture to 254° F. Performing the process at lower temperatures allows incorporation of other ingredients into the melt at temperatures below their level of sensitivity toward degradation while still using the extra water to provide enhanced fluidity (lower viscosity) to the mixture. This allows better spray and pour type granulation and provides enhanced product characteristics of hardness and extended release when the product granules are produced. Such beneficial product characteristics are provided without extra drying because the water of hydration released by the CaSO₄.2H₂O recombines to form a hydrate during granulation.

Absorbent Controlled Release Fertilizer

Controlled release fertilizer embodiments of the present invention are particularly effective by inclusion of particles of an absorbent material. Such absorbent controlled release fertilizers are described, for example, in U.S. Pat. No. 6,890,888.

The absorbent based fertilizers includes particles of an absorbent material containing capillaries/voids between 10-200 microns in cross-sectional diameter which is impregnated in an amount of 40-95% of the capillaries/voids volume with an agriculturally beneficial material selected from the group consisting of fertilizers, insecticides, herbicides and fungicides. The absorbent material includes for example, expanded perlite, shredded newspaper, saw dusts, cotton lint, ground corn cobs, corn cob flower, Metrecz absorbent and diatomaceous earth.

The fertilizer includes nitrogen compounds, phosphorous compounds and potassium compounds. The nitrogen compounds include urea, ammonia, ammonium nitrate, ammonium sulfate, calcium nitrate, diammonium phosphate, monoammonium phosphate, potassium nitrate and sodium nitrate. The phosphorous compounds include diammonium phosphate, monoammonium phosphate, monopotassium phosphate, dipotassium phosphate, tetrapotassium pyrophosphate, and potassium metaphosphate. The potassium compound includes potassium chloride, potassium nitrate, potassium sulfate, monopotassium phosphate, dipotassium phosphate, tetrapotassium pyrophosphate, and potassium metaphosphate.

The agriculturally beneficial material also includes micronutrients, secondary nutrients, growth regulators, nitrification regulators, as well as the aforementioned insecticides, herbicides and fungicides.

The particles of absorbent may be agglomerated into granules of a predetermined size.

An important embodiment of the invention is the impregnation of the particle absorbent with a mixture of an interspatial blocker and the agriculturally beneficial material. The interspatial blocker includes plant starches, protein gels, glues, gumming compositions, crystallizing compounds, gelling clays, and synthetic gel forming compounds. The interspatial blocker may also be a combination of soluble and insoluble ureaform with or without one or more other blockers wherein the ureaform includes water soluble urea formaldehyde polymers, water insoluble urea formaldehyde polymers, methylene urea, methylene diurea, dimethylenetriurea and urea formaldehyde. The presence of the interspatial blocker acts to regulate the release of the agriculturally beneficial material and some blockers may themselves be an agriculturally beneficial material, e.g. starch providing a carbohydrate source for soil microbes and ureaform providing a source of nitrogen for plants.

The term “NUREA” is employed in this application and refers to the controlled release granule product of the present invention comprising perlite, urea and starch. The term “NPK” refers to the constitutents of nitrogen, phosphorus and potassium.

Techniques have been developed to utilize innovative means to provide deep penetration and extensive absorption of an agriculturally beneficial material into the absorbent material. Where this absorbed material contains plant nutrient, the result is a fertilizer with controlled nutrient release characteristics. In most cases, we have been able to further enhance the retention of the nutrient within the absorbent through use of an interspatial blocker such as a gelling compound, which helps further trap the nutrient within the small capillaries and voids of the absorbent material. We have tried many absorbents and methods of absorption, along with several gel forming materials, with varying levels of controlled nutrient release. We have been the most successful where the absorbents are extremely absorbent which results in a relatively dense concentration of nutrient. For testing and development purposes, urea was selected as representative of nutrient/fertilizer agriculturally beneficial materials. It was the nutrient most tested. Best results have been achieved when using perlite as the absorber, although milled newspaper and fine pine sawdust have been very good as absorbents. Utilizing cornstarch as the interspatial blocker (a gelling substance) has improved controlled nutrient release.

Those who are familiar with the production, storage, transportation, and application of fertilizers know that the nutrient concentration and the physical properties of a fertilizer are extremely important in its acceptance and use by the agricultural community.

Our invention addresses the problems of production, storage, shipping, and application costs, as well as the need for moderation in the length of nutrient availability from slow and controlled release fertilizers. It provides a process that produces a high analysis granular material, for example 40 to 45% by weight nitrogen when using perlite and urea, with or without corn starch, at an extremely low production cost for a controlled release fertilizer. Concurrently, the invention provides a product with physical properties equal to and for the most part more desirable than commercially available urea.

The nutrient strength of commercial urea is commonly recognized as 46-0-0, which is 46% nitrogen. The most common slow release nitrogen, sulfur coated urea, varies from 32% nitrogen to 38% nitrogen depending on its size and the thickness of the coating it is given to obtain the desired release rate. Therefore, substantially more weight (typically 28% more) of sulfur coated urea is required to provide the same amount of nutrient. When this property of a fertilizer is coupled with the physical property commonly called bulk density, which is the amount of weight which occupies a unit of volume, e.g. lbs/ft³, then we have the full impact on the cost of storage and distribution of the fertilizer. In the case of urea and sulfur coated urea, the bulk density is about the same at 45 to 46 lb/ft³.

To achieve a fertilizer which will be accepted by the agricultural community as a replacement for urea and sulfur coated urea, we have developed products which approach the bulk density and exceeds the crushing hardness of urea. Handling characteristics are much better than for sulfur coated urea. Handling and storage do not affect the controlled release properties of our product, but they can, for example, crack the coating of sulfur coated urea. Our particulate absorbent (w/ or w/wo blocker) product+Ureaform product varies in nitrogen strength from 40.0% nitrogen to 45.0% nitrogen. At the same time we had been able to perfect the nutrient absorption and granule forming aspects of the product such that bulk densities have been achieved from 25 lb/ft³ to 43 lb/ft³, with a more preferred range being 35 lb/ft³ to 46 lb/ft³ and the most preferred range being 38 lb/ft³ to 46 lb/ft³. The concentrations of nitrogen using urea and perlite and those bulk densities of final product have been achieved in a laboratory and a pilot plant while maintaining the controlled release properties of the fertilizer. In using larger equipment, as in a full scale plant, with the techniques taught herein, the bulk density is 46 lb/ft³, the same as that of urea and sulfur coated urea while maintaining 44% nitrogen content of the fertilizer and the controlled release aspects of our product.

Several innovative methods were developed to increase the density of the resulting controlled release fertilizer. Such methods provide a superior, concentrated product, having improved handling characteristics and controlled release properties. The product should have a bulk density approaching that of urea to provide economics of storage, transportation and distribution near or equal to those of urea.

In one embodiment of the present invention, our dense, concentrated product is accomplished by the following important features: 1) already expanded perlite is further steam exfoliated beyond its normal popped form to allow better penetration and filling of its interspatial regions by the urea/corn starch mixture; 2) urea/corn starch melts are maintained around 95 to 98% concentration to minimize voids formed from evaporation during the processing; and 3) the small perlite particles containing urea/corn starch are granulated together to form dense, spherical particles.

In general, the process involves taking a proper absorbent material and a fertilizer melt or solution and absorbing the fertilizer melt or solution (which is in a dense saturation state) into the absorbent material and then solidifying the fertilizer within the voids of the absorbent such that it is difficult for the fertilizer to be released by the absorbent when in contact with water or humid conditions. This is done by utilizing a very absorbent material with small capillaries and/or voids and accomplishing the absorbance by keeping the fertilizer and the absorbent above the fertilizer's initial crystallization temperature and at viscosities where capillary action easily occurs while absorption is occurring. For improvements in controlled release characteristics, an interspatial blocker, such as starches and/or other gelling compounds are homogenized into the fertilizer melt or solution before the absorption step of the process. When solidified, these gelling compounds tend to help trap the soluble fertilizer nutrients within the capillaries and/or internal voids of the absorbent. Following absorption and prior to crystallization of the fertilizer melt or solution within the absorbent, the liquid filled absorbent is mixed with recycled material, previously crystallized, to solidify and granulate the liquid filled absorbent with the recycled material through cooling and/or drying, at least partially, imparted by these recycled materials within a pugmill, drum, rotating pan, fluid-bed, or similar standard granulation equipment or combination of standard granulation equipment. Before being stored as product, the granulated solids are milled, screened, further cooled and dried, but not necessarily in that order, by any of the obvious ways before sending the product to storage. The material also is easily prepared using the solids forming techniques which do not use recycle of solid particles for cooling, such as slating, prilling, rotoforming, low pressure extrusion, molding, and forming of bulk slabs or molded shapes. As needed, any of these methods can involve milling of the obtained solids with screening and further cooling and drying as needed with fines recycled to the starting melt or solution filled absorbent for inclusion in the solidification process. The cooling and drying can be accomplished by the use of most all standard methods presently known in the art of granulation including, but not limited to direct gas contact, vacuum enhanced evaporation, and indirect heat exchange.

In important embodiments of the present invention, ureaform is a constituent that is present in small to large proportion, depending upon the degree of slow release desired. In general, ureaform consists of those compounds produced by reacting urea with formaldehyde. The particular compounds will be determined by specific amounts of starting materials and reaction conditions. Ureaform typically contains about 35-45% nitrogen. A particularly important type of ureaform are polymers of methylene urea. While a significant portion of ureaform is insoluble, nitrogen is released gradually from ureaform by microbial activity in the soil, thus providing a slow release fertilizer. Other ureaforms include water soluble urea formaldehyde polymer, water insoluble urea formaldehyde polymer, methylene diurea, dimethylenetriurea and urea formaldehyde.

Ureaforms can exist as 100% water soluble urea formaldehyde polymers or 100% water insoluble urea formaldehyde polymers. Commercially available ureaform is often available wherein about 65-75% of ureaform will be water insoluble, generally depending upon the length of the resulting polymers of ureaform with the remaining 25-35% of ureaform being water soluble. However, in the present invention, specific amounts of water soluble urea formaldehyde polymers and water insoluble urea formaldehyde polymers are either individually or in combination, incorporated into the particulate absorbent of this invention, with or without blocker, for an effective controlled release fertilizer. Urea formaldehyde polymers may be employed as slow release fertilizer products having release rates of 90 to 120 days or longer.

In the present invention, water soluble urea formaldehyde polymers are added to the particulate absorbent of this invention (w/ or w/o blocker) at weight percentages of 1 to 50% wt. The preferable weight percentage is from 5 to 40% wt. The most preferable weight percentage is from 7 to 13% wt.

In the present invention, water insoluble urea formaldehyde polymers are added to the particulate absorbent of this invention (w/ or w/o blocker) at weight percentages of 1 to 50% wt. The preferable weight percentage is from 0.5 to 40.0%. The most preferable weight percentage is from 5 to 25%.

The following techniques are employed as methods to make particulate absorbent (w/ or w/o blocker) plus ureaform products by incorporating urea formaldehyde polymers into particulate absorbent (w/ or w/o blocker) compositions.
1. Absorption—Urea formaldehyde polymers are absorbed into the perlite (or other absorbent) or absorbed and interstitially blocked with starch (or other blocker(s)). The urea formaldehyde polymers are thus added to the absorbent during the absorbent step before granulation into the granule product.
2. Granulation—Urea formaldehyde polymers are added into the particulate absorbent (w/ or w/o blocker) production process after the absorption step but prior to the granulation step such that the urea formaldehyde polymer is not absorbed into the perlite but is incorporated during granulation into the granule product. Particulate compositions of this invention containing urea, cornstarch, and urea formaldehyde polymer are alternatively granulated into a granule product, without perlite.
3. Surface application—Urea formaldehyde polymers are added to the surface of the granule product after granulation, as a coating to the granules. The ureaform coating is water insoluble urea formaldehyde polymers having a coating thickness of 0.005 to 11.0 mm and the coating is 1-30% wt and preferably 2-10% wt.

Other nutrient fertilizers which can be used to provide controlled release fertilizer include, but are not limited to the following; ammonia, ammonium nitrate, ammonium sulfate, calcium nitrate, diammonium phosphate, monoammonium phosphate, potassium chloride, potassium nitrate, potassium sulfate, potassium phosphates, such as monopotassium phosphate, dipotassium phosphate, tetrapotassium pyrophosphate and potassium metaphosphate, calcium phosphate, dicalcium phosphate, and sodium nitrate and combinations of these materials. The urea melt is maintained between 40% and +99.9% by weight urea; however, a preferred range of the melt would be between 65% and +99.9% and a most preferred range between 75% and +99.9% by weight urea. To provide other controlled release fertilizer, one or more other nutrient materials other than urea can be absorbed as long as the nutrients are in the fluid phase by being pure melt or by being solubilized in water or in the melt of another nutrient or combination of nutrients and/or water. For example, a full NPK fertilizer can be made by using urea, monoammonium phosphate, diammonium phosphates, and potassium chloride in various proportions and concentrations, and then blending the product with a filler to provide, for example, 29-3-4, 16-4-8, 10-10-10, 15-5-10, 15-0-15, 22-3-14, 20-28-5, and 12-6-6 control release fertilizers. Further, the nutrients can be in the fluid phase by being in a volatile substance such as e.g. ethanol or methanol as the solvent, which can be evaporated out as the material is solidified and dried. In the above manner, it is possible to prepare controlled release fertilizers containing various mixtures of nitrogen, phosphorus, and potassium as well as incorporation of various secondary nutrients (e.g. sulfur, calcium, and magnesium) and micronutrients (e.g. boron, copper, iron, manganese, molybdenum, zinc) if not all of the secondary and micronutrients, and secondary and micronutrients as well as growth regulators such as, but not limited to, potassium azide, 2 amino-4-chloro-6-methylpyrimidine, N-3,5-dichlorophenyl succinimide, 3-amino-1,2,4-triazole and nitrification regulators such as, but not limited to, 2-chloro-6-(trichloromethyl)pyridine, sulfathiazole, dicyandiamide, thiourea, and guanylthiourea.

The controlled release absorbent particles are small and must be granulated for most commercial application. It is possible to granulate the filled absorbent particles either in their liquid filled or solidified condition with other non-absorbed materials to give controlled release properties to only that portion of the material contained in the absorbent.

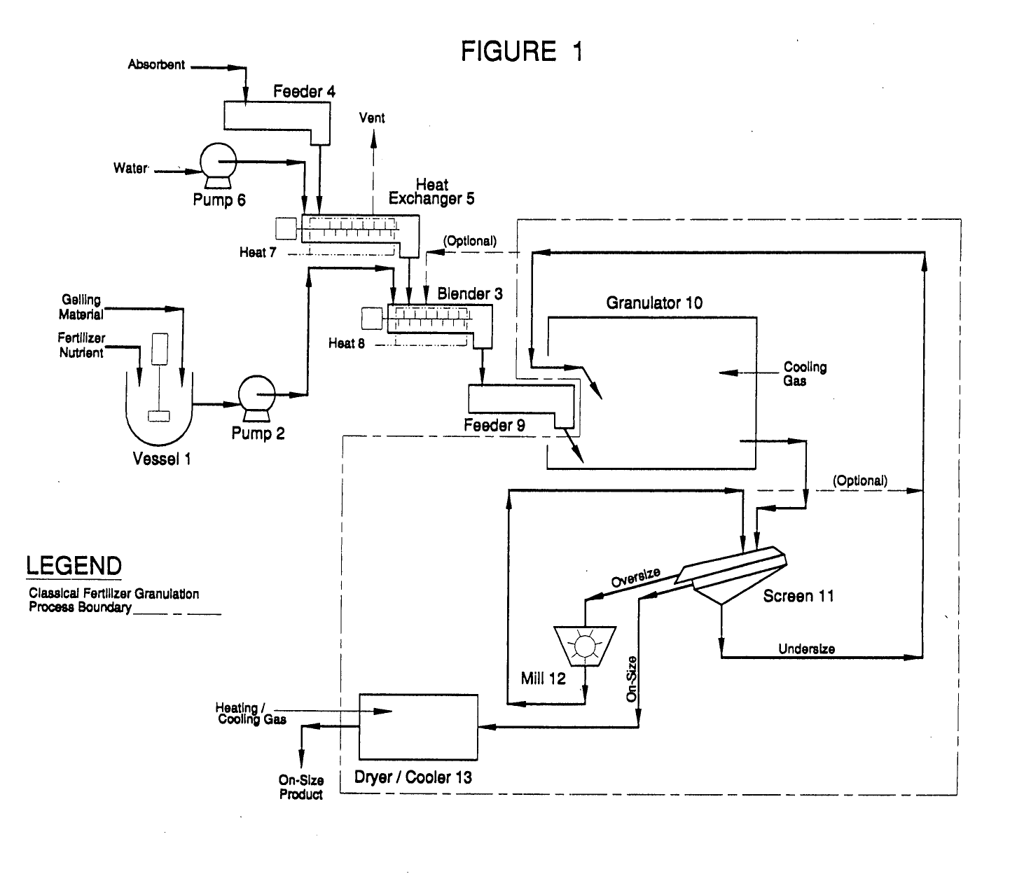

See FIG. 1 for a flow diagram of one embodiment of the processes of our invention. The blending of cornstarch and urea, if needed, is done through the use of high shear agitation provided by a homogenizer. The cornstarch addition in tests carried out in the laboratory and pilot plant has worked well. Cornstarch addition can range from 0.01 to 20% by weight cornstarch, with the preferred range being from 0.2 to 10% by weight cornstarch and the most preferred range being from 0.5 to 4% by weight cornstarch. The homogenized mixture is mixed (poured not sprayed) gently with the exfoliated and/or expanded perlite at near the full absorbing capability of the perlite, which is approximately 4 to 7.5% for our exfoliated perlite, by weight of the final product; thus the absorbed urea and cornstarch makes up approximately 95% of the weight of the final product. Prior to the mixing, the exfoliated and/or expanded perlite is preheated significantly above the melt temperature to prevent premature freezing of the melt before full penetration into the perlite. Preheating expanded perlite to temperatures as high as 330° F. has been successful. Preheating of the perlite is desirable but we have made a good product just by keeping the mixture of perlite and melt above the melting point of the urea melt or solution while absorption is occurring. Although full absorption of the urea and fertilizer into the exfoliated perlite or other absorbent is the preferred manner for most products, a reduction in the absorbance will provide a material with less release extension and can be desirable for some fertilizers.

We have been successful by 1) submerging preheated exfoliated and/or expanded perlite in an excessive amount of homogeneous urea/corn starch melt or urea melt, and then extracting the fully absorbed particle from the homogeneous melt for granulation; 2) pouring the homogeneous urea/cornstarch melt or urea melt into the preheated exfoliated and/or expanded perlite with gentle mixing until the absorbing capacity of the perlite is obtained before granulation; or 3) in mixing simultaneously metered amounts of exfoliated and/or expanded perlite and urea/cornstarch melt or urea melt and blending them together with gentle mixing while maintaining the melt and perlite above the solidification point of the melt before granulation. Then for all three methods of blending, the resulting blended material is added directly to a pan/drum granulator or pugmill, with recycle and allowed to agglomerate and solidify into granules or is premixed with or without recycle before adding it to the pan/drum. The resulting granules are screened and the oversize is milled and recycled to the screen. The undersize is recycled back to the granulator where it is agglomerated with the incoming mixed material. In another option, we have been successful in returning the oversize directly to the perlite urea/corn starch mixing step, Vessel 2. Steam can be used to enhance granulation, but our laboratory tests have not shown this is required. The product granules are quickly and easily dried in a pilot plant or laboratory fluid-bed operating with approximately 190° F. entering air. The dried granules are then cooled and conditioned against caking, if necessary, before going to storage.

All of the exfoliated and/or expanded perlites we have used have worked well. The inside microstructure of an exfoliated and/or expanded perlite particle is comparable to a honeycomb type arrangement; the individual cells indicate diameters of 10 to 200 micron, with a preferred range being 25 to 150 microns, and the most preferred range being 40 to 100 microns. As such, the exfoliated and/or expanded perlite used can have a loose weight density of from 2 to 20 lb/ft³ with a preferred range of 2 to 10 lb/ft³ and a most preferred range of 2 to 6 lb/ft³.

One skilled in the art readily will see that the agglomeration and otherwise granule forming, drying, milling, and screening portions of the process are similar to that of a pan/drum agglomeration type granulation process and that of a fluid-bed or prilling granulation process and as such the innovative portion of our process can be easily incorporated into existing and idle fertilizer granulation plants. See the dashed line enclosure of FIG. 1 for the existing plant equipment. Tests have shown that drying can be performed at lower temperatures and without the use of fluid-beds, e.g. within a standard rotary drying drum. The milling step which is obviously forbidden in coated products appears to have no significant adverse effect on the controlled release characteristics of this new invention when milling uses a knife bladed hammer mill similar to those used in large urea granulation plants.

For the most economical process, it is preferred to have the urea as a melt of concentration around 78 to 85%. The urea can be taken directly from the urea synthesis plant and does not need to pass through an evaporator, concentrator per the normal route toward granulation or prilling, hence biuret formation which occurs in the normal granulation urea process of melt concentration and then granulation at high temperatures is avoided. Further, the added costs for production of a controlled release urea fertilizer over that of just urea granules is only the cost of the perlite and, if used, the cornstarch or other gelling additive, and the cost of mixing them with the urea. However for more dense products with enhanced controlled nutrient release characteristics, and the use of less absorbent, we teach the use of higher concentration melts up to 99.9% melt.

The products made by our invention continue to retain excellent handling characteristics with regard to hardness and abrasion resistance and can be made in all size ranges desired by the lawn and garden users as well as the agricultural users. In some cases, by using 78% to 85% by weight urea melt, we can achieve better penetration of the cornstarch within the capillaries and voids of the absorbent material than with +99.9% melt. This increased penetration is apparently due to several reasons; among them lower viscosity of the homogeneous mixture, almost no foaming of the mixture with cornstarch during processing, and reduced pre-gelling of the cornstarch prior to entrance into the exfoliated and/or expanded perlite. When the absorption is done without cornstarch or any additive absorbed into the perlite using the same methods as with cornstarch, significant reductions in controlled release characteristics occur.

All absorbents will not work; it now appears that only those with capillaries and voids between 10 and 200 microns in cell diameter can be used. Further it appears that others, which may work from a controlled release standpoint, have much too small an absorbing capacity, greatly diluting the nutrient content of the fertilizer particle and thus increasing the cost.

In our work to date we have made granular-product of a size from 1 mm to 4 mm; however, we have made granules ranging in size from 0.20 mm to 25 mm. These larger and smaller granules have control release properties and product of this size can be made with only a change in the process screen size. It is preferable to have granules of about 0.20 mm when producing a product to be used on golf greens. The 25 mm product would be used in rice patties. The most useful range for lawns and most agriculture is 1 mm to 4 mm granules. Material with a size of 6 mm to 8 mm will be useful for forestry fertilization.

The urea used can contain normal conditioning additives like formaldehyde, previously reacted urea formaldehyde, clays, ligno products, or parting agents. The presently produced product has shown some excellent handling characteristics. Unlike some controlled release products, it has little tendency to float and it can be blended with most other fertilizers or used directly without blending.

We have successfully made a product using urea melt concentrations up to +99.9% urea melt without cornstarch addition, but at a loss of some controlled release characteristics and some good physical properties because of the absence of the corn starch. Further processing at above about 98% urea concentration leads to excessive formation of biuret, a compound which is undesirable to many agricultural users because of its toxic properties with some crops, in particular, citrus crops. This requires preheating and/or keeping the absorbent above the solidification point of the urea melt and preferably about 20 to 30° F. above that point.

In our work along with the granulation process techniques otherwise mentioned, we have experienced success in making the controlled release absorbent based product when using a compaction step, by making a homogenous mixture of cornstarch and urea, or using just urea and then mixing the mixture with the perlite or other absorbents, i.e. shredded newspaper, various saw dusts, cotton lint, ground corn cobs, corn cob flower, Metrecz absorbent, diatomaceous earth, and others. Then we solidify the material by pouring it out on a flat metal sheet to cool. Following this, the product is milled to the desired particle size; however, when employing a compaction step it is typically milled and compacted into the desired particle size. The controlled release characteristics of the product are usually reduced by the compaction step.

Many other pure nutrients and combination of nutrients can be made utilizing the process techniques taught by our disclosure.

In further embodiments of this invention, insecticides such as 0,0-diethyl O-(2-isopropyl-6 methyl-4 pyrimidinyl) phosphorothioate), herbicides such as 2,4-dichlorophenoxyacetic acid, fungicides such as ferric-di-methyl-dithiocarbamate, growth regulators such as gibberellic acid, and other agricultural chemicals such as methiocarb can be added during the absorption phase of this process to obtain controlled release characteristics to a complete set of a crop's chemical and nutrient needs. Table 1 includes some more of these chemicals, but those that can be added to the product during the absorption phase are not limited by this list.

TABLE 1
CHEMICAL NAME

2-(2-Methyl-4-chlorophenoxy)propionic acid
2-Methyl-4-chlorophenoxyacetic acid
3,6-Dichloro-o-anisic acid
Pyrethrins
2-chloro-4-ethylamino-s-triazine
Benefin: N-butyl-N-ethyl-alpha,alpha,alpha,trifluoro-
2,6-dinitro-p-toluidine
Trifluralin: alpha,alpha,alpha,trifluoro-2,trifluoro-
2,6-dinitro-N,N-dipropyl-p-toluidine
Dithiopyr 3,5-pyridenedicarbothiocic acid,2-
(difluoromethyl)-4-(2-methylpropyl)-6-(trifluoromethyl)-S,S-
dimethyl ester
Chlorpyrifos[O,O-diethyl-O-(3,5,6-trichloro-2-
pyridyl)phosphorothioate
O,O-Diethyl S-(2-(ethylthio)ethyl)phosphorodithioate
(2,2,2-trichloro-1-hydroxethyl)phosphonate
1-((6-chloro-3-pyridinyl)methyl)-N-nitro-2-
imidazolidinimine
Cyano(4-fluoro-3-phenoxyphenyl)methyl 3-(2,2-
dichloroethenyl)-2,2-dimethylcyclopropane carboxylate
(2,4,6,8-tetramethyl-1,3,5,7-tetraoxycyclo-octane)
Prodiamine,(N3,N3-Di-n-propyl-2,4-nitro-
6(trifluoromethyl)-m-phenylenediamine)

Other plant starches, protein gels and glues, gumming products, crystallizing compounds, gelling clays, and synthetic gel forming compounds also work as the gelling and/or inter-spatial blocking compound. These include but are not limited to the following: rice starch, potato starch, wheat starch, tapioca starch, and any starch which contains the D-glucopyranose polymers, amylose and amylopectin; modified starch of the former listing (also including corn starch) by acetylation, chlorination, acid hydrolysis, or enzymatic action which yield starch acetates, esters, and ethers; starch phosphate, an ester made from the reaction of a mixture of orthophosphate salts (sodium dihydrogen phosphate and disodium hydrogen phosphate) with any of the listed (also including corn starch) starch/or starches; gelatin as made by hydrolysis of collagen by treating raw materials with acid or alkali; glue as made from any of the following: collagen, casein, blood, and vegetable protein such as that of soybeans; gumming products such as cellulosics, rubber latex, gums, terpene resins, mucilages, asphalts, pitches, hydrocarbon resins; crystallizing compounds such as sodium silicate, phosphate cements, calcium-oxide cements, hydraulic cements (mortar, gypsum); gelling clays in the form of very fine powders; synthetic gel forming compounds such as polysulfide sealants, polyethylene, isobutylene, polyamides, polyvinyl acetate, epoxy, phenolformaldehyde, urea formaldehyde, polyvinyl butyral, cyanoacrylates, and silicone cements. Plant starches work particularly well, especially corn and wheat starches.

All granules made can be rounded and/or coated, if desired, with hydrophobic materials such as waxes, polymers, or oils to further enhance their controlled release characteristics.

Scanning electron photo micrographs of our expanded perlite showed the expanded perlite to be an in-depth formation of small micro sized chambers connected by walls which are about 0.5 micron thick which formed when water evenly dispersed in the unexpanded perlite expanded under high temperature. For the most part, the expansion of the perlite particles, which are sized before expansion by milling the larger mineral rock, result in particles which appear to have outer shells with blow-holes in the shells. This original perlite expansion can be done by any one of several known technologies. We find that though the resulting expanded perlite has potential, it does not allow us to produce the dense product we desire. Therefore, we subject the expanded perlite to further treatment in our pilot plant. A small quantity of water is applied to the expanded perlite, our most preferred amount being from 0.5 ml of water/gm of perlite to 5.0 ml of water/gm of perlite. The treated expanded perlite is then introduced into a heated chamber, most preferably a steam jacketed double shaft pugmill running at a high rate of speed so as to mechanically fluidize the particles. This heats the wetted expanded perlite up again such that the water in the perlite expands within the perlite but this time in a much more gentle fashion than the original high temperature and pressure popping technique used in the original expansion. Air temperatures within the vessel can range from 210° F. to 500° F. with the most desired range being 215° F. to 350° F. The result as shown by the electron microscope is increased rupture and exfoliation of the outer shell as the absorbed water expands into steam at atmospheric pressure. There appears to be less effect on the vast maze of internal chambers. The retention time that the wetted perlite spends in the expansion chamber (or pugmill) needs only to be about 30 seconds, but extensive exposure of over an hour is not detrimental unless the mechanical action is too violent and abrades the perlite. The perlite with this enhancement to the original expansion is now ready to be filled with our urea/corn starch mixture. This step of controlled exfoliation of the perlite with steam immediately before it is introduced to the absorbing vessel also drives most of the air from the internals of the previously expanded perlite replacing it with steam. Since urea and urea solutions are extremely hydrophilic as are most fertilizers, the steam in the perlite is absorbed by the fertilizer mixture causing a psuedo vacuum within the perlite which further assists complete filling of the perlite with urea/corn starch solution or melt when the perlite is fully immersed in the molten material. We have achieved the same exfoliated results in the laboratory using a small tank fitted with a condenser, in a pressure cooker and with a microwave oven. In each case, to get a further rupture of the outer skin of the expanded perlite, water had to be applied to the expanded perlite prior to heating. Scanning electron photo micrographs and calculations, based on percentage of components in the final product and bulk density in the final product, indicate that in the final product, the exfoliated perlite is impregnated to between 40 and 95% of its holding capacity and in most cases, impregnation is between 60 and 90% of its holding capacity. In the most preferred cases, impregnation is between 80 and 90% of the capillaries/void volume. Thereby, the impregnated mixture makes up 70 to 95% by weight of the final product. About 60 to 80% of the urea/corn starch mixture is absorbed into the exfoliated perlite. The remaining urea and corn starch acts as a binder holding the individual granules together and that urea is available for quick release to the soil.

Another major contributor to the high bulk density is the fact that we can granulate the material in the same manner as urea is presently granulated. This is accomplished by spraying the mixture consisting of molten urea, corn starch, and the small perlite particles containing absorbed urea/corn starch mixture, and which vary in size from about 100 micron to 1500 micron in diameter, but more preferably 150 to 1000 microns, onto existing recycle granules in a rotating drum. The existing granules thus grow in size because of the onion skin type build-up from direct solidification of the mixture sprayed on them and because there is some agglomeration of small existing granules in the rotating bed being adhered to large granules by the solidifying mixture which acts as an adhesive. By such a manner the granules are made spherical. They are then sized as they leave the granulator as per a typical urea granulation plant, with the undersize being returned to the granulator and the oversize being milled and returned to the granulator either in total or just the undersize part after rescreening. The resulting product is spherical even though each granule is made up of a multiplicity of perlite particles filled with solidified urea and starch and the unabsorbed urea and starch acting as the adhesive to hold the granule together. Later when the granules are applied to the soil and water begins to leach-out the urea nutrient, the corn starch not only acts as a inter-spatial blocker thus retarding the leaching of the urea it helps hold the perlite particles together which also enhances controlled release of the nutrient by, in effect, maintaining a larger center of high nutrient content, rather than allowing the dispersion of the small perlite particles in the soil. Also, in effect, maintaining a large urea granule which obviously goes into solution slower than the same granule ground to a powder and dispersed in the soil.

Our granules are extremely hard when made at high density even without the customary inclusion of 0.3% to 0.5% urea formaldehyde in urea granules to harden them up and prevent caking. The exfoliated perlite super-structure apparently gives extra hardness (crushing strength) to the granules such that the crushing strength of −6+7 Tyler mesh, (3.4 mm to 2.8 mm in diameter) materials vary from 8 lbs of force to 10 lbs of force without the addition of urea formaldehyde as a hardening and conditioning agent. This is due to using concentrated urea of 95%, and spray agglomeration granulation. In comparison, typical commercial urea with 0.3% to 0.5% urea formaldehyde at −6+7 Tyler mesh (3.4 mm to 2.8 mm in diameter) has a hardness (crushing strength) of 5 to 8 lbs of force, but without formaldehyde, are much weaker.

Urea hardness (crushing strength) varies directly in a straight line manner with granule diameter, with a curve of the type y=m×+c, where y=the hardness, x=the diameter of the granule, m=the slope of the curve, and c=the intercept of the x-axis. Using this curve equation with the normal intercept as determined by classical data at 0.75, we can predict the hardness (crushing strength) of our urea/corn starch product to range 11 to 14 lb of force when the granules are 4 mm in diameter and 0.9 to 1.1 lb of force when the granules are 1 mm in diameter.

With regard to the use of urea formaldehyde as the recognized manner of preventing urea caking during storage and shipment, we have used some urea pretreated with 0.4% urea formaldehyde in our tests to determine any positive or adverse effect its presence might have on the controlled release characteristics of our material. Some may wish to re-granulate urea by melting or dissolving standard commercial product or they may wish to add urea formaldehyde to resist caking or other reasons. To demonstrate this was possible we did some limited testing. In our test work, we were able to make a product with some increased extension to the release rate, even at small proportions of urea formaldehyde, such as 0.4%.

To measure the relative solubilities of the products in soil, an irrigated soil burial test (“Controlled Release Soil Test”) was devised such that granules could be retrieved for measurement of their nitrogen content. The following is a description of the test.

Controlled Release Soil Test

Procedure for Controlled Release Soil Test

1. Screen the sample to obtain −6+7 Tyler mesh granules for the test.

2. Label a freezer container with the test description.

3. Place the freezer container on the 1200 g balance and tare out.

4. Place 300 g of potting soil with a 40% moisture content into the container and record the weight.

5. Over the soil place two (2) pieces of fiberglass mesh with 14 meshes to the inch and 1/16 inch openings.

6. Tare out the container with the soil and fiberglass mesh screens.

7. Spread 5 grams of −6+7 Tyler mesh granules over the screen in a single layer and record the weight.

8. Place a large square of fiberglass mesh over the granules, with a stainless steel screen cut to fit over it, so that the shape of the container has been mirrored.

9. Once this is shaped, tare out the container and add 150 g of soil and record the weight.

10. Repeat this process for each sample to be tested (in triplet if possible).

11. After all containers are completed, fill a mist spray bottle with de-ionized water and prime.

12. Tare out the weight of the primed mist bottle.

13. Mist 4 g of water into each container and immediately place the lid on container and seal.

14. After the fertilizer granules have been submerged in a humid soil environment for the allotted time (9 hours, 24 hours, and 3 days), the 150 g of soil is removed from the container.

15. Weigh to the nearest 0.0001 g in aluminum weigh pan and tare out.

16. Gently remove the two pieces of fiberglass mesh, which contains the remaining fertilizer granules.

17. Transfer the granules to the aluminum weigh pan and record the weight of the fertilizer granules.

18. Place the fertilizer granules in a laboratory oven to dry at low temperature (50° C.) for 13 hours.

19. Remove the dry sample from the oven, weigh to the nearest 0.0001 g and record weight.

20. Place the dry fertilizer sample into a 125 mL plastic sample bottle containing 20 g of de-ionized water.

21. Allow the sample to dissolve for 3 hours.

22. Place approximately 1 ml aliquot of the sample solution onto the sample stage of a refractometer (e.g., Abbe Refractometer).

23. Record the refractive index and temperature of the solution.

24. Calculate the percent urea retained from the original fertilizer sample.

Using the above procedure, plain urea particles went into solution in the first 9 hours. Perlite granules containing urea and 1% corn starch and made from 85% urea melt retained up to 42% of their nutrient after 9 hours, 23% after 24 hours, and 11% after 3 days, thus providing an extended control release pattern. Further extended control release of the granules resulted when 1% cornstarch was used as a gelling compound with a 95% urea melt; up to 48% of the nutrient remained in the perlite after 9 hours, 23% remained after 24 hours, and 11% remained in the perlite after 3 days.

This is much less controlled retention than the goal of most sulfur coated ureas, which is a relatively expensive, longer nutrient availability extending material.

Alternatively, cornstarch and cold water (33° F.-43° F.) can be blended at ratios of as little as 1 to 1 (i.e. cornstarch is equal to or less than 50%) and then mixed with the urea melt before the absorption step of the process and thus avoid the homogenizer step in the process. This, however, adds water to the melt which must be dried out of the product, and for a continuous plant process would not be desirable.

While urea was employed in the tests as the principle source of nitrogen, diammonium phosphate (DAP) was additionally used as a source of nitrogen, as well as a source of phosphorus.

The control release fertilizer of the present invention was applied to outdoor plots of grass as described in Example 16. Two sample embodiments of the present controlled release fertilizer were prepared using urea, corn starch and expanded perlite. One sample fertilizer was prepared using a 1% corn starch solution and the second sample fertilizer was prepared using a 4% corn starch solution. An 85% urea solution was employed in preparing both the 1% and 4% sample fertilizers. Test results show that the controlled release fertilizers provided the shortest time from planting to tasseling and silking for both sweet corn and field corn.

More specifically, our invention encompasses taking urea melt of concentrations 40% to 99.9%, or more preferably 65% to 99.9%, and most preferably 75% to 99.9% made by any means and corn starch made by a means and blending them together into a completely homogeneous mixture and in such a way that the gelling properties of the corn starch are not destroyed and foam formation is minimized. We blend under atmospheric pressure and do not let the temperature of the mixture exceed 295° F. or a point where the vapor pressure of the mixture exceeds 450 mm of Hg while maintaining the temperature of the mixture above the point of first crystallization for urea. More preferably, we do not exceed 280° F. or a point where the vapor pressure of the mixture exceeds 350 mm of Hg and most preferably we do not exceed 270° F. or a point where the vapor pressure exceeds 300 mm of Hg. This prevents foaming which hinders the later absorption step, limits formation of biuret, and limits thermal damage to the corn starch.

We minimize the mixing step and use only enough homogenization to completely mix the corn starch within the urea solution. We use urea solution with more than 40% urea content up to 99.9% urea; however, to provide a more dense product and to get better extension of the release, we more prefer to use urea solution with a urea content between 65% and 99.9% and most prefer a urea solution between 75% urea and 99.5% urea. Further, we keep the melt at least 0.5° F. above the point of first crystallization for the urea/corn starch mixture; however, we prefer to keep it at least above 2° F., and most prefer to keep it at least 5° F. above the point of first crystallization. Once the mixture has been made, it is important to quickly absorb it to prevent damage to the corn starch gel and to prevent excessive biuret formation. We pump and meter the mixture without temperature adjustment into a pugmill where it is mixed with the absorbing exfoliated perlite. Although others who utilize our technology may wish to adjust the temperature, we find temperatures adjusted at this point can cause foaming or crystallization which at this point are very harmful in obtaining maximum absorption into the expanded perlite. Expanded perlite by any of most standard means is heated to above the point of first crystallization of the mixture to avoid premature freezing of the mixture in the outer chambers of the perlite and thus prevent full penetration. The metered perlite can be heated by a fluid-bed or any number of ways and passed to the absorber, however, we prefer to provide a secondary step of limited exfoliation to the perlite as follows for much better absorption and controlled release. A mixture of perlite and water may be heated to steam the perlite, or hot steam may be introduced directly to the perlite to steam the perlite.

The preferably hot steam filled perlite is fed to the absorber where it absorbs the mixture to near completeness. More urea/corn starch mixture is used than the absorbing capacity of the perlite so that the perlite is essentially totally submerged in the urea/corn starch mixture. This allows the excellent penetration and fill of the perlite particles. To give the mixture time to completely penetrate into the perlite before being crystallized or gel setting the absorbers side walls are heated at the same temperature as the perlite-slurry and the top is covered to prevent evaporation. Although we do this in continuous fashion in a pugmill, it is obvious to those schooled in the art that some other absorber vessels may work just as well or to a limited degree as long as early crystallization of the mixture is not allowed. There must be excess in urea/corn starch over that which absorbs for this mixture is used as the mortar which covers and joins the individual pieces of perlite, now partially or totally filled with the urea/corn starch mixture, together into granules made up of a multiplicity of these filled perlite particles. Retention time in the absorber can be from 10 seconds to several hours, however, we prefer to provide the time to obtain maximum penetration and yet minimize the time with respect to avoiding excess formation of biuret and damage to the corn starch gel. Thus we more prefer 30 seconds to 30 minutes within the absorber, and most prefer 1 minute to 15 minutes within the absorber.

Once the urea/corn starch mixture is absorbed into the exfoliated perlite to the extend desired, the mixture is still a slurry of urea/corn starch containing perlite in a mixture of urea and corn starch, as such it is pumped by mechanical, pressure or suction means into the granulator. We have found that a course dispersion spray such as is used in most commercial drum granulators is preferred although we have been successful in pouring the material into the rolling bed of granules and in pressure spraying the material with steam. When doing this, recycle as undersize and milled oversize and product, if needed, is fed back to the drum to provide cooling as needed and to assist in particle formation and agglomeration. Much of the cooling is provided by the evaporation of water from the granules. We have found that the best temperature for granulation is to provide entering recycle at from 110° F. to 220° F., but more preferably between 130° F. and 210° F., and most preferably, between 150° F. and 205° F., with the perlite/corn starch slurry fed into the drum at from 32° F. to 295° F., but more preferably, from 115° F. to 280° F., but most preferably, between 160° F. and 270° F., but not allowing the temperature of the granules in the drum to exceed 235° F. The rolling action and spraying action combine to form hard spherical granules with a good gel structure and with controlled release properties.

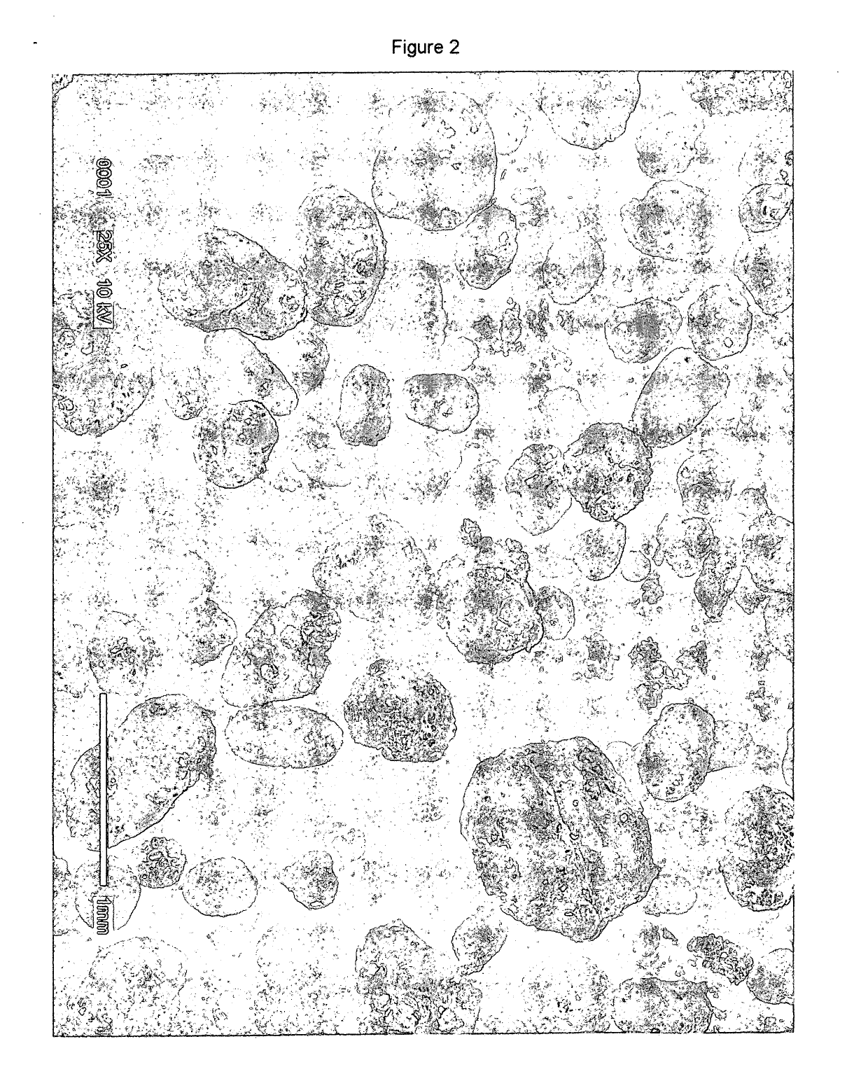

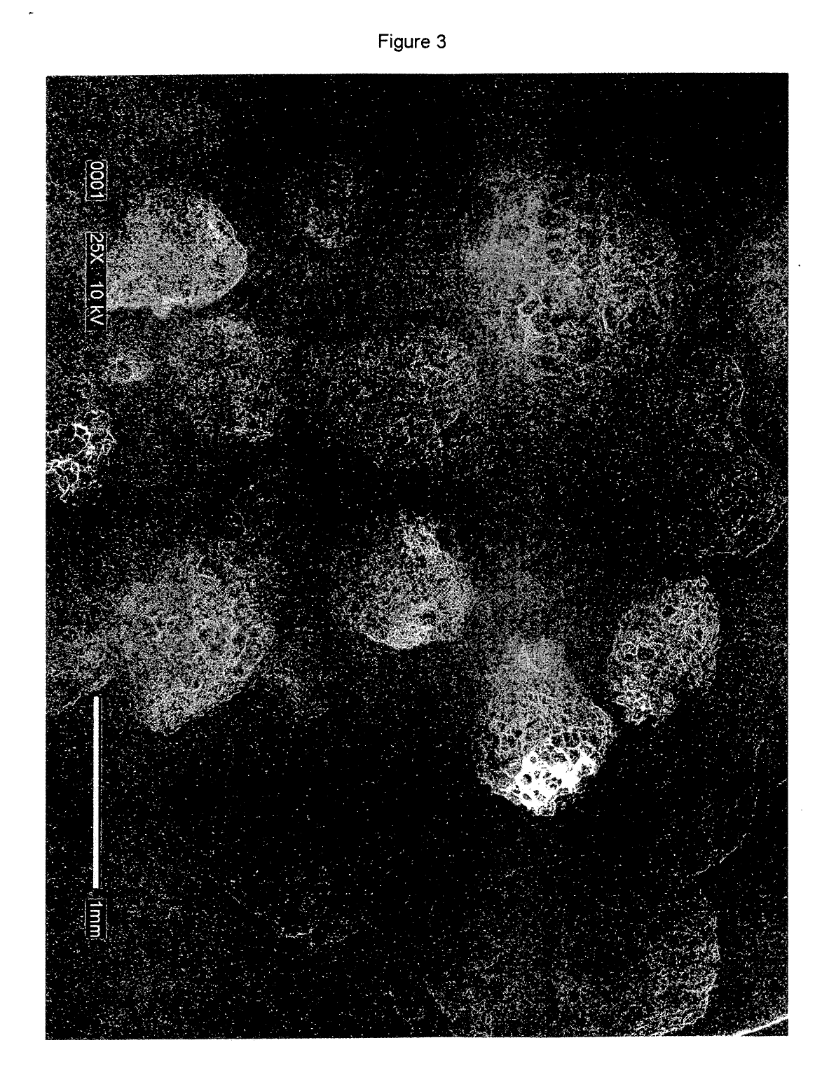

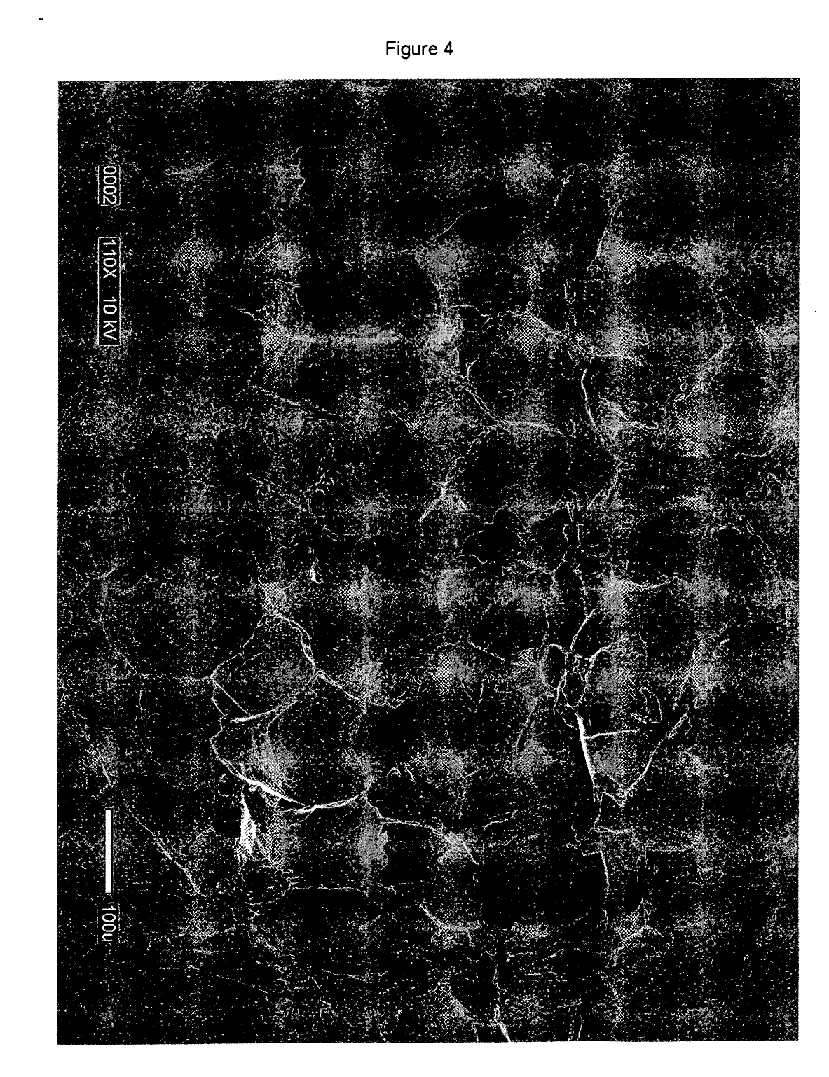

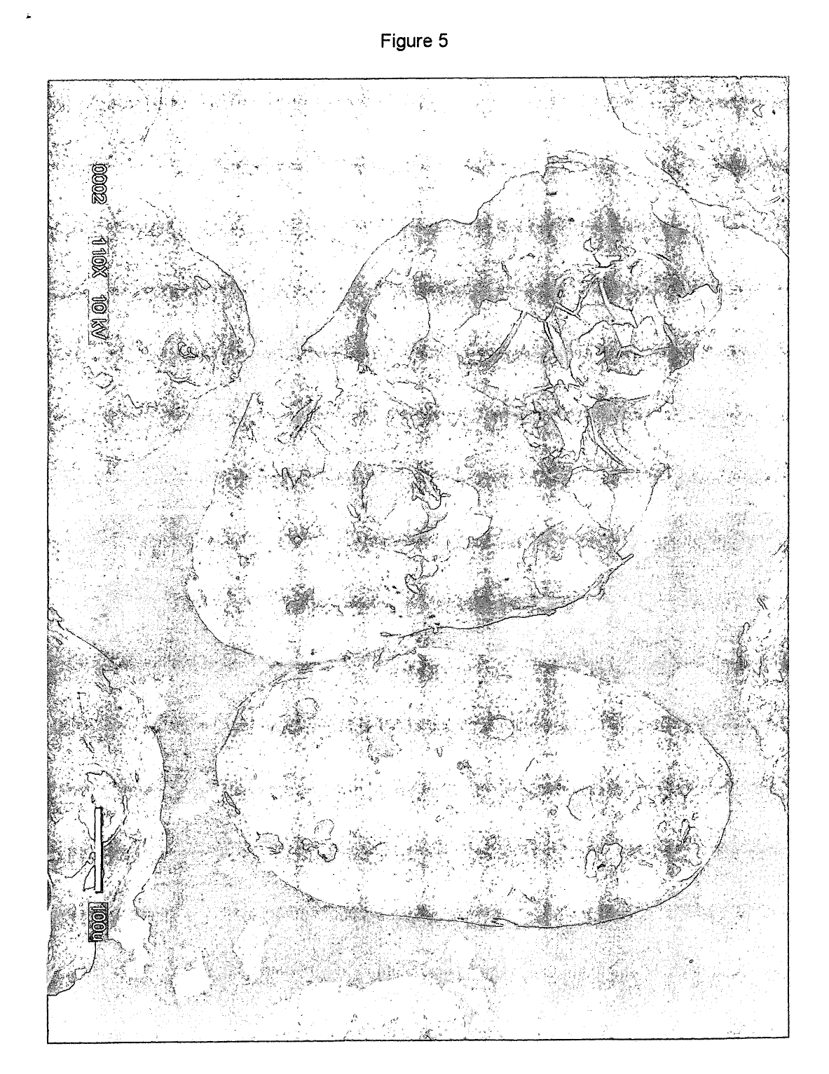

The difference between normally expanded perlite and exfoliated perlite as taught by our invention is shown by the following photo micrographs. FIG. 2 shows the expanded perlite to be spherical to oblong in shape with an average size of about 0.5 millimeters=500 microns. Some openings are apparent on some of the material, but most of the particles appear to be covered over with a thin shell. After steam exfoliation within the pugmill of the pilot plant, as shown in FIG. 3, the outer covering is efficiently removed revealing the expanse of the internals. In essence, totally changing the absorbency of the perlite. A close up of an exfoliated granule in FIG. 4 shows just how open the perlite is to penetration by the urea and/or urea/corn starch mixture. A close up photo micrograph of expanded perlite, as in FIG. 5, in contrast to FIG. 4, shows limited exposure to the perlite internals to the urea or urea/corn starch mixtures. It also reveals a much easier means of egress by the absorbed mixture when it is in the soil, thus allowing the control and extension of nutrient release by the amount and type of blocking agent mixed with the urea or other nutrient.

With reference to FIG. 1, one embodiment of the process of our invention includes taking fertilizer nutrient as a solution or as a melt and homogenously mixing it with a gelling material, i.e. blocking agent, in vessel (1) containing a high sheer homogenizer. However, if the mixture is, e.g. a starch or similar material, and the solution is relatively cold, a homogenous mixture of the solution and the blocking agent can be obtained with less mixing force.

The homogenous solution is then pumped in a continuous manner by a metering pump (2) to a blender (3) to mix with an absorbent. The absorbent is likewise continuously fed to the blender by being metered by a solids feeder (4) to a blending type heat exchanger (5) to which water is also metered through a pump (6) and added to the absorbent prior to complete heating of the absorbent and in a manner that it is evenly dispersed among and within the particles of the absorbent. Heat (7) is applied indirectly to the absorbent and water in the heat exchanger in a controlled manner to cause the water to expand to steam as the absorbent passes through the heat exchanger, this prepares the absorbent for maximum absorbency when it reaches the blender (3). Heat (8) is applied to the blender to individually heat the contents and maintain good temperature control for optimum absorbency. In the blender the absorbent absorbs the mixture prepared in vessel (1) but not all of it; leaving an essentially filled absorbent with excess of that mixture in a very viscous but flowable condition to be discharged from blender (3) to feeder (9). Thereby it can be introduced into the granulator (10) by a number of means. The filled absorbent particle with the absorbent mixture are granulated within the granulator such that the mixture crystallizes both within the absorbent particles and outside the absorbent particles, the latter thus acting as the glue to hold the individual particles together into the form of a granule containing many particles. The granules discharge from the granulator after the particles and their contents and the accompanying mixture, making up the granules, are solidified by the loss of heat and/or increase concentration. The heat of crystallization is removed by incoming recycle provided by the undersize from a sizing screen (11) and/or cooling gases passing through the granulator and/or heat losses passing through the shell of the granulator and/or by evaporation of water or other solvent from the granules or evaporation cooling from other means within the granulator. In some cases heat will replace cooling to evaporate the solvent, thus increasing concentration of the mixture, both within and outside the absorbent, and resulting in solidification of the mixture. Within the granulator, the particles from feeder (9), not only agglomerate among themselves, they also build on and agglomerate with the incoming recycle of undersize. Discharge from granulator (10) then free flows to screen (11) where the oversize is separated and sent to a mill (12) and then back to the screen (11). As an option to allow the best sphericity product, the milled material is all returned to the granulator. The on-size material leaving screen (11) free flows to a dryer/cooler (13) where it is dried to the desired completeness and cooled to a proper storage temperature. Optionally, portions or all of the undersize and milled oversize can be returned to the blender (3) as is needed to improve granulation.

More specifically, we prefer that the heat exchanger (3) be a moderately high tip speed pugmill with heated sidewalls, and that heat be provided by steam whose pressure at saturation can be easily regulated for a constant temperature control. The heat exchanger (3) should be vented but only to let out the air and steam which would otherwise build to a pressure condition within the heat exchanger. We prefer to maintain as much as possible a steam atmosphere within the pugmill, which is produced by evaporation of the water dispersed into the absorbent, and to discharge the exfoliated and/or steam containing absorbent directly to the blender (3). The blender is preferred to be a pugmill with moderate to slow tip speed, such that the mixing is gentle but thorough. The material should reach a moderate oatmeal consistency as it exits the pugmill blender (3). We prefer the feeder (9) to be a low pressure developing pump or screw conveyor.

In other feeding means, we have been successful with a steam eductor whereby the filled absorbent and excess mixture is sprayed onto the granules in the granulator. The granulation system which consists of the granulator, screen, mill and drying and cooling means and associated supporting equipment can be most any classical commercially existing system including spray drum granulators, pan granulators, pugmill granulators, pour and crumble granulators, fluid-bed granulators, prill towers, and other forms of solid forming operations. The process is designed such that only minimal alterations are required to most every large (equal to or greater than 5 tons/hr) granulation plant now in operation which produce granules or prills of urea, monoammonium phosphate, diammonium phosphate, sulfur, ammonium sulfate, and ammonium nitrate, potassium nitrate, calcium nitrate, potassium phosphate, sodium nitrate, and mixtures of these products and others.

The following examples show how the present invention has taken the above concepts and developed them into a unique extended release agricultural product and method of making and using same.

Thus, the invention is demonstrated with reference to the following examples, which are of an illustrative nature only and which are to be construed as non-limiting.

### EXAMPLES

Absorbent Based Controlled Release Fertilizers

### Example 1

Samples of the controlled release fertilizer of the present invention was made employing urea as the nitrogen source. These product samples were made by granulating an 85% urea solution, with and without corn starch equal to 1% of the final product, and pre-heated perlite 3-S (Perlite 3-S refers to commonly available, small sized perlite having particle size of 94% less than 840 microns and a bulk density of about 3 lb/ft³. In the exemplary compositions for the present invention, unless otherwise stated, the employed perlite was perlite 3-S). The urea and corn starch were combined in a laboratory beaker. (The corn starch employed in the compositions for the present invention is sometimes referred to as corn starch B810. This refers to commonly available corn starch that is a flash-dried bent corn starch having particle size wherein 94-96% of the particles are smaller than 74 microns and has a moisture content of 10%. In the exemplary compositions for the present invention, unless otherwise stated, the employed corn starch was corn starch B810). A laboratory scale homogenizer was used to evenly disperse the corn starch in the urea solution. In separate tests, a sufficient amount of perlite, both pre-heated to 300° F. and un-heated, was added to the urea/corn starch mixture to obtain almost complete absorption of the mixture. The mixture was removed from the beaker and allowed to solidify. Once the mixture had solidified and cooled, it was crumbled using a laboratory blender on the chop setting, and then screened to obtain −6+7 Tyler mesh (3.4 mm to 2.8 mm in diameter) fertilizer granules. These granules were then dried in a laboratory fluid-bed. The resulting materials were evaluated by placing 1 gm of sample in a test tube with 6 grams of water held at 75° F. for 1, 2, and 3 days, at which time the samples were drawn out of the test tube using a pipette after rotating the test tube end on end three times to create a homogenous solution. Urea retention in the perlite in all cases was over 250% better when it contained 1% corn starch instead of no corn starch and at least 35% better in all cases when the perlite was heated.

### Example 2

A pilot plant was set-up where urea was melted by a steam tube melter then blended with water to make an 85% solution and continuously fed at 109 lb/hr to a mix tank equipped with a homogenizer where corn starch powder was added at the rate of 1 lb/hr. The urea solution and the mix tank were maintained at a temperature of 210° F. Expanded 3-S perlite was continuously fed to a fluid-bed pre-heater at 7 lb/hr where it was heated with air until it was 320° F. to 327° F. (No water was applied to the perlite before hand and no steam was used to exfoliate it.) The perlite and the urea/corn starch mixture were then fed to a pugmill where most of the urea/corn starch mixture was absorbed while being held at a temperature of 196-197° F. The resulting slurry of perlite containing urea and corn starch plus excess urea and corn starch mixture was fed to a second pugmill. Oversize granules produced during the pilot plant operation were milled utilizing a Jacobson knife-bladed hammermill to obtain additional product size material and recycle. Recycle was added to the pugmill at a rate slightly over 2.5 to 1 that of the product made. The temperature of product leaving the pugmill was 136° F. The product and recycle were rounded and pre-dried in a rotating drum at 130° F. after which the product was dried in a fluid-bed dryer using 140° F. air.

The resulting product had a bulk density of 26 lb/ft³, a perlite content of 8.8%, and a corn starch concentration of 1% giving a nitrogen content of 41.5+%; which resulted in a 9 hour dissolution rate in the aforementioned soil test of 43%, 23% after 24 hours, and 10% after 3 days.

### Example 3

Eighteen (18) grams of expanded 3-S perlite was placed in a laboratory vessel having an agitator and small vent. 20 ml of water were added to the vessel and mixed with the perlite, and it was heated so that it steamed for 1 hour at 220° F. 350 grams of a mixture of 85% urea solution with 1% of corn starch homogenized with it was added to the steaming perlite and mixed well. The mixture was poured onto a plastic surface to harden and then crumbled in a lab blender. The crumbled material was screened to −6+10 Tyler mesh (3.4 mm to 1.7 mm in diameter) and dried in a lab fluid-bed. The resulting material had a bulk density of 35 lb/ft³. The material was then placed in a rotating drum and rounded by blowing hot air on it at 240° F. The bulk density of the resulting material was 38 lb/ft³.

### Example 4

Eighteen (18) grams of expanded 3-S perlite was placed in a laboratory vessel and treated in the same manner as Example 2 except 350 grams of a 95% urea-1% corn starch mixture was added to the steaming perlite and mixed well. After crumbling, screening, and drying, the resulting material had a bulk density of 35 lb/ft³ and after rounding, a bulk density of 37 lb/ft³.

### Example 5

The same test was performed as Example 3, but a 98% urea-1% corn starch mixture was added to the steaming perlite. The resulting material had a bulk density of 38 lb/ft³ and after rounding, a bulk density of 40 lb/ft³.

### Example 6

The same test was performed as Example 3, but a pure urea melt was added to the 18 grams of steam perlite resulting in a bulk density of 41 lb/ft³ and after rounding 43 lb/ft³.

### Example 7

The apparatus of Example 2 was altered to allow additional exfoliation of the expanded perlite in order to get increased absorbency and increased bulk density per lab examples 3, 4, 5, and 6. The perlite was fed into a double shaft pugmill heated by a steam jacket at 85 psia or 316° F. The shafts were rotated at 130 rpm to give them a tip speed of 3.4 ft/sec. As the perlite was metered to the pugmill, it was moistened at the rate of approximately 1.1 grams of perlite per gram of water at the inlet end of the pugmill to allow absorption of the water into the perlite before the water was heated to the point of becoming steam. The water was applied through a tygon tube which dripped on the most active part of the bed in the pugmill. Retention time of the perlite in the pugmill was about 30 minutes. Photo micrographs showed the perlite exiting the pugmill to have enhanced exfoliation of the outer shell. The perlite was introduced to the urea/corn starch mixture in a second pugmill with its double shaft running at 72 rpm for a tip speed of 0.98 ft/sec. The temperature of the perlite-urea/corn starch mixture was controlled by a steam jacket at 271° F. through the use of 45 psia steam. The urea/corn starch mixture was prepared by melting granular urea and diluting it with water to 95% solution in the same mix tank as corn starch was homogenously blended into the mixture. The homogenizer operated at 3130 rpm and was powered by a 2 hp motor. The mixing was done in a semi-continuous manner. Residence time in the mixing tank was about 14 minutes during which it was under constant homogenization. Every 3 to 4 minutes, some of the mixture was withdrawn from the mixing vessel and put into a pump tank to provide continuous feed to the pugmill absorber. Once the withdrawal had occurred, additional amounts of urea and water to give a 95% urea solution were added to the mix vessel and corn starch was gradually poured into the vessel. The steam to the melter was 115 psia; however, temperatures of the mixing vessel was controlled at 269° F. In another change from Example 2, the perlite-urea/corn starch slurry leaving the absorber was sprayed by means of a steam eductor onto a rolling bed of granules in a rotating drum. The second pugmill mentioned in Example 2 was removed and the recycle and slurry were fed directly to the 4 ft diameter. drum which was rotating at 15 rpm. Feed rate of urea @ 95% solution was 100.8 lb/hr with a corn starch feed rate of 1 lb/hr. Perlite fed at 4.2 lb/hr and recycle was fed back to the granulation drum at 27 lb/hr. Bed temperature within the granulation drum was controlled at 217° F. by means of blowing hot air at 227° F. onto the rotating bed. Material discharged by the drum was fed to a vibrating type screener for separation into product, oversize, and undersize. The undersize and oversize milled by a knife-bladed hammermill was fed back to the drum. Granulation was excellent, forming spherical granules and very little oversize. The product size granules of −6+10 Tyler mesh (3.4 mm to 1.7 mm in diameter) size were dried and found to have a bulk density of up to 43 lb/ft³. In the soil burial tests previously mentioned, 33%, 16%, and 6% of the urea remained in the perlite after 9 hours, 24 hours, and 3 days, respectively. After drying the product, actual perlite content was 5.2% and corn starch was 1%. Nitrogen content of the product was 43+%. The hardness (crushing strength) of the urea by the recognized TVA crushing strength test as taught by TVA Bulletin Y-147 was 9+ lbs of force for −6+7% Tyler mesh (3.4 mm to 2.8 mm in diameter) granules. Gel formation around and within the granules however, did not appear as good as the laboratory products when they were viewed as submerged in a watch glass filled with water and with a surface stereo microscope. The individual perlite particles separated to a larger extent than normal while in water rather than being bound together by the gel.

### Example 8

Using the same equipment as in Example 7 but with alterations to the operating conditions, the good gelling properties reappeared in the final product. The same feed rates were maintained as in Example 7 and the same method of operation was used for enhanced exfoliation. However, the pugmill rpm was reduced to 97 rpm and thus the tip speed was reduced to 2.5 ft/sec. The temperature maintained in the urea melting and corn starch homogenization steps were reduced; mix tank retention time was reduced to 3½ minutes and homogenization was reduced from 14 minutes to 1-minute. Temperatures in the mix tank were reduced to 258° F. and that in the pump tank to 262° F. The urea melt temperature fed to the mixing vessel was reduced to 283° F. and the pugmill absorber temperature was reduced to 266° F. The temperature to the perlite steaming pugmill was reduced to 313° F. Steam pressure in the slurry venturi nozzle was operated at 30 psig. The resulting bulk density of the −6+10 Tyler mesh product was 39 lb/ft³. Urea remaining after 9 hours in the perlite after the soil burial tests was 44%, 10%, and 4.5% for 9 hours, 24 hours, and 3 days, respectively.

### Example 9

A 95% urea solution was homogenized to contain 1% corn starch and then for the most part absorbed by perlite equal to 4.5% of the final product in the same equipment as in Example 7. However, the granulation of the material was done by spreading the molten slurry onto the bed of the rotating drum by hand through use of a ice scoop of the open-top half-pipe style. The scoop allowed the material to be distributed across the rolling bed of the drum simulating a course spray discharge longitudinally across the rolling bed and falling curtains of particles as presently experienced in the large drum of a urea granulation plant. Otherwise the manner of operation was like that of Example 8. Urea melt at 100% and about 283° F. was fed to the mixing vessel. The mixture temperature was varied from 268° F. to 255° F. during the 4 hour operation as water and then corn starch was blended into it to make the aforementioned mixture. Feed rates for the urea, water, and corn starch were 111 lb/hr, 6 lb/hr, and 1 lb/hr respectively. There was essentially no heel left in the mix tank between blends. Once the blend was made, it was immediately discharged to the pump tank, thus providing continuous feed for the absorber. The urea/corn starch mixture was fed to the absorber along with the perlite which had been further exfoliated just prior to its introduction to the absorber. About 1 ml of H₂O per gram of perlite was introduced to the feed end of the pugmill and allowed to absorb into the perlite. It expanded into steam in the steam heated pugmill operating at 320° F., thus further exfoliating the perlite. The absorber was run at from 268° F. to 255° F. as the operation progressed. Slurry leaving the absorber was discharged to hand operated ice scoops. The granulation was done in the 4 ft diameter by 18″ long drum rotating at 3.5 rpm, but increased to 7.5 rpm as the operation progressed. Some of the absorber discharge was put into a aluminum sheet and allowed to solidify in a slab. The drum recycle was 33 lb/hr and the temperature of the bed was maintained at between 192° F. to 201° F. using the recycle and the hot air blower for control. Material from the drum was screened to a product of −6+10 Tyler mesh and the oversize milled without drying and recycled to the screen. Undersize was fed to the drum as the recycle. As the temperature was varied in the homogenizer vessel from 268° F. to 255° F., the mixture changed from clear to opaque and the gel strength in the final product as observed by the stereo microscope increased significantly, as did the soil burial test results, which went from a urea retention in the perlite of 33% urea and 13% in 9 and 24 hours respectively, to a retention of 47% urea and 23% urea in the perlite in 9 and 24 hours respectively, as the test progressed. The bulk density was acceptable for the entire run but decreased with an increase in gel strength from 38 lb/ft³ to 36.5 lb/ft³.

### Example 10

The pilot plant of Example 9 was operated in the same manner and rates as the best means of Example 9. However, corn starch was applied at a strength of only 0.5% of the mixture. The resulting −6+10 Tyler mesh (3.4 mm to 1.7 mm in diameter) product had an increased bulk density of 39 lb/ft³ and soil burial result showed 45%, 16%, and 6% of the urea retained after 9 hours, 24 hours, and 3 days respectively.

### Example 11

The pilot plant of Example 9 was operated in the same manner and rates as the best means of Example 9 except there was no addition of corn starch. Although the 95% solution of urea was absorbed by the perlite, it could not be granulated in the drum. The material was weak and turned to dust in the rotating drum. The perlite urea slurry was successfully poured out on an aluminum sheet and solidified as a slab. The material which was poured and solidified was milled into granules, but it created large quantities of dust and would be unacceptable in a plant operation.

### Example 12

A 95% urea solution was homogenized with corn starch to give a 6% corn starch product in the same manner as Example 1, but no perlite was added. The material was slowly poured on a bed of rotating granules in a pan granulator and granulated. The resulting product which contained no perlite was screened to −6+10 Tyler mesh (3.4 mm to 1.7 mm in diameter) product and had a bulk density of 32 lb/ft³. In the soil burial, it had a urea retention of 27%, 15% and 6% in the perlite after 9 hours, 24 hours, and 3 days respectively.

### Example 13

The same test was done as above but had only 1% corn starch in the final product. The final product of −6+10 Tyler mesh (3.4 mm to 1.7 mm in diameter) granules had a bulk density of 40 lb/ft³. In the previously described controlled release soil tests, urea retention in the perlite was 10%, 3% and 1% after 9 hours, 24 hours, and 3 days respectively.

### Example 14

Using a standard pressure cooker, but without pressure development, expanded perlite was moistened with water at 20 ml of H₂O/18 grams of perlite in the laboratory and the vessel was heated to exfoliate the perlite. Urea containing the customary 0.3% to 0.5% formaldehyde (a relatively small amount and not to be confused with the ureaform constituent of the ureaform composition products of the present invention) used to condition it in most agricultural operations, was dissolved in H₂O to make a 95% solution. Corn starch was homogenized into the urea solution at 1% by weight. The urea/corn starch mixture was poured into the perlite such that the perlite content was 5% of the dried product and allowed to absorb the urea formaldehyde/corn starch mixture. The resulting material was poured onto an aluminum sheet to cool. Then it was crumbled with a laboratory blender on the chop cycle, screened to −6+10 Tyler mesh and dried. The resulting material had a bulk density of 33 lb/ft³ and in the previously described controlled release soil test (also simply referred to as the “soil burial test”) retained 51% urea, 31% urea, and 15% urea in the perlite after 9 hours, 24 hours, and 3 days respectively.

### Example 15

In the same manner as Example 14, material was produced in the laboratory where by urea, diammonium phosphate and potassium chloride were dissolved in water to make an 85% solution of the nutrients. The solution at 240° F. was added to perlite to contain 8% of the perlite which had been further expanded in the manner of Example 14. The resulting product had a nutrient content of 29% nitrogen, 3% P₂O₅, and 4% K₂O and a bulk density of 41 lb/ft³. It showed excellent physical properties.

The present controlled release agricultural absorbent based product and holding material based product provide for fine control of the release over both short and long periods of time, for a variety of agriculturally beneficial materials.

Another embodiment of the present invention does not include particles of an absorbent material but is a controlled release, particulate, agricultual product that includes a mixture of a control release holding substance, such as plant starches, protein gels, glues, gumming compositions, crystallizing compounds, gelling clays and synthetic gel forming compounds, and an agriculturally beneficial material including fertilizers, insecticides, herbicides and fungicides. Such controlled release fertilizers are also described in U.S. patent application Ser. No. 09/895,876, which has been incorporated herewith in its entirety.

Fertilizers Containing Calcium Sulfate and Urea

### Example 16

Slow Release Fertilizers

A summary of the following Tests 1-10 and test results are presented in below Table 2.

To measure the slow or controlled release of the present compositions a Controlled Release Soil Test was employed, described as follows.

To measure the relative solubilities of the products in soil, an irrigated soil burial test was devised such that granules could be retrieved for measurement of their nitrogen content. The test has been earlier described herein.

Test 1

Commercial agricultural grade granular urea was tested in the Controlled Release Soil Test as described above. The results show complete dissolution of the urea within 9 hours.

Test 2

Urea was granulated in a continuous process pilot plant with 5% of expanded and exfoliated perlite and 1% corn starch; where the latter was homogenized into 96% urea (4% water) melt and then absorbed into the perlite as granulated pursuant to the above process description. The results, as presented in Table 1, show that retained nitrogen after 3 days was 9.0%.

Test 3

Urea was granulated in the lab with 5% of expanded and exfoliated perlite and 1% corn starch; where the latter was homogenized into 96% urea (4% water) melt and then absorbed in perlite at 265° F. Then gypsum equal to 10% of the formulation was added to the slurry and stirred in well. The mixture was then manually granulated using a rotating pan granulator. Its granules were oven dried at 122° F. The resulting granules, when submitted to the Control Release Soil Test, gave the results shown in Table 2; where retained nitrogen after 3 days was 19.2%.

Test 4

Urea was granulated in the same manner as in Test 3 but to contain 20% gypsum. The resulting nitrogen retention with the Control Release Soil Test was 17.8% for the 3-day test period.

Test 5

Urea was granulated in the same manner as in Test 4 with the only change being a change in formulation from 1% corn starch to 2% corn starch. The resulting nitrogen retention for the 3-day period was 18.4%.

Test 6

Urea was granulated in a continuous process pilot plant with 5% of expanded and exfoliated perlite and 1% corn starch; where the latter was homogenized into 96% urea (4% water) melt mixed with potassium chloride formulated at 6.7% of the final product. Following the addition of potassium chloride and perlite, diammonium phosphate was added at the formulation amount of 6.5% of the final product and then granulated as described above. The resulting Control Release Soil Test values are shown in Table 2; where the retained nitrogen after 3 days was 7.3%.

Test 7

Urea was granulated in the lab with 5% of expanded and exfoliated perlite and 1% corn starch where the latter was homogenized into 96% urea (4% water) melt mixed with potassium chloride formulated at 6.7% of the final product. The perlite was added to the mixture at 245° F.; followed by the stirred addition of diammonium phosphate at 6.5% of the formulation and the gypsum at 7.3% of the formulation at a mixture temperature of 240° F. The slurry mixture was then granulated manually in a rotating pan granulator and the resulting granules were oven-dried at 122° F. The resulting nitrogen retention with the Control Release Soil Test was 16.3% for the 3-day test period.

Test 8

Urea was granulated in a continuous process pilot plant with 5% of expanded and exfoliated perlite and 1% corn starch where the latter was homogenized into 96% urea (4% water) melt mixed with potassium chloride formulated at 6.7% of the final product. Then this mixture at 235° F. was mixed with gypsum to give a final product containing 6.0% gypsum. Following the gypsum addition, the perlite was added and followed by the addition of diammonium phosphate formulated to give a final product content of 6.5%. The mixed slurry was then granulated in the same manner as Test 2. The resulting nitrogen retention with the Control Release Soil Test was 20.2% for the 3-day test period.

Test 9

Urea was granulated in the lab in the same manner as Test 7 with the exception that the gypsum was 21.3% of the final product and was added to the mix in the homogenizer after the potassium chloride and before the addition of the perlite. The mixture temperature at the time of the gypsum addition was 240° F. Subsequently the perlite and diammonium phosphate were added sequentially. Formulation amounts of starch, potassium chloride, perlite, and diammonium phosphate were in the same amounts as Tests 7 and 8. The resulting nitrogen retention with the Control Release Soil Test was 18.0% for the 3-day period.

Test 10

Urea was granulated in the lab without the addition of perlite. Potassium chloride at 6.4% of the final formulation was homogenized into a 95% urea (5% water) melt followed by the homogenization of corn starch at 1% of the formulation into the mix. Diammonium phosphate was stirred into the mix at 6.5% of the formulation followed by the stirred addition of gypsum at 23.0% of the formulation. The product was oven-dried at 122° F. The resulting nitrogen retention with the Control Release Soil Test was 17.4% for the 3-day period.

TABLE 2
TEST UREA BASED FERTILIZER PRODUCTS AND CORRESPONDING CONTROL
RELEASE SOIL TEST RESULTS

| | | | | | | | Control Release Soil Test | | |
|---|---|---|---|---|---|---|---|---|---|
| TEST # | STARCH % | PERLITE % | GYPSUM % | N* % | P2O5 % | K2O % | 9 HR | 24 HR | 3 DAY |
| 1 | 0.0 | 0.0 | 0.0 | 46.4 | 0.0 | 0.0 | 0 | 0 | 0 |
| 2 | 1.0 | 5.0 | 0.0 | 43.6 | 0.0 | 0.0 | 53.4 | 23.5 | 9.0 |
| 3 | 1.0 | 5.0 | 10.0 | 37.9 | 0.0 | 0.0 | 53.1 | 27.2 | 19.2 |
| 4 | 1.0 | 5.0 | 20.0 | 35.0 | 0.0 | 0.0 | 55.5 | 27.4 | 17.8 |
| 5 | 2.0 | 5.0 | 20.0 | 34.4 | 0.0 | 0.0 | 58.6 | 27.5 | 18.4 |
| 6 | 1.0 | 5.0 | 0.0 | 39.9 | 3.0 | 4.0 | 44.4 | 22.4 | 7.3 |
| 7 | 1.0 | 5.0 | 7.3 | 34.6 | 3.0 | 4.0 | 49.2 | 20.4 | 16.3 |
| 8 | 1.0 | 5.0 | 6.0 | 35.8 | 3.0 | 4.0 | 58.5 | 37.3 | 20.2 |
| 9 | 1.0 | 5.0 | 21.3 | 30.9 | 3.0 | 4.0 | 58.5 | 36.4 | 18.0 |
| 10 | 1.0 | 0.0 | 23.0 | 31.8 | 3.0 | 4.0 | 52.6 | 40.3 | 17.4 |

*Based on product analysis

Examples Concerning the Disassociation Of Gypsum (CaSO₄.2H₂O) in Melts

Test results showed that the temperature at which gypsum loses its water of hydration was very important to absorption of urea and other nutrients into the perlite absorbent, handling and granulation of the slurry mixture, and blocking action to the absorbed nutrient within the perlite and the granule. It is also an important feature associated with the use of various forms of potassium and the prevention of foaming during process operations.

Thus, the following Tests 11-14 provide for the use of more concentrated urea and lower temperatures when making the urea-perlite-starch (i.e., NUREA) based slow release fertilizer with other nutrients and otherwise active additives.

Another process embodiment provides for preparing a controlled release agricultural product including the steps of mixing solutions or melts of an agriculturally beneficial material with calcium sulfate, and cooling and granulating the resulting mixture to a granular solid, wherein the calcium sulfate is dispersed within the granular solid, being inter-crystallized within the solid.

Compositions may contain two basic components of urea and calcium sulfate (especially gypsum) with or without the addition of an agriculturally beneficial material such as a source of nitrogen, phosphorus and/or potassium. In the forgoing type of composition, the calcium sulfate is present in amounts of 1-50% wt, preferably in amounts of 10-40% wt, and most preferably in amounts of 15-35% wt, with the balance of the composition being the non-calcium sulfate component(s).

In another embodiment, compositions may contain three basic components of urea, ammonium sulfate and calcium sulfate (especially gypsum) with or without the addition of an agriculturally beneficial material such as a source of nitrogen, phosphorus and/or potassium. In the forgoing type of composition, the calcium sulfate is present in amounts of 1-50% wt, preferably in amounts of 10-40% wt, and most preferably in amounts of 15-35% wt, with the balance of the composition being the non-calcium sulfate component(s).

A summary of Tests 11-14 and test results are presented in below Table 3.

Test 11

Commercial urea was melted and found to have a freeze point of 268° F. (The nutrient strength of commercial urea is commonly recognized as 46-0-0, which is 46% nitrogen.) The molten urea was heated to 278° F. where gypsum was added at a formulation of 10% and stirred into the melt. The mixture was allowed to cool and completely solidified at around 257° F. When reheated it became liquid again at 259° F. Thus, gypsum was shown to lose its water of hydration at the higher temperature of 278° F. and then again on reheating at 259° F., near but below the temperature expected by the literature. The normal gypsum dissociation temperature to calcium sulfate hemi-hydrate (CaSO₄.0.5H₂O) and water is 262.4° F. (see Handbook of Chemistry and Physics, 50 ed. pp. B-99.)

Test 12

Urea was melted and 7.29% of potassium chloride was added to the melt along with 1.80% water, which lowered the measured freeze point to 240° F. The mixture was remelted and reheated to 250° F. where 1.09% of corn starch was homogenized into the mixture. The mixture solidified at 240° F. The mixture of urea and potassium chloride was remelted and reheated to 250° F. where 9.84% of gypsum was mixed into it. The gypsum lost its hydrated water at the lower temperature of 250° F. lowering the melting point of the mixture to 226° F., because of the extra water now in the solution. Since gypsum loses hydrated water in the presence of urea, starch, and potassium chloride at lower than normal temperature of dissociation, it allows granulation of urea and potassium chloride mixtures at lower temperatures when gypsum is added to the mixture. Further, since the water released by the gypsum while in the mixtures molten state reverts to gypsum on resolidification, the absorption can occur with less residual free water which has to be dried later in the process.

Test 13

Urea was melted and potassium nitrate was added equal to 28.33% of the urea. The resulting mixture solidified at 230° F. The mixture was remelted and reheated to 240° F. where gypsum was added equal to 10% of the mixture. The mixture then solidified at 205° F. showing the dissociation of the gypsum and release of water of hydration. The solid then became fully liquid at 209° F., thus showing gypsum acts in the same manner with potassium nitrate as with potassium chloride.

Test 14

Urea was melted and potassium sulfate was added equal to 4.11% of the mixture. The mixture solidified at 266° F. The mixture was heated to 276° F. and gypsum was added equal to 10% of the mixture. After the gypsum was stirred into the mixture, the slurry solidified at 254° F. and remelted at 255° F.

TABLE 3
EFFECT OF GYPSUM ON UREA FREEZING POINT

| | | Freezing Point | Remelt Point |
|---|---|---|---|
| Starting Solution | Freezing Point, | With Gypsym, | With Gypsum, |
| Concentration, % | ° F. | ° F. | ° F. |
| Test 11 | | | |
| 100% Urea | 268 | | |
| Add Gypsum | | | |
| 90% Urea | | 257 | 259 |
| 10% Gypsum | | | |
| Test 12 | | | |
| 90.81% Urea | 240 | | |
| 1.82% Water | | | |
| 7.37% KCl | | | |
| Add Starch | | | |
| 89.82% Urea | 240 | | |
| 1.80% Water | | | |
| 7.29% KCl | | | |
| 1.09% Starch | | | |
| Add Gypsum | | | |
| 80.99% Urea | | 226 | — |
| 1.62% Water | | | |
| 6.57% KCl | | | |
| 0.98% Starch | | | |
| 9.84% Gypsum | | | |
| Test 13 | | | |
| 71.67% Urea | 230 | | |
| 28.33% KNO₃ | | | |
| Add Gypsum | | | |
| 64.50% Urea | | 205 | 209 |
| 25.50% KNO₃ | | | |
| 10.00% Gypsum | | | |
| Test 14 | 266 | | |
| 95.89% Urea | | | |
| 4.11% K₂SO₄ | | | |
| Add Gypsum | | | |
| 86.30% Urea | | 254 | 255 |
| 3.70% K₂SO₄ | | | |
| 10.00% Gypsum | | | |

Observations Concerning Results Of Tests 1-14

In all tests, gypsum dissociated and did not reform until well below its normal dissociation temperature. In all cases dissociation of gypsum into water and calcium sulfate and/or calcium sulfate hemi-hydrates, and reformation of gypsum in situ enhanced blocking action within the perlite and is largely responsible to the nitrogen slow release enhancement shown by Tests 3, 4, 5, 7, 8, 9, and 10, as shown in above Table 2.

In the tests results presented, it is shown that only small amounts of gypsum (no more than 6.0% are needed to enhance controlled release of nitrogen and in the range of Table 2, 6.0% gypsum to 21.3% gypsum concentrations are equally effective at extending nitrogen control release. Gypsum at a concentration of 23% was shown to be effective, even without perlite, at extending the control release of nitrogen; 17.4% nitrogen retained after 3 days per Table 2, Test 10.

In the case of NUREA and NUREA-NPK, the gypsum inclusion further extends the release time over just perlite and corn starch. It appears that only a small amount like 6% is as good as a large amount like 21.3%.

In NUREA granulation by using CaSO₄.2H₂O, solidification temperatures of the mixture can be decreased during the granulating step. CaSO₄.2H₂O dissociates to CaSO₄ and/or CaSO₄.0.5H₂O with a release of water. This allows more inclusion of products like KCl which are otherwise limited by solubility in the highly concentrated melt. It also lowers the melting point of the mixture. This lower temperature will also allow inclusion of additives in the mixture which decompose at normal granulation temperatures.

Fertilizers Containing Calcium Sulfate and Ammonium Sulfate

### Example 17

Granulation of Calcium Sulfate and Ammonium Sulfate

By the granulation of ammonium sulfate with calcium sulfate (CaSO₄), calcium sulfate hemihydrate (CaSO₄.0.5H₂O) and/or gypsum, i.e., calcium sufate dihydrate (CaSO₄.2H₂O), the control release characteristics of the resulting fertilizer are enhanced.

The following is a description of the process used to granulate ammonium sulfate ((NH₄)₂SO₄). Ammonium sulfate crystals are ground to a particle size less than 0.71 millimeters. A pre-determined amount of de-ionized water is placed in a 1000 mL beaker. A magnetic stir bar and thermocouple are placed in the beaker. The water is pre-heated to 200-205° F. utilizing a lab hotplate. Once the water temperature reaches 200° F., a pre-determined amount of ground ammonium sulfate is slowly added while the solution is agitating. Once all of the weighed ammonium sulfate crystals are added to the mixture, the temperature of the mixture is held at 200-205° F. with continuous stirring. If cornstarch is utilized, the weighed amount of cornstarch is added to the heated ammonium sulfate mixture and homogenized with a laboratory homogenizer.

For ammonium sulfate products containing phosphate, a pre-weighed amount of di-ammonium phosphate (DAP) or mono-ammonium phosphate (MAP) is added to the mixture with continuous agitation. A pre-weighed amount of gypsum (CaSO₄.2H₂O) is added to the mixture with continuous agitation.

While the mixture is being prepared, a laboratory pan granulator is pre-heated indirectly with a Bunsen burner by applying heat to the bottom of the pan. The mixture is removed from the beaker into the pre-heated laboratory pan granulator. A putty knife is used to keep the material moving in the pan and promote granule formation.

Once the granular particles are free flowing, they are removed from the laboratory pan granulator and placed in a laboratory scale fluid-bed for further drying. The inlet air temperature in the fluid-bed is 160° F. The granules are dried until the exit air temperature reaches approximately 140-145° F. The granules are then removed from the fluid-bed and placed in a laboratory convection oven to finish drying over night. The oven temperature is 120-130° F. Once the granules are dry, they are screened to the desired product size of −5+9 Tyler mesh (2.00-4.00 mm) and bagged.

Examples of Slow Release Fertilizers Employing Calcium Sulfate and Ammonium Sulfate

The following Tests 15-26 were performed to create granules of fertilizer containing from 67% to 86.5% of ammonium sulfate, ((NH₄)₂SO₄).

One embodiment are compositions that contain two basic components of ammonium sulfate and calcium sulfate (especially gypsum) with or without the addition of an agriculturally beneficial material such as a source of nitrogen, phosphorus and/or potassium. In the forgoing type of composition, the calcium sulfate is present in amounts of 1-50% wt, preferably in amounts of 10-40% wt, and most preferably in amounts of 15-35% wt, with the balance of the composition being the non-calcium sulfate component(s).

In another embodiment, compositions may contain three basic components of urea, ammonium sulfate and calcium sulfate (especially gypsum) with or without the addition of an agriculturally beneficial material such as a source of nitrogen, phosphorus and/or potassium. In the forgoing type of composition, the calcium sulfate is present in amounts of 1-50% wt, preferably in amounts of 10-40% wt, and most preferably in amounts of 15-35% wt, with the balance of the composition being the non-calcium sulfate component(s).

Table 4, below, presents the amount of additives used in the individual Tests 15-26. Table 5, below presents the final product makeup and the results obtained when tested for nitrogen control release per the Controlled Release Soil Test as described above, in which results showed complete dissolution of urea within 9 hours.

Ammonium sulfate crystals were ground to a particle size less than 0.71 millimeters. A pre-determined amount of de-ionized water was placed in a 1000 mL beaker. A magnetic stir bar and thermocouple were placed in the beaker. The water was pre-heated to 200-205° F. utilizing a lab hotplate. Once the water temperature reached 200° F., a pre-determined amount of ground ammonium sulfate was slowly added while the solution was agitating. Once all of the weighed ammonium sulfate crystals were added to the mixture, the temperature of the mixture was held at 200-205° F. with continuous stirring. In the tests where cornstarch was utilized, the weighed amount of cornstarch was added to the heated ammonium sulfate mixture and homogenized with a laboratory homogenizer.

For ammonium sulfate products that contained phosphate, a pre-weighed amount of di-ammonium phosphate (DAP) or mono-ammonium phosphate (MAP) was added to the mixture with continuous agitation.

In tests 15-26, with the exception of test 24, a pre-weighed amount of gypsum was added to the mixture with continuous agitation. In test 24, CaSO₄.0.5H₂O was added in place of gypsum. In tests 25 and 26, exfoliated perlite as described above (and in steam containing condition) was added to the ammonium sulfate, starch slurry and fully absorbed before introduction of the gypsum.

While the mixture was being prepared, a laboratory pan granulator was pre-heated indirectly with a Bunsen burner by applying heat to the bottom of the pan. The mixture was removed from the beaker and put into the pre-heated laboratory pan granulator. A putty knife was used to scrape the sides and bottom of the pan and to keep the material moving in the pan and promote granule formation.

Once the granular particles were free flowing, they were removed from the laboratory pan granulator and placed in a laboratory scale fluid-bed for further drying. The inlet air temperature in the fluid-bed was 160° F. The granules were dried until the exit air temperature reached approximately 140-145° F. The granules were then removed from the fluid-bed and placed in a laboratory convection oven to finish drying over night. The oven temperature was 120-130° F. Once the granules were dry, they were screened to the desired product size of −5+9 Tyler mesh (2.00-4.00 mm) and bagged.

Test 15

| | | |
|---|---|---|
| 550 grams AmSO ₄ fines | | |
| | {close oversize brace} | 73.3% slurry |
| 200 grams DI H ₂O | | |
| 50 grams DAP | | |
| 7 grams B-810 CS | | |
| 125 grams Gypsum | | |

1. Heat AmSO₄ slurry, stirring to 200° F.
2. Homogenize in CS (thin) (≈195° F.)
3. Add DAP and stir (thin) (≈195° F.)
4. Add Gypsum and stir (paste-like) (≈185° F.)
5. Thickened up in beaker
6. Scrapped out of beaker into lab pan granulator
7. Immediately wanted to “snowball” (over granulate)
8. Added heat with a heat gun and Bunsen burner to dry up the bed
9. Once the bed started to dry, good granulation occurred with normal hand work
10. Dried in lab fluid bed

Test 16

| | | |
|---|---|---|
| 800 grams AmSO ₄ fines | | |
| | {close oversize brace} | 80% slurry |
| 200 grams DI H ₂O | | |
| 50 grams DAP | | |
| 7 grams B-810 CS | | |
| 125 grams Gypsum | | |

1. Heat H₂O to 200° F. and add AmSO₄, stirring and heated
2. Very thick (≈210° F.)
3. Add CS and homogenize (≈195° F.) still thick
4. Add DAP and stirred very well (slurry thinned some) 180° F.
5. Stir in Gypsum, very thick
6. Granulate in lab pan (pre-heated with Bunsen burner)
7. Dried in lab fluid bed

Test 17

| | | |
|---|---|---|
| 800 grams AmSO ₄ fines | | |
| | {close oversize brace} | 80% slurry |
| 200 grams DI H ₂O | | |
| 50 grams MAP | | |
| 7 grams B-810 CS | | |
| 125 grams Gypsum | | |

1. Heat H₂O to 200° F. and add AmSO₄, stirring and heated
2. Very thick (≈205° F.)
3. Add CS and homogenize (≈195° F.) still thick
4. Add MAP and stirred very well (slurry thinned) ≈190° F.
5. Added Gypsum and stirred very well
6. Very thick
7. Granulate in lab pan (pre-heated), wanted to “snowball”
8. Dried in lab fluid bed

Test 18

| | | |
|---|---|---|
| 800 grams AmSO ₄ fines | | |
| | {close oversize brace} | 80% slurry |
| 200 grams DI H ₂O | | |
| 7 grams CS | | |
| 125 grams Gypsum | | |

1. Heat H₂O to 200° F. and add AmSO₄ with stirring and heat
2. Very thick (≈200° F.)
3. Add CS and homogenize
4. Add Gypsum and stir very well (≈180° F.)
5. Very thick
6. Granulated in lab pan (pre-heated with Bunsen burner)
7. Dried in lab fluid bed

Test 19

| | | |
|---|---|---|
| 800 grams AmSO ₄ fines | | |
| | {close oversize brace} | 80% slurry |
| 200 grams DI H ₂O | | |
| 125 grams Gypsum | | |

1. Heat H₂O to 200° F. and add AmSO₄ with stirring and heat
2. Very thick (≈205° F.)
3. Add Gypsum and stir very well (≈180° F.)
4. Very thick
5. Granulated in lab pan (pre-heated with Bunsen burner)
6. Very sticky, wanted to over granulate
7. % N=18.6%

Test 20

| | | |
|---|---|---|
| 550 grams AmSO ₄ fines | | |
| | {close oversize brace} | 73.3% slurry |
| 200 grams DI H ₂O | | |
| 125 grams Gypsum | | |

1. Heat H₂O to 200° F. and add AmSO₄ with stirring and heat
2. Thick (≈205° F.)
3. Very thick
4. Granulated in lab pan (pre-heated with Bunsen burner)
5. Dried in lab fluid bed

Test 21

| | | |
|---|---|---|
| 550 grams AmSO ₄ fines | | |
| | {close oversize brace} | 73.3% slurry |
| 200 grams DI H ₂O | | |
| 50 grams MAP | | |
| 125 grams Gypsum | | |

1. Heat H₂O to 200° F. and add AmSO₄ with stirring and heat
2. Thick (≈205° F.)
3. Add MAP and stir (≈190° F.) slurry thinned some
4. Add Gypsum and stir very well (≈175° F.)
5. Very thick
6. Granulated in lab pan (pre-heated with Bunsen burner)
7. Stayed very sticky, wanted to over granulate
8. Dried in lab fluid bed

Test 22

| | | |
|---|---|---|
| 800 grams AmSO ₄ fines | | |
| | {close oversize brace} | 80% slurry |
| 200 grams DI H ₂O | | |
| 250 grams Gypsum | | |

1. Heat H₂O to 200° F. and add AmSO₄ with stirring and heat
2. Very thick (≈195° F.)
3. Add Gypsum and stir very well (≈150° F.)
4. Set-up in beaker, had to chip out of beaker
5. Granulated in lab pan (pre-heated with Bunsen burner)
6. Formed a lot of small particles
7. Dried in lab fluid bed

Test 23

| | | |
|---|---|---|
| 550 grams AmSO ₄ fines | | |
| | {close oversize brace} | 73.3% slurry |
| 200 grams DI H ₂O | | |
| 250 grams Gypsum | | |

1. Heat H₂O to 200° F. and add AmSO₄ with stirring and heat
2. Thick (≈200° F.)
3. Add Gypsum and stir very well (≈170° F.)
4. Stayed fluid a long time, started to get thick as it was poured into pan to granulated (did not granulate [good])
5. Granulated in lab pan (pre-heated with Bunsen burner)
6. Dried in lab fluid bed

Test 24

| | | |
|---|---|---|
| 800 grams AmSO ₄ fines | | |
| | {close oversize brace} | 80% slurry |
| 200 grams DI H ₂O | | |
| 125 grams CaSO₄ · ½ H₂O | | |

1. Heated H₂O to 200° F. and added AmSO₄ with stirring and heat
2. Very thick (≈205° F.)
3. Added CaSO₄½H₂O and stir very well (≈175° F.)
4. Stayed fluid for a while, then started to thicken up
5. Granulated in lab pan (pre-heated with Bunsen burner)
6. Good granulation
7. Dried in lab fluid bed

Test 25
400 grams AmSO₄ fines
100 grams DI H₂O
15 grams Corn Starch B810
24 grams Exfoliated Perlite
125 grams Gypsum

1. Heated H₂O to 200° F. and add AmSO₄ with stirring and heat

2. Thick mixture (200° F.)

3. Added corn starch to the mixture and homogenized

4. Added exfoliated perlite and absorbed the mixture

5. Added gypsum to the mixture and stirred

6. Removed the mixture from a container and granulated the formulation in a preheated laboratory scale pan.

7. Dried the granules in a lab fluid bed

Test 26
800 grams AmSO₄ fines
200 grams DI H₂O
20 grams Corn Starch B810
24 grams Exfoliated Perlite
125 grams Gypsum

1. Heated H₂O to 200° F. and add AmSO₄ with stirring and heat

2. Thick mixture (200° F.)

3. Added corn starch to the mixture and homogenized

4. Added exfoliated perlite and absorbed the mixture

5. Added gypsum to the mixture and stirred

6. Removed the mixture from a container and granulated the formulation in a preheated laboratory scale pan.

7. Dried the granules in a lab fluid bed

TABLE 4
FORMULATION AMOUNTS FOR AMMONIUM SULFATE PRODUCT TESTS 15-26

| | AMOUNT OF ADDITIVES IN FORMULATION; GRAMS | | | | | | | |
|---|---|---|---|---|---|---|---|---|
| Test Number | (NH4)2SO4 | De-ionized Water | Corn Starch | Exfoliated Perlite | CaSO4.2H2O | CaSO4.½H2O | DAPa | MAPb |
| 15 | 550 | 200 | 7 | — | 125 | — | 50 | — |
| 16 | 800 | 200 | 7 | — | 125 | — | 50 | — |
| 17 | 800 | 200 | 7 | — | 125 | — | — | 50 |
| 18 | 800 | 200 | 7 | — | 125 | — | — | — |
| 19 | 800 | 200 | — | — | 125 | — | — | — |
| 20 | 550 | 200 | — | — | 125 | — | — | — |
| 21 | 550 | 200 | — | — | 125 | — | — | 50 |
| 22 | 800 | 200 | — | — | 250 | — | — | — |
| 23 | 550 | 200 | — | — | 250 | — | — | — |
| 24 | 800 | 200 | — | — | — | 125 | — | — |
| 25 | 400 | 200 | 15 | 24 | 125 | — | — | — |
| 26 | 800 | 200 | 20 | 24 | 125 | — | — | — |

aDAP—Diammonium Phosphate
bMAP—Monoammonium Phosphate

TABLE 5
TEST AMMONIUM SULFATE BASED GRANULATION PRODUCTS AND CORRESPONDING
CONTROL RELEASE SOIL TEST RESULTS

| | (NH₄)₂SO₄ | | | | | | | | | | | |
|---|---|---|---|---|---|---|---|---|---|---|---|---|
| | slurry | | | | | | | | | Control Release | | |
| | concentration | Type of | PRODUCT MAKE-UP | | | | | | | Soil Test | | |
| Test | used | CaSO₄ | Exfoliated | Corn | DAP^{a} | MAP^{b} | CaSO₄ as | | Total | 9 | 24 | 3 |
| Number | in process, % | used, % | Perlite, % | Starch % | % | % | Gypsum, % | (NH₄)₂SO₄ % | N^{c} % | HR | HR | DAY |
| AS | 100 | N/A | 0 | 0 | 0 | 0 | 0 | 100 | 21.3 | 56.8 | 30.0 | 0 |
| 15 | 73.3 | 2H2O | 0 | 0.96 | 6.8 | 0 | 17.1 | 75.1 | 14.7 | 54.6 | 32.3 | N/D |
| 16 | 80.0 | 2H2O | 0 | 0.7 | 5.1 | 0 | 12.7 | 81.5 | 17.6 | 66.7 | 36.9 | 11.4 |
| 17 | 80.0 | 2H2O | 0 | 0.7 | 0 | 5.1 | 12.7 | 81.5 | 16.3 | 51.3 | 27.3 | 7.8 |
| 18 | 80.0 | 2H2O | 0 | 0.8 | 0 | 0 | 13.4 | 85.8 | 14.9 | 61.0 | 37.1 | N/D |
| 19 | 80.0 | 2H2O | 0 | 0 | 0 | 0 | 13.5 | 86.5 | 18.6 | 55.2 | 40.9 | 7.0 |
| 20 | 73.3 | 2H2O | 0 | 0 | 0 | 0 | 18.5 | 81.5 | 17.2 | 62.9 | 38.9 | 11.3 |
| 21 | 73.3 | 2H2O | 0 | 0 | 0 | 6.9 | 17.2 | 75.9 | 16.1 | 50.4 | 40.6 | 14.5 |
| 22 | 80.0 | 2H2O | 0 | 0 | 0 | 0 | 23.8 | 76.2 | 15.4 | 67.9 | 35.4 | N/D |
| 23 | 73.3 | 2H2O | 0 | 0 | 0 | 0 | 31.3 | 68.7 | 13.9 | 71.0 | 34.9 | N/D |
| 24 | 80.0 | ½H2O | 0 | 0 | 0 | 0 | 13.5 | 86.5 | 17.9 | 70.9 | 36.0 | 13.4 |
| 25 | 67.0 | 2H2O | 4.3 | 2.7 | 0 | 0 | 22.2 | 70.8 | 13.3 | 85.5 | 52.1 | 25.0 |
| 26 | 80.0 | 2H2O | 2.5 | 2.1 | 0 | 0 | 12.9 | 82.5 | 14.5 | 68.0 | 33.0 | 12.4 |

^{a}DAP—Diammonium Phosphate
^{b}MAP—Monoammonium Phosphate
^{c}Based on Final Product Analysis

Observations Concerning Test Results

In the case of ammonium sulfate, the inclusion of gypsum provides enhanced control release properties of ammonium sulfate with and without corn starch and exfoliated perlite. Certainly with perlite and corn starch such as Test 25, the control release of the ammonium sulfate is greatly enhanced. The control release soil test shows 25% retention of nitrogen after 3 days.

By using gypsum, ammonium sulfate slurries can be granulated up to 80% ammonium sulfate, generally because during the granulation, the gypsum losses some of its water of hydration making the slurry easier to handle and then reforms as the temperature is reduced, thus making the slurry more viscous and solidify better.

### Example 18

Effects of Compositions on Growth and Color of Hybrid-419 Bermudagrass

The effect of nitrogen type was evaluated on the quality of hybrid bermudagrass grown under golf course conditions. Five fertilizer compositions were tested which included five compositions of the present invention, urea and Scotts Turf Builder. Nitrogen sources were applied individually at a rate of 1 lb N/1,000 ft² on Apr. 19, 2004. Field test plots were rated weekly for visual quality and scanned for digital image analysis. The nitrogen source type had a significant effect on turf quality ratings relative to unfertilized turf.

Materials and Methods

Research was conducted on a fairway at Pleasant Valley Country Club in Little Rock, Arkansas. The hybrid “419” was bermudagrass was grown and was mowed at 0.5 inches height and clippings were not collected. Nitrogen sources were applied at a rate of 1 lb N/1,000 ft² on Apr. 19, 2004. Plots were 3 ft.×6 ft. Air temperatures on April 19th were 65-75° F. Turf quality ratings were made weekly by a single evaluator. Quality ratings considered turf growth and color. A rating of 6 was considered the minimum acceptable turf; a rating of 9 was not considered favorable from a management standpoint since growth was excessive and required frequent mowing. A visual rating of 8 would be considered excellent. Plots were also evaluated weekly using a digital image analysis. Digital images were taken with a Nikon CoolPix 880 camera with a shutter speed of 1/30 sec. and an aperture of f/2.8. Images were downloaded to a personal computer for subsequent analysis. Ratings were terminated when the nitrogen treated plots could not be visually separated from the control. Treatments consisted of 4 single plot replications. The experimental design was a completely randomized design.

The test fertilizer compositions were the following:

Composition No. 4121
(96% Urea Melt+1% Corn Starch B810+4.5% Perlite) (Dry Basis)
NPK=44:0:0 ratio of nitrogen:phosphorus:potassium

Size=SGN 215 (2.15 mm) particle size (SGN=size guide number. Divide the SGN value by 100 to yield size in millimeters, e.g. SGN 215=2.15 mm particle size)

500 pound Batch

| | | |
|---|---|---|
| 472.5 | pounds | Urea |
| 19.7 | pounds | Water |
| 5 | pounds | Corn Starch B810 |
| 25 | pounds | Perlite 3-S |

Weighed 472.5 pounds urea granules
Added 19.7 pounds of water
Heated material until the urea was molten
Added Corn Starch B810 to the melt and homogenized
Added steamed perlite to the melt
Added the mixture to a drum and granulated

Once the granular controlled release fertilizer was granulated, it was dry blended with granular diammonium phosphate and granular potassium chloride to produce an NPK=38:3:4 ratio of nitrogen:phosphorus:potassium

(Granular controlled release fertilizer + Diammonium
Phosphate + Potassium Chloride)
500 pound Batch

| | | |
|---|---|---|
| 435.2 | pounds | Granular controlled release fertilizer (44:0:0) |
| 32.6 | pounds | Diammonium Phosphate |
| 32.2 | pounds | Potassium Chloride |

Added the granular controlled release fertilizer, granular diammonium phosphate, granular potassium chloride to a mixer and blended the three components together to produce a blended product
Composition No. 4122
(96% Urea Melt+1% Corn Starch B810+6.4% Potassium Chloride+6.5% Diammonium Phosphate+5% Perlite) (Dry Basis)
NPK=40:3:4 ratio of nitrogen:phosphorus:potassium

Size=SGN 215 (2.15 mm) particle size (SGN=size guide number. Divide the SGN value by 100 to yield size in millimeters, e.g. SGN 215=2.15 mm particle size)

500 pound Batch

| | | |
|---|---|---|
| 405.5 | pounds | Urea |
| 16.9 | pounds | Water |
| 5 | pounds | Corn Starch B810 |
| 32.2 | pounds | Potassium Chloride |
| 25 | pounds | Perlite 3-S |
| 32.6 | pounds | Diammonium Phosphate |

Weighed 405.5 pounds urea granules
Added 16.9 pounds of water
Heated material until the urea was molten
Added potassium chloride and mixed
Added Corn Starch B810 to the mixture and homogenized
Added steamed perlite to the melt
Added diammonium phosphate
Added the mixture to a drum and granulated
Composition No. 4123
(96% Urea Melt+1% Corn Starch B810+6.4% Potassium Chloride+6.5% Diammonium Phosphate+5% Perlite) (Dry Basis)
NPK=39:3:4 ratio of nitrogen:phosphorus:potassium

Size=SGN 165 particle size (SGN=size guide number. Divide the SGN value by 100 to yield size in millimeters, e.g. SGN 165=1.65 mm particle size)

500 pound Batch

| | | |
|---|---|---|
| 405.3 | pounds | Urea |
| 16.9 | pounds | Water |
| 5 | pounds | Corn Starch B810 |
| 32.2 | pounds | Potassium Chloride |
| 25 | pounds | Perlite 3-S |
| 32.6 | pounds | Diammonium Phosphate |

Weighed 405.3 pounds urea granules
Added 16.9 pounds of water
Heated material until the urea was molten
Added potassium chloride and mixed
Added Corn Starch B810 to the mixture and homogenized
Added steamed perlite to the melt and stirred
Added diammonium phosphate and stirred
Added the mixture to a drum and granulated
Composition: Composition No. 4124
(98% Urea Melt+1% Corn Starch B810+6.4% Potassium Chloride+6.5% Diammonium Phosphate+5% Perlite+8% Gypsum (calcium sulfate dihydrate)) (Dry Basis)
NPK=35.8:3:4 ratio of nitrogen:phosphorus:potassium

Size=SGN 165 (1.65 mm) particle size (SGN=size guide number. Divide the SGN value by 100 to yield size in millimeters, e.g. SGN 165=1.65 mm particle size)

500 pound Batch

| | | |
|---|---|---|
| 365.3 | pounds | Urea |
| 7.45 | pounds | Water |
| 5 | pounds | Corn Starch B810 |
| 32.2 | pounds | Potassium Chloride |
| 25 | pounds | Perlite 3-S |
| 32.6 | pounds | Diammonium Phosphate |
| 40 | pounds | Gypsum (calcium sulfate dihydrate) |

Weighed 365.3 pounds urea granules
Added 7.45 pounds of water
Heated material until the urea was molten
Added potassium chloride and mixed while homogenizing
Added Gypsum (calcium sulfate dihydrate) to the mixture while homogenizing
Added Corn Starch B810 to the mixture while homogenizing
Added steamed perlite to the melt and stirred
Added diammonium phosphate and stirred
Added the mixture to a drum and granulated
Composition No. 4125
(70% Ammonium Sulfate Solution+1% Corn Starch B810+11.5% Potassium Sulfate+20% Gypsum (calcium sulfate dihydrate)
NPK=14:0:5

Size=SGN 215 (2.15 mm)

500 gram batch

| | | |
|---|---|---|
| 333 | grams | Ammonium Sulfate crystals |
| 143.2 | grams | Water |
| 57.7 | grams | Potassium Sulfate |
| 5 | grams | Corn Starch B810 |
| 104 | grams | Gypsum (calcium sulfate dihydrate) |

Added water and ammonium sulfate crystals together and heated the mixture to 200° F.
Added corn starch B810 and homogenized
Added potassium sulfate to the mixture and homogenized
Added Gypsum to the mixture and stirred
Added the materials to a pan granulator while applying heat to the granulator shell
Granulated the materials and screened to product size

Composition No. 3064 (Scott's Turfbuilder® Lawn Fertilizer)

Scott's Turfbuilder ® Lawn Fertilizer

NPK: 29-3-4
Total Nitrogen (N) 29%
5.3% Ammoniacal Nitrogen 13.0% Urea Nitrogen
9.8% Other Water Soluble Nitrogen* 0.9% Water Insoluble Nitrogen
Available Phosphate (P₂0₅) 3%
Soluble Potash (K₂0) 4%
Sulfur (S) 6%
6.0% Combined Sulfur (S)
Iron (Fe) 1%
Manganese (MN Total) 0.5%
0.33% Water Soluble Manganese (MN)

Derived From: urea, methyleneurea, sulfate of potash, monoammonium phoshate, ferrous sulfate, manganese oxide, manganese sulfate, ammonium sulfate.
Contains 7.0% slowly available methylenediurea and dimethylenetriurea nitrogen.
Composition Urea
Product Name: Granular Urea
Chemical Name: Carbamide
White solid
NPK=46:0:0 ratio of nitrogen:phosphorus:potassium
Size=SGN 240 (2.40 mm) particle size (SGN=size guide number. Divide the SGN value by 100 to yield size in millimeters, e.g. SGN 240=2.40 mm particle size)
Control Treatment: No Fertilizer

Test results for visual turf quality are shown in the following Table 6 and test results for color characteristic is shown in the following Table 7.

TABLE 6
Results of Visual Turf Quality for Hybrid “419” Bermudagrass
Nitrogen Sources

| Test | | | | | | | | | |
|---|---|---|---|---|---|---|---|---|---|
| Com- | | | | | | | | | |
| position | Apr. 19, 2004 | May 3, 2004 | May 9, 2004 | May 16, 2004 | May 24, 2004 | Jun. 1, 2004 | Jun. 7, 2004 | Jun. 14, 2004 | Jun. 21, 2004 |
| 4124 | 6.5 | 7.8abc | 8.0abcd | 8.3abc | 8.1abcde | 7.7 cde | 7.7bcde | 7.7bcd | 7.5bc |
| 4122 | 6.5 | 7.6abcd | 8.3ab | 8.3abc | 8.6abc | 7.8bcde | 8.0abcde | 7.5 cd | 7.5bc |
| 4123 | 6.5 | 8.0a | 8.3ab | 8.0abcd | 8.3abcde | 7.7 cde | 7.8abcde | 7.8bcd | 7.5bc |
| 4125 | 6.5 | 8.1a | 8.6 a | 8.6ab | 8.8ab | 8.3abcd | 8.0abcde | 7.8bcd | 7.6abc |
| 4121 | 6.5 | 6.5d | 7.6abcd | 8.1abcd | 8.1abcde | 7.8bcde | 7.8abcde | 7.8bcd | 7.6abc |
| 3064 | 6.5 | 6.5d | 7.0 cd | 8.3abc | 8.2abcde | 8.2abcd | 7.8abcde | 7.9bcd | 7.5bc |
| Urea | 6.5 | 7.5abcd | 7.3bcd | 7.5abcd | 7.7bcdef | 7.7 cde | 7.7bcde | 7.6bcd | 7.5bc |
| Control | 6.5 | 6.5d | 6.8d | 6.8d | 6.8f | 6.8e | 7.0e | 7.1d | 7.4c |

TABLE 7
Results of Measured Color Hue for Hybrid Bermudagrass
Hue ratings: mean of 4 repetitions; fertilizer applied on Apr. 19, 2004.

| | Hue | Hue | Hue | Hue | Hue | Hue | | |
|---|---|---|---|---|---|---|---|---|
| | May 3, 2004 | May 10, 2004 | May 17, 2004 | May 24, 2004 | Jun. 1, 2004 | Jun. 7, 2004 | Jun. 14, 2004 | Jun. 21, 2004 |
| 4124 | 33.489 | 30.325 | 28.365 | 28.678 | 28.117 | 26.355 | 27.123 | 24.794 |
| 4122 | 28.791 | 31.579 | 27.687 | 28.805 | 30.667 | 25.817 | 26.777 | 24.096 |
| 4123 | 28.051 | 29.970 | 31.293 | 28.174 | 33.204 | 26.687 | 26.138 | 25.073 |
| 4125 | 32.064 | 28.977 | 31.406 | 30.027 | 31.941 | 27.597 | 28.671 | 24.841 |
| 4121 | 26.977 | 25.975 | 28.415 | 29.023 | 28.217 | 26.682 | 27.944 | 25.545 |
| 3064 | 27.374 | 28.666 | 32.794 | 29.853 | 30.221 | 27.176 | 28.422 | 26.378 |
| Urea | 29.085 | 30.702 | 30.920 | 29.943 | 31.589 | 27.101 | 28.324 | 25.750 |

Conclusions

The gypsum containing products 4124 and 4125 greened-up 419 Bermudagrass significantly faster than the other products as seen by the color hue measurements appearing on Table 7 for May 3, 2004 where the gypsum containing products measured >15% and 10% greener than urea and even more significantly greener than the other products total. In addition to early greening the products provided extended good quality ratings (above 7.5) as shown by Table 6 for the duration of the nine (9) weeks of test duration.

### Example 19

Growth Response of PennEagle Creeping Bentgrass in Central Pennsylvania

This Example sets forth evaluations of several gypsum (calcium sulfate dihydrate) fertilizer compositions of the present invention on the grass, PennEagle Creeping Bentgrass Fairway.

Materials And Methods

In May, 2004, an experimental design with 4 blocks of 12 plots (4×8 ft. in area) was initiated on a 4-year old PennEagle creeping bentgrass fairway at the Valentine Turfgrass Research Facility, University Park, Pa. Prior to treatments, soil in the experimental region was sampled at the 0-4″ (minus thatch) and 4-8″ depths, and the plots were mowed at ½ inch height. Eight fertilizers were applied in four replicated blocks on May 8, 2004. Weather conditions immediately following the initial fertilizer application were dry, yet one-half inch of rain did fall at 3 pm on May 9, 2004. The plots were not mowed until May 12, when 0.3″ of precipitation fell in University Park. This date (May 12) served as time zero [0 days after treatment (DAT)].

Turfgrass clipping yields were measured 9, 13, 21, 24, 31, 40, 47, 61, and 74 DAT. Clipping yields were oven dried, weighed and standardized (relatively) for each collection date. Clipping yields are reported in relative clipping yield (RCY), which is a unit-less number, a fraction of the greatest clipping yield observed in any experimental block on any sampling date. Digital images of plots were captured 0, 2, 15, 21, 28, 37 and 54 DAT. These high-resolution images (≧3.0 Mg pixels) were qualitatively analyzed using SigmaScan software (SPSS, Chicago, Ill.) as described by Karcher and Richardson (Karcher, D. E., and M. D. Richardson. 2003. Quantifying turfgrass color using digital image analysis. Crop Science 43: 943-951). Comparing these dark green color index (DGCI) values enabled statistical analysis of canopy color data. Clippings collected 13 and 31 DAT were dried, ground, and analyzed for total nutrient content at the Agricultural Analytical Services Laboratory (AASL, University Park, Pa.). Clippings collected 24 and 47 DAT were dried, ground, and analyzed for N content. Nitrogen uptake (NUP) is calculated as the RCY (0-1) times the N content of tissue (%), and is generally unit-less and should be considered an index for comparing treatments.

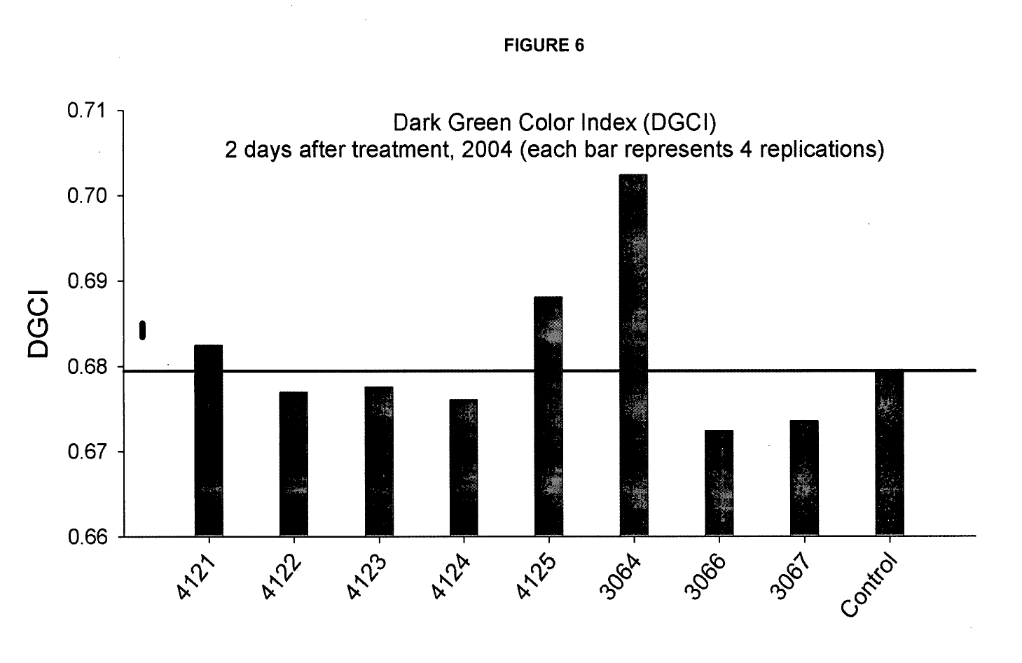

The PennEagle fairway was mowed three times weekly at a 0.5″ height. Plots were irrigated equally to prevent wilt. Pesticides were applied as necessary to control pest infestations, following standard golf course management practices. Weather conditions were monitored at the Valentine Weather Station (University Park, Pa.; FIG. 6).

Statistical analysis was conducted by general linear modeling procedures using SAS/STAT software. Analysis of repeated measures employed the appropriate interactive error terms (either as a split-plot effect or repeated measure analysis), and means were separated at a 0.05 alpha level, by either orthogonal contrasts or Tukey's Studentized Range.

TABLE 8
Preliminary soil fertility status of experimental site, April 2004.

| | Soil pH | P₂O₅ | K | Mg | Ca | CEC |
|---|---|---|---|---|---|---|
| Soil Depth | (1:1 H₂O) | (lbs/A) | [meq(100 g soil)₋₁] | | | |
| 1-4″ (thatch removed) | 6.7 | 540 | 0.5 | 3.0 | 8.7 | 14.10 |
| 4-8″ | 6.8 | 508 | 0.4 | 2.55 | 7.7 | 12.55 |

The test fertilizer compositions were the following:

Composition No. 4121
(96% Urea Melt+1% Corn Starch B810+4.5% Perlite) (Dry Basis)
NPK=44:0:0 ratio of nitrogen:phosphorus:potassium

Size=SGN 215 (2.15 mm) particle size (SGN=size guide number. Divide the SGN value by 100 to yield size in millimeters, e.g. SGN 215=2.15 mm particle size)

500 pound Batch

| | | |
|---|---|---|
| 472.5 | pounds | Urea |
| 19.7 | pounds | Water |
| 5 | pounds | Corn Starch B810 |
| 25 | pounds | Perlite 3-S |

Weighed 472.5 pounds urea granules
Added 19.7 pounds of water
Heated material until the urea was molten
Added Corn Starch B810 to the melt and homogenized
Added steamed perlite to the melt
Added the mixture to a drum and granulated
Once the granular controlled release fertilizer was granulated, it was dry blended with granular diammonium phosphate and granular potassium chloride to produce an NPK=38:3:4 ratio of nitrogen:phosphorus:potassium
(Granular controlled release fertilizer+Diammonium Phosphate+Potassium Chloride)

500 pound Batch

| | | |
|---|---|---|
| 435.2 | pounds | Granular controlled release fertilizer |
| | | (44:0:0) |
| 32.6 | pounds | Diammonium Phosphate |
| 32.2 | pounds | Potassium Chloride |

Added the granular controlled release fertilizer, granular diammonium phosphate, granular potassium chloride to a mixer and blended the three components together to produce a blended product
Composition No. 4122
(96% Urea Melt+1% Corn Starch B810+6.4% Potassium Chloride+6.5% Diammonium Phosphate+5% Perlite) (Dry Basis)
NPK=40:3:4 ratio of nitrogen:phosphorus:potassium

Size=SGN 215 (2.15 mm) particle size (SGN=size guide number. Divide the SGN value by 100 to yield size in millimeters, e.g. SGN 215=2.15 mm particle size)

500 pound Batch

| | | |
|---|---|---|
| 405.5 | pounds | Urea |
| 16.9 | pounds | Water |
| 5 | pounds | Corn Starch B810 |
| 32.2 | pounds | Potassium Chloride |
| 25 | pounds | Perlite 3-S |
| 32.6 | pounds | Diammonium Phosphate |

Weighed 405.5 pounds urea granules
Added 16.9 pounds of water
Heated material until the urea was molten
Added potassium chloride and mixed
Added Corn Starch B810 to the mixture and homogenized
Added steamed perlite to the melt
Added diammonium phosphate
Added the mixture to a drum and granulated
Composition No. 4123
(96% Urea Melt+1% Corn Starch B810+6.4% Potassium Chloride+6.5% Diammonium Phosphate+5% Perlite) (Dry Basis)
NPK=39:3:4 ratio of nitrogen:phosphorus:potassium

Size=SGN 165 particle size (SGN=size guide number. Divide the SGN value by 100 to yield size in millimeters, e.g. SGN 165=1.65 mm particle size)

500 pound Batch

| | | |
|---|---|---|
| 405.3 | pounds | Urea |
| 16.9 | pounds | Water |
| 5 | pounds | Corn Starch B810 |
| 32.2 | pounds | Potassium Chloride |
| 25 | pounds | Perlite 3-S |
| 32.6 | pounds | Diammonium Phosphate |

Weighed 405.3 pounds urea granules
Added 16.9 pounds of water
Heated material until the urea was molten
Added potassium chloride and mixed
Added Corn Starch B810 to the mixture and homogenized
Added steamed perlite to the melt and stirred
Added diammonium phosphate and stirred
Added the mixture to a drum and granulated
Composition No. 4124 (Present Invention Composition)
(98% Urea Melt+1% Corn Starch B810+6.4% Potassium Chloride+6.5% Diammonium Phosphate+5% Perlite+8% Gypsum (calcium sulfate dihydrate)) (Dry Basis)
NPK=35.8:3:4 ratio of nitrogen:phosphorus:potassium

Size=SGN 165 (1.65 mm) particle size (SGN=size guide number. Divide the SGN value by 100 to yield size in millimeters, e.g. SGN 165=1.65 mm particle size)

500 pound Batch

| | | |
|---|---|---|
| 365.3 | pounds | Urea |
| 7.45 | pounds | Water |
| 5 | pounds | Corn Starch B810 |
| 32.2 | pounds | Potassium Chloride |
| 25 | pounds | Perlite 3-S |
| 32.6 | pounds | Diammonium Phosphate |
| 40 | pounds | Gypsum (calcium sulfate dihydrate) |

Weighed 365.3 pounds urea granules
Added 7.45 pounds of water
Heated material until the urea was molten
Added potassium chloride while homogenizing
Added Gypsum (calcium sulfate dihydrate) to the mixture while homogenizing
Added Corn Starch B810 to the mixture while homogenizing
Added steamed perlite to the melt and stirred
Added diammonium phosphate and stirred
Added the mixture to a drum and granulated
Composition No. 4125 (Present Invention Composition)
(70% Ammonium Sulfate Solution+1% Corn Starch B810+11.5% Potassium Sulfate+20% Gypsum (calcium sulfate dihydrate)
NPK=14:0:5

Size=SGN 215 (2.15 mm)

500 gram batch

| | | |
|---|---|---|
| 333 | grams | Ammonium Sulfate crystals |
| 143.2 | grams | Water |
| 57.7 | grams | Potassium Sulfate |
| 5 | grams | Corn Starch B810 |
| 104 | grams | Gypsum (calcium sulfate dihydrate) |

Added water and ammonium sulfate crystals together and heated the mixture to 200° F.
Added corn starch B810 and homogenized
Added potassium sulfate to the mixture and homogenized
Added Gypsum to the mixture and stirred
Added the materials to a pan granulator while applying heat to the granulator shell
Granulated the materials and screened to product size

The above composition was made as follows:

A 42-inch pan granulator, a small steam-jacketed pugmill, a steam-jacketed mix tank, and homogenizer were set-up to produce 14-0-5 ammonium sulfate gypsum product. The pan granulator was placed on approximately a 45-degree angle. A scraper was mounted to keep the material from sticking to the pan. A blower was used to supply heated air to the pan to dry the material during granulation. The material from the pan was screened on a Sweco screener with screens for a product cut of −6+9 market grade.

Ammonium sulfate crystals were milled to a fine powder. Water was weighed and placed in the steam-jacketed tank. Ammonium sulfate was weighed to produce a 75% solution when added to the water in the tank. The ammonium sulfate was slowly added to the tank. Once the level in the tank was above the homogenizer head, the homogenizer was started to mix the ammonium sulfate and water. The remaining ammonium sulfate was added to the tank with continued mixing. The amount of cornstarch equal to 1% of the final product was weighed and added to the tank while mixing. The solution became very thick and was discharged to the pugmill. The pre-weighed amount of gypsum was metered to the pugmill as the solution was added. The material from the pugmill discharge was returned to the inlet of the pugmill to allow for complete mixing of the gypsum and for removal of as much water as possible before granulation in the pan. Once the material was mixed, a portion of the material was placed in the pan and worked with hand pressure while heating with the hot air from the blower. As the material began to granulate, large granules were formed. With continued working of the granules by hand pressure, the particle size was reduced. The material was removed from the pan and screened on the Sweco screener. The undersize (recycle) was placed in the pan to help dry out the next portion of the pugmill material placed in the pan. This step was continued until all of the material from the pugmill had been granulated in the pan and screen. The resulting product granules were dried in a fluid-bed before being sent out for turf tests.

Composition No. 3064 (Scott's Turfbuilder® Lawn Fertilizer)

Scott's Turfbuilder ® Lawn Fertilizer

NPK: 29-3-4
Total Nitrogen (N) 29%
5.3% Ammoniacal Nitrogen 13.0% Urea Nitrogen
9.8% Other Water Soluble Nitrogen* 0.9% Water Insoluble
Nitrogen
Available Phosphate (P₂0₅) 3%
Soluble Potash (K₂0) 4%
Sulfur (S) 6%
6.0% Combined Sulfur (S)
Iron (Fe) 1%
Manganese (MN Total) 0.5%
0.33% Water Soluble Manganese (MN)

Derived From: urea, methyleneurea, sulfate of potash, monoammonium phoshate, ferrous sulfate, manganese oxide, manganese sulfate, ammonium sulfate.
Contains 7.0% slowly available methylenediurea and dimethylenetriurea nitrogen.
Urea Composition (Composition No. 3066)
(Blend of 80.1% Urea+6.5% Diammonium Phosphate+6.4% Potassium Chloride+7.0% Limestone)
NPK=38:3:4

Size=215 (2.15 mm)

500 pound Batch

| | | |
|---|---|---|
| 400.3 | pounds | Urea |
| 32.6 | pounds | Diammonium Phosphate |
| 32.2 | pounds | Potassium Chloride |
| 35 | pounds | Limestone |

Added the granular urea, granular diammonium Phosphate, granular potassium chloride, and granular limestone to a mixer and blended the four components together to produce a blended product
Ammonium Sulfate Composition (Composition No. 3067)
Product Name: SULF-N 45 Ammonium Sulfate
Generic Names: Ammonium sulfate; Diammonium sulfate
Produced by Honeywell, Morristown, New Jersey
Colorless to dark brown granules
NPK=21:0:0:24 ratio of nitrogen:phosphorus:potassium:sulfur
Size=SGN 240 (2.40 mm) particle size (SGN=size guide number. Divide the SGN value by 100 to yield size in millimeters, e.g. SGN 240=2.40 mm particle size)
Negative Control Treatment: No Fertilizer
Results
May Application and Short-Term Response

Edaphic conditions of the fairway prior to fertilizer application were optimal, and are described in Table 8 above. The soil series present at the experimental site was an unamended Hagerstown silt loam with a slight thatch/mat layer (˜0.3″).

Two days after treatment (2 DAT), color differences between fertilizers and rates had developed, and these color differences between fertilized plots and the negative control were stark. Whenever color (DGCI) ratings of recently-fertilized plots straddle the color value exhibited by the unfertilized (negative control) value, there are two processes generally occurring. The more favorable process is N uptake in moderation, resulting in significant greening and vibrant growth within 36-60 hours of fertilizer activation. The less-preferred process is overload of ionic salt N (often plant available N), resulting in local tissue desiccation (foliar burn). Local tissue desiccation was observed in fertilizer-treated plots in this study (2 lb N/M) (“M” refers to 1,000 ft²).

Two days after treatment (DAT), fertilized plots having DGCI values below the horizontal reference line in FIG. 6, show persistent discoloration typical of local tissue/foliar burn. The horizontal line represents the average control plot color (DGCI), with neither desiccation damage nor nitrogen-induced darkening in its canopy. Thus, when fertilizer Compositions 4122, 4123, 4124, 3066, and 3067 were applied at the 2 lb N/M rate, unfavorable tissue desiccation was observed (briefly). Conversely, when fertilizer Compositions 4121, 4125, and 3064 were applied at the 2 lb N/M rate, less availability of ionic N resulted in favorable greening and growth. Plots treated with these fertilizers showed improved color 2 DAT, when compared to the negative control plots.

Nine DAT, clipping yields of all the plots fertilized at the 2 lb N/M rate significantly exceeded the clipping yield from the negative control plots. The 3064 treated plot demonstrated significantly darker green color than every other fertilizer, 2 DAT (see FIG. 6). This enhanced color is likely the result of other nutrients contained in the 3064 Composition, namely 2% soluble Fe and 1% soluble Mn. On the other end of the growth spectrum, the 2 lb N/M application of Composition 4125 resulted in a rather persistent flush of growth. The Composition 4125 fertilizer likely possessed a fairly-slow-release mechanism that limited N availability and resultant tissue desiccation immediately following “activation”, but did not limit N availability much longer than the first week following activation (FIG. 2).

Considering that the 3067 composition is 100% soluble, agricultural-grade ammonium sulfate, and the DGCI values of treated plots 2 DAT were less than those observed in the control plots, there was significant tissue desiccation the 3067 plots following the 2 lb N/M application, particularly at 9 DAT. The PennEagle grass of the 3067 plots recovered by 13 DAT and demonstrated signs of significant N availability over the following 5-week period.

Thirteen days after treatment (DAT), all plots demonstrated continually-more rapid growth than the control plots, as expected. Clippings collected 13 DAT were analyzed for total nutrient concentration, and nitrogen concentration will be discussed as well as used to calculate N uptake (NUP) data. At 13 DAT, Leaf N was (quite remarkably) elevated in all plots treated at the 2 lb N/M rate (Table 2). Fortunately, leaf concentrations of the other primary nutrients were at the upper end of optimal ranges (Appendix A). The sufficiency level of N in creeping bentgrass leaf tissue is not exactly etched in stone, but exists between 5 and 6% N by dry mass.

TABLE 9
Leaf N and nitrogen uptake (NUP) measured 13 DAT. Treatment
mean values followed by different letters indicate significant
differences (α = 0.05).

| Fertilizer Code | Leaf N | (%) | Uptake (index) |
|---|---|---|---|
| 4121 | 6.66 | bc* | 4.73 bcd |
| 4122 | 6.68 | Bc | 4.41 bcd |
| 4123 | 6.46 | C | 4.18 cde |
| 4124 | 6.55 | C | 4.78 bc |
| 4125 | 7.05 | A | 6.93 a |
| 3064 | 6.57 | Bc | 4.20 cd |
| 3066 | 6.67 | Bc | 5.11 bc |
| 3067 | 6.80 | Ab | 5.27 b |
| Negative control plots | 5.13 | E | 1.99 f |

*Tukey's Studentized Range Test

The average NUP from plots treated with the Composition 4125 fertilizer (@ 2 lb N/M) were extremely high, approximately 32% greater than the next observed (Composition 3067 @ 2 lb N/M) NUP level. Considering that Composition 3067 is agricultural grade ammonium sulfate, containing 100% soluble and plant available NH4⁺, one suspects that the Composition 4125 material contains significant nitrate N. The 2 lb N/M application of both Compositions 3067 and 3066 resulted in the second and third greatest clipping yield and N uptake, respectively, 13 DAT (Table 9). Likewise, the Compositions 4121 and 4124 fertilizers have released a good portion of plant-available N and have fostered consistent growth at the 13 DAT sampling. At 24 DAT, the Compositions 4125, 3067, and 3066 reside in the top statistical group for clipping yield. At 31 DAT, the Composition 4125 fertilized plots appear to running low on available N, as relative clipping yield dips below 0.7 (70% of maximum level), but other physiological issues are more likely responsible. Leaf N of the Composition 4125 fertilized plots still resides in the top statistical group (5.81% N) at 31 DAT, yet growth was comparatively limited. Thus 30 days of N-induced top growth stimulation eventually has a detrimental effect. Overzealous production of leaves, shoots, and stolons during the first 30-days of the study likely occurred at the expense of root growth, development, and maintenance. Bankrupt carbohydrate reserves often curb growth and quality of a turfgrass stand, especially during periods of heat stress. This observation emphasizes the importance of consistent, moderate N-release over the 5-7 weeks following a 2 lb N/M application, such as proved by an extended release fertilizer.

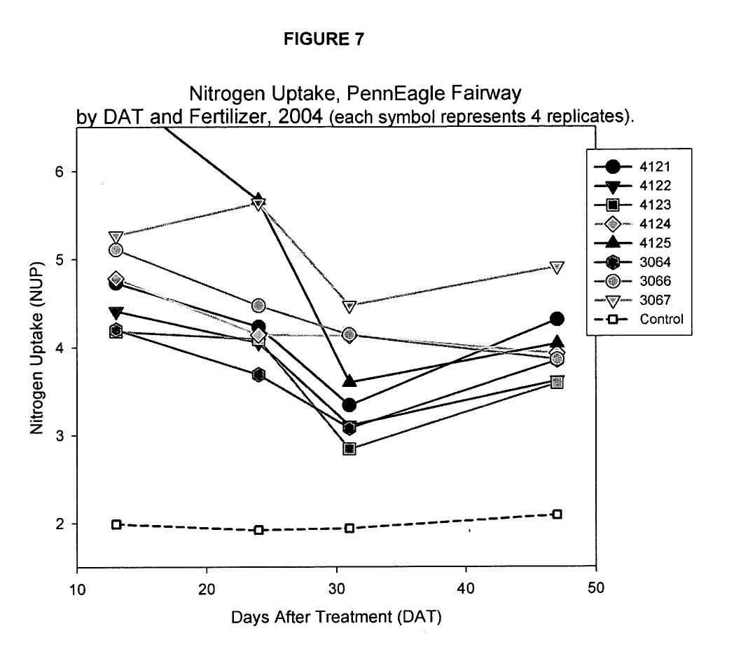

Nitrogen uptake (NUP) over a majority of the experimental period is shown in FIG. 7. The N release from the Composition 4125 fertilizer at 24 DAT has receded from the 13 DAT levels. Observed NUP levels have decreased from 13 to 24 DAT for all experimental plots except the 3067-fertilized plots and negative control plots (FIG. 7). Both the Compositions 4125 and 3067 fertilized plots contain significantly greater leaf N at 24 DAT than all other treatments (6.1 and 6.3% N, respectively), while the Compositions 4124 and 3066 fertilized plots reside in the second statistical grouping (5.7 and 5.8% N, respectively). From 24 to 31 DAT, some fertilizers demonstrated a slower descent than others. For example, the Compositions 4124 and 3066 fertilizer applications (2 lb N/M) resulted in a leveling-off of NUP from 24 to 31 DAT, whereas most other fertilizers are releasing less and less N, failing to support growth and sufficient leaf N concentrations (FIG. 7).

Dark green color indices (DGCI) are useful in determining color and inferring chlorophyll concentration of the bentgrass canopy. However, there are days where the DGCI data does not seem to make much sense. Fertilizers that tended to promote dark green color include the Composition 3064 product. The 3064 fertilizer was a top performer as far as canopy color evaluations went. Again, this is likely related to its iron and manganese inclusions. For example, the total nutrient concentration data (13 DAT) showed leaf Mn of plots fertilized with Composition 3064 at 2 lb N/M to reach a level of 117 ppm. This level is well into the Mn sufficiency range, and was significantly greater than Compositions 4121, 4122, 4123, and 4124 fertilized plots, and control.

Long-Term Fertilizer Response and Split Applications

At the 31 DAT tissue analysis, the Compositions 3066, 3067, and 4124 fertilized-plots continue to exhibit elevated NUP levels. Oddly, only the 3066 fertilized plots demonstrated dark green color comparatively at the 37 DAT image collection. From 31 to 47 DAT, NUP of the 2 lb N/M fertilizer rates remained between 3.5 and 4.5. At 40 DAT, RCY data show the Compositions 3067, 3066, and 4122 fertilizers (all at the 2 lb N/M rate) in the top statistical group.

At 47 DAT, RCY data shows Composition 3067 still in the top statistical group, joined by Compositions 4121 and 4125 (at the 2 lb N/M rate). Compositions 4121 and 3067 filled out the top leaf N statistical group 47 DAT (all at 2 lb N/M rate). Compositions 4121 and 3067 fertilizers are the only 2 lb N rate plots in the top statistical group for NUP levels at 47 DAT. The NUP data from 47 DAT generally correlate poorly with the 54 DAT DGCI values. The sole exception may be the Composition 4121 fertilized plots, which reside in the upper statistical group of both DGCI and NUP, 54 and 47 DAT, respectively. Temperature and soil water conditions were ideal for bentgrass growth.

TABLE 10
Cumulative nitrogen uptake (NUP) measured over the entire experimental
period (derived from clipping yields and leaf N taken 13, 24, 31,
and 47 DAT).

| | Cumulative Nitrogen Uptake |
|---|---|
| Fertilizer Code | (NUP) (lbs fertilizer N/M)* |
| 4121 | 0.422 |
| 4122 | 0.347 |
| 4123 | 0.328 |
| 4124 | 0.439 |
| 4125 | 0.618 |
| 3064 | 0.329 |
| 3066 | 0.490 |
| 3067 | 0.615 |
| Negative control plots | not applicable* |

*Control plots NUP was subtracted from shown values

The performance of the fertilizers certainly varied by date, as is to be expected with varying slow-release chemistries. Sampling error, spatial variability in soil properties, sprinkler head coverage, and other managerial/environmental forces can infuse noise and undermine experimental quality in the field. Sometimes stepping back and looking at the big picture can help one reach conclusions accurately. Table 10 may be a tool to assist one in doing that.

Previously within this Example, NUP has been reported as an index, the product of relative clipping yield (RCY) and leaf N (%) (Table 9 & FIG. 7). This is useful for relative comparisons, but not for measuring absolute fertilizer N recovery. Thus, Table 10 above shows actual fertilizer N recovery over the meaty portion of the study, in terms we can easily understand (lbs N/M). The minuteness of the numbers in Table 10 may be surprising at first glance, but remember not all mowing events were measured, nor were all clipping yields analyzed for N. Likewise, the values in Table 10 report fertilizer N only, as the NUP measured in the control plots have been subtracted off. The control plots NUP value represents N mineralized from soil organic matter over the course of the experiment.

On the basis of total N recovery, the Compositions 4125 and 3067 fertilizers make up the upper tier. The Composition 3066 fertilizer comprises the second tier, and the Compositions 4121 and 4124 fertilizers comprise the third tier. Tabulating experiment-wide averages of DGCI is not quite as fruitful. All DGCI treatment means are virtually equal across the study.

Summary

Considering the observations made and data collected over 12 weeks following the 2 lb N/M applications, the Compositions 3066, 4121, and 4124 fertilizers performed best over this study. The Compositions 4121 and 3066 fertilizers maintained acceptable DGCI values over a majority of the study, the Composition 4125 fertilizer lagged behind somewhat on turf color but did exhibit consistent NUP comparatively.

### Example 20

Burn Potential, Color and Quality of ‘Confederate’ Tall Fescue Grass Grown in North Georgia

This Example sets forth evaluations of several gypsum (calcium sulfate dihydrate) fertilizer formulations, including two NUREA formulations, applied at 3 pounds nitrogen per one thousand square feet (4#N/MSF) rate and how the formulations relate to burn potential, color and quality of ‘Confederate’ tall fescue grass. The objectives were the following:

A) To evaluate the quality, color and burn potential effects of three compositions of the present invention compared to other fertilizers as it relates to initial injury of tall fescue turf, and color and qualtity.

B) To compare the above at 3 pounds nitrogen per one thousand square feet (4#N/MSF) rate.

C) Evaluate two SGN granule sizes of the Nurea+gypsum compositions of the present invention and determine effects on turf burn, color and quality.

The tests were performed on turf lawn located in White, Georgia. Turf test located onto 3A area of irrigated tall fescue turfgrass.

The turf species was ‘Confederate’ Tall Fescue, sown in September, 2002. Test initiation of ‘Confederate’ tall fescue (PCST 0416) was made on Aug. 4, 2004 and was terminated on Sep. 3, 2004 (providing a potential test period of 30 Days After Treatment (DAT)).

Turfgrass burn (injury) ratings were made two days after the initial application and thereafter on a periodic basis. Turf burn is subjectively evaluated on a 0-9 rating system. 0 is regarded no injury and looking very normal. A rating of 1=slight tip injury; 2=moderate tip injury; 5=grass blades/stems are dying; 9=complete kill. Turfgrass color & quality rating (1-9 scale) w/1=yellow turf color & poor quality; 6=consumer acceptable; 9=dark green and very high quality turf.

Three replications were selected with a statistical randomized block design. All data was analyzed via Duncan's Multiple Range Test @ P=0.05. Tables 12, 13 and 14 show test results for burn injury, color and quality, respectively.

The plot size was 3′×3′ w/no unfertilized borders between plots but unfertilized bordering at the top and bottom of each plot. Enough space was given to accommodate 15 treatments and 3 replications.

For application of the test compositions, all fertilizer formulations (see below Table 11) were preweighed and placed into plastic bags just prior to treating. All plots were individually sprayed with water from Solo Backpack Sprayers (TJ8010LP nozzle) until foliage was saturated. Contents were placed into “shaker jars” and placed onto the 3′×3′ plot. Contents were broadcasted evenly 3-5 times across the plots until then entire amount was used. A crisscross pattern was used over each plot. Note: observations made over the past nine seasons have suggested that this method is very accurate. No rainfall or post-irrigation occurred/was supplied for the next 48 hours.

Both turf areas were moderately to light colored green at the initiation date. Turfgrass had been irrigated prior to test initiation. Post treatment irrigation was done on Aug. 7, 2004 (3 DAT) for an accumulation of 0.5″. Irrigation frequency was made on an “as-needed” basis after the initial 72 hour period. Records of irrigation, rainfall and max/min temperatures were kept. One pre & postemergence herbicide application (Barricade 65 WG & Speedzone Broadleaf Weed Control @ RR) was made prior to test initiation.

Mowing was performed on a routine basis (usually weekly) with mowing at a height of 3.5″ on the tall fescue. Insecticide applications were not made to the turfgrasses. Heritage fungicide was applied at the recommended rate for the suppression of brown patch.

TABLE 11
TREATMENTS

| Treatment | Composition | | Tall |
|---|---|---|---|
| Number | Number | Description | Fescue |
| 1 | 4122 | Compd. 40-3-4 SGN 215 | 3.0 |
| 2 | 4123 | Compd. 39-3-4 SGN 165 | 3.0 |
| 3 | 4124 | Compd. Nurea-G 36-3-4 SGN 165 | 3.0 |
| 4 | 4272 | Compd. Nurea-G 33-3-3 SGN 180 | 3.0 |
| 5 | 4125 | Compd. AS-G 14-0-5 SGN 215 | 3.0 |
| 6 | 3064 | Scotts TB 29-3-4 SGN 140 | 3.0 |
| 7 | 3066 | Urea Blend 38-3-4 SGN 215 | 3.0 |
| 15 | NA | Negative Control (no fertilizer) | 0.0 |

The test fertilizer compositions were the following:
Composition No. 4122 (Nurea+NPK)
(96% Urea Melt+1% Corn Starch B810+6.4% Potassium Chloride+6.5% Diammonium Phosphate+5% Perlite) (Dry Basis)
NPK=40:3:4 ratio of nitrogen:phosphorus:potassium

Size=SGN 215 (2.15 mm) particle size (SGN=size guide number. Divide the SGN value by 100 to yield size in millimeters, e.g. SGN 215=2.15 mm particle size)

500 pound Batch

| | | |
|---|---|---|
| 405.5 | pounds | Urea |
| 16.9 | pounds | Water |
| 5 | pounds | Corn Starch B810 |
| 32.2 | pounds | Potassium Chloride |
| 25 | pounds | Perlite 3-S |
| 32.6 | pounds | Diammonium Phosphate |

Weighed 405.5 pounds urea granules
Added 16.9 pounds of water
Heated material until the urea was molten
Added potassium chloride and mixed
Added Corn Starch B810 to the mixture and homogenized
Added steamed perlite to the melt and stirred
Added diammonium phosphate and stirred
Added the mixture to a drum and granulated
Composition No. 4123 (Nurea+NPK)
(96% Urea Melt+1% Corn Starch B810+6.4% Potassium Chloride+6.5% Diammonium Phosphate+5% Perlite) (Dry Basis)
NPK=39:3:4 ratio of nitrogen:phosphorus:potassium

Size=SGN 165 particle size (SGN=size guide number. Divide the SGN value by 100 to yield size in millimeters, e.g. SGN 165=1.65 mm particle size)

500 pound Batch

| | |
|---|---|
| 405.3 pounds | Urea |
| 16.9 pounds | Water |
| 5 pounds | Corn Starch B810 |
| 32.2 pounds | Potassium Chloride |
| 25 pounds | Perlite 3-S |
| 32.6 pounds | Diammonium Phosphate |

Weighed 405.3 pounds urea granules
Added 16.9 pounds of water
Heated material until the urea was molten
Added potassium chloride and mixed
Added Corn Starch B810 to the mixture and homogenized
Added steamed perlite to the melt and stirred
Added diammonium phosphate and stirred
Added the mixture to a drum and granulated
Composition No. 4124 (Present Invention Composition)
Nurea+NPK+Gypsum
(98% Urea Melt+1% Corn Starch B810+6.4% Potassium Chloride+6.5% Diammonium Phosphate+5% Perlite+8% Gypsum (calcium sulfate dihydrate)) (Dry Basis)
NPK=35.8:3:4 ratio of nitrogen:phosphorus:potassium

Size=SGN 165 (1.65 mm) particle size (SGN=size guide number. Divide the SGN value by 100 to yield size in millimeters, e.g. SGN 165=1.65 mm particle size)

500 pound Batch

| | |
|---|---|
| 365.3 pounds | Urea |
| 7.45 pounds | Water |
| 5 pounds | Corn Starch B810 |
| 32.2 pounds | Potassium Chloride |
| 25 pounds | Perlite 3-S |
| 32.6 pounds | Diammonium Phosphate |
| 40 pounds | Gypsum (calcium sulfate dihydrate) |

Weighed 365.3 pounds urea granules
Added 7.45 pounds of water
Heated material until the urea was molten
Added potassium chloride while homogenizing
Added Gypsum (calcium sulfate dihydrate) to the mixture while homogenizing
Added Corn Starch B810 to the mixture while homogenizing
Added steamed perlite to the melt and stirred
Added diammonium phosphate and stirred
Added the mixture to a drum and granulated
Composition No. 4125 (Present Invention Composition)
(70% Ammonium Sulfate Solution+1% Corn Starch B810+11.5% Potassium Sulfate+20% Gypsum (calcium sulfate dihydrate)
NPK=14:0:5

Size=SGN 215 (2.15 mm)

500 gram batch

| | |
|---|---|
| 333 grams | Ammonium Sulfate crystals |
| 143.2 grams | Water |
| 57.7 grams | Potassium Sulfate |
| 5 grams | Corn Starch B810 |
| 104 grams | Gypsum (calcium sulfate dihydrate) |

Added water and ammonium sulfate crystals together and heated the mixture to 200° F.
Added corn starch B810 and homogenized
Added potassium sulfate to the mixture and homogenized
Added Gypsum to the mixture and stirred
Added the materials to a pan granulator while applying heat to the granulator shell
Granulated the materials and screened to product size
   Composition No. 4272 (Present Invention Composition)
   (98% Urea Melt+1% Corn Starch B810+6.4% Potassium Chloride+6.5% Diammonium Phosphate+5% Perlite+20% Gypsum (calcium sulfate dihydrate)) (Dry Basis)
   NPK=33:3:3

Size=SGN 180 (1.80 mm)

500 pound Batch

| | |
|---|---|
| 305.3 pounds | Urea |
| 6.23 pounds | Water |
| 5 pounds | Corn Starch B810 |
| 32.2 pounds | Potassium Chloride |
| 25 pounds | Perlite 3-S |
| 32.6 pounds | Diammonium Phosphate |
| 100 pounds | Gypsum (calcium sulfate dihydrate) |

Weighed 305.3 pounds urea granules
Added 6.23 pounds of water
Heated material until the urea was molten
Added potassium chloride and mixed
Added Corn Starch B810 to the mixture and homogenized
Added steamed perlite to the melt and stirred
Added diammonium phosphate and stirred
Added Gypsum (calcium sulfate dihydrate) to the mixture and stirred
Added the mixture to a drum and granulated

Composition No. 3064 (Scott's Turfbuilder® Lawn Fertilizer)

Scott's Turfbuilder ® Lawn Fertilizer

NPK: 29-3-4
Total Nitrogen (N) 29%
5.3% Ammoniacal Nitrogen 13.0% Urea Nitrogen
9.8% Other Water Soluble Nitrogen* 0.9% Water Insoluble
Nitrogen
Available Phosphate (P₂0₅) 3%
Soluble Potash (K₂0) 4%
Sulfur (S) 6%
6.0% Combined Sulfur (S)
Iron (Fe) 1%
Manganese (MN Total) 0.5%
0.33% Water Soluble Manganese (MN)

Derived From: urea, methyleneurea, sulfate of potash, monoammonium phoshate, ferrous sulfate, manganese oxide, manganese sulfate, ammonium sulfate.
Contains 7.0% slowly available methylenediurea and dimethylenetriurea nitrogen.
Composition No. 3066 (Urea Composition)
(Blend of 80.1% Urea+6.5% Diammonium Phosphate+6.4% Potassium Chloride+7.0% Limestone)
NPK=38:3:4

Size=215 (2.15 mm)

500 pound Batch

| | |
|---|---|
| 400.3 pounds | Urea |
| 32.6 pounds | Diammonium Phosphate |
| 32.2 pounds | Potassium Chloride |
| 35 pounds | Limestone |

Added the granular urea, granular diammonium Phosphate, granular potassium chloride, and granular limestone to a mixer and blended the four components together to produce a blended product
Negative Control Treatment: No Fertilizer
Results
Burn (Injury) Test

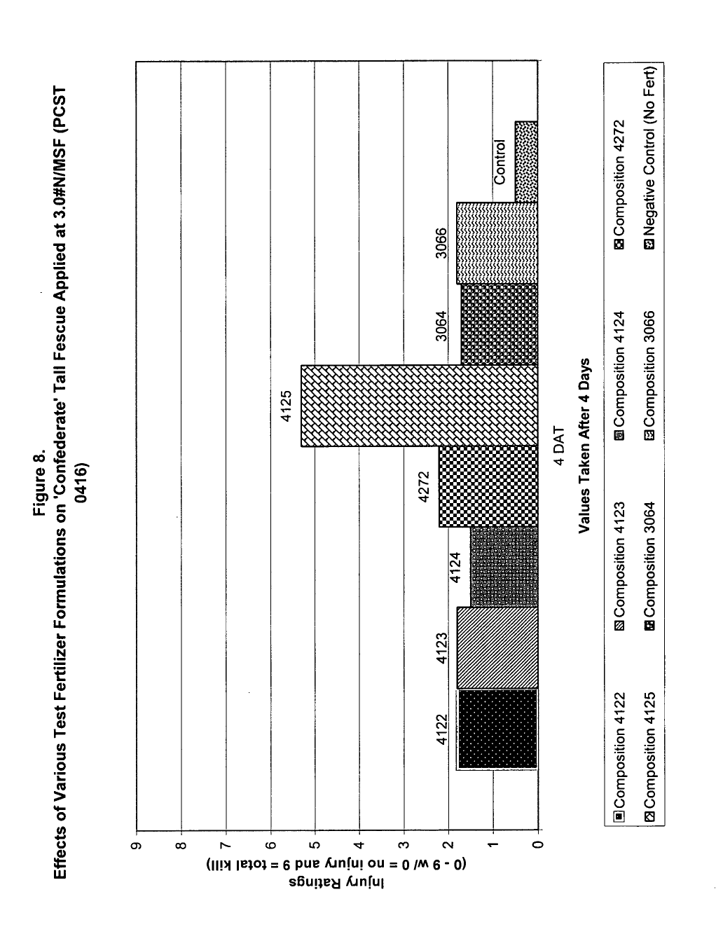

Within 2 DAT there was significant amount of injury detected when the 3#N rate of Composition 4125 (Compd AS-G, SGN 215) was applied on tall fescue (Table 12). This stem/blade dieback of the tissue was detectable for 13 DAT but fully recovered within 23 DAT. Within 4 DAT slight tipburn was noticed from all fertilizer treatments @ this rate but none were significantly different than the others (FIG. 8). After this date the remaining Nurea, Urea and Scotts compositions looked very good and comparable to the untreated control.

Color Test

The data can be found in Table 13. Turfgrass color appeared inhibited due to the injury by the fertilizers especially. By 9 DAT, the grass began to recover. By the 23^{rd} day each fertilized plot was very dark green.

Each of the Nurea formulations (except Composition 4125) displayed good color after the new growth masked the initial burn.

Quality Test

The quality ratings of Nurea Compounds, Urea Blends and Scotts Turf Builder can be seen in Table 14. The turf injury had an impact on the overall quality performance of the AND 4125 fertilizer treatment on ‘Confederate’ tall fescue. This was very obvious from 4-13 DAT and happened with both rates of N.

Conclusions

Significant turf injury was detected when Composition 4125 14-0-5 (Compd AS-G, SGN 215) was applied @ 3.0#N/MSF. Complete recovery occurred within 23 DAT.

Slight/moderate tip burn of tall fescue was detected with all remaining fertilizer treatments when applied at 3.0#N/MSF. Recovery was within 9 DAT.

The Nurea formulations (excluding Composition 4125, 14-0-5) showed equal burn potential to that of the standard Urea Blend (Composition 3066).

The color and quality of tall fescue treated at 3#N/MSF was impacted by the injury for the first 4 days. After recovery all turf plots were excellent.

TABLE 12
RESULTS OF INJURY TESTS

| | | | | | | | | 17-Aug | 17-Aug |
|---|---|---|---|---|---|---|---|---|---|
| | | | | 6-Aug | 8-Aug | 11-Aug | 13-Aug | 13 DAT | 13 DAT |
| | | | | 2 DAT | 4 DAT | 7 DAT | 9 DAT | Before | After |
| Trt | Comp. | Description | Rates #/MSF | Injury | Injury | Injury | Injury | Mowing | Mowing |
| 1 | 4122 | Compd. 40-3-4 SGN 215 | 3.0 | 1.9ef | 1.8d | 1.7ef | 1.0e | 0.5ef | 0.5d |
| 2 | 4123 | Compd. 39-3-4 SGN 165 | 3.0 | 1.8ef | 1.8d | 1.7ef | 1.3e | 0.3f | 0.5d |
| 3 | 4124 | Compd. Nurea-G 36-3-4 SGN 165 | 3.0 | 2.0ef | 1.5d | 1.5ef | 0.8e | 0.8ef | 0.5d |
| 4 | 4272 | Compd. Nurea-G 33-3-3 SGN 180 | 3.0 | 2.5de | 2.2d | 1.0f | 0.8e | 0.3f | 0.8d |
| 5 | 4125 | Compd. AS-G 14-0-5 SGN 215 | 3.0 | 5.0b | 5.3bc | 4.8d | 3.7d | 1.8de | 2.7c |
| 6 | 3064 | Scotts TB 29-3-4 SGN 140 | 3.0 | 2.0ef | 1.7d | 1.3f | 1.3e | 0.5ef | 0.7d |
| 7 | 3066 | Urea Blend 38-3-4 SGN 215 | 3.0 | 1.5ef | 1.8d | 3.0e | 1.5e | 0.7ef | 0.8d |
| 15 | | Negative Control (No Fert) | 0.0 | 1.0f | 0.5e | 0.7f | 0.3e | 0.5ef | 1.0d |

Injury Rating (0-9 scale) w/0 = no injury; 1 = slight tip injury; 2 = moderate tip injury; 5 = grass blades/stems dying; 9 = complete kill.
Note:
Mean seperation within a column followed by the same letter or letters are not significantly different using the Duncan's Multiple Range Test @ P = 0.05.
NS = not significant.
Aug. 4, 2004 - Test initiated.
Soil temperatures @ 1-2″ was 78° F. & 2-3″ was 80° F.
The air temperature was 82° F.

TABLE 13
RESULTS OF COLOR TESTS

| | | | | 6-Aug | 8-Aug | 13-Aug | 17-Aug | 27-Aug | 3-Sep |
|---|---|---|---|---|---|---|---|---|---|
| | | | | 2 DAT | 4 DAT | 9 DAT | 13 DAT | 23 DAT | 30 DAT |
| Trt | Comp. | Description | Rates #/MSF | Color | Color | Color | Color | Color | Color |
| 1 | 4122 | Compd. 40-3-4 SGN 215 | 3.0 | 4.2ab | 5.5ab | 7.7a | 8.7ab | 8.7ab | 8.0a |
| 2 | 4123 | Compd. 39-3-4 SGN 165 | 3.0 | 4.2ab | 5.8ab | 7.8a | 9.0a | 8.8ab | 8.0a |
| 3 | 4124 | Compd. Nurea-G 36-3-4 SGN 165 | 3.0 | 3.8bc | 5.7ab | 7.8a | 8.7ab | 8.7ab | 8.0a |
| 4 | 4272 | Compd. Nurea-G 33-3-3 SGN 180 | 3.0 | 4.0abc | 5.2ab | 7.8a | 9.0a | 8.8ab | 8.0a |
| 5 | 4125 | Compd. AS-G 14-0-5 SGN 215 | 3.0 | 2.7c | 3.2def | 4.7bc | 8.3abc | 8.5b | 8.0a |
| 6 | 3064 | Scotts TB 29-3-4 SGN 140 | 3.0 | 4.0abc | 4.8bc | 7.7a | 8.8ab | 8.8ab | 8.0a |
| 7 | 3066 | Urea Blend 38-3-4 SGN 215 | 3.0 | 4.2ab | 5.3ab | 7.8a | 8.8ab | 8.7ab | 8.0a |
| 15 | | Negative Control (No Fert) | 0.0 | 5.0a | 6.0a | 5.8b | 5.3ef | 5.2c | 5.3b |

Color Rating (1-9 scale) w/1 = yellow; 6 = consumer acceptable; 9 = dark green.
Note:
Mean seperation within a column followed by the same letter or letters are not significantly different using the Duncan's Multiple Range Test @ P = 0.05.
NS = not significant.
Aug. 4, 2004 - Test initiated.
Soil temperatures @ 1-2″ was 78° F. & 2-3″ was 80° F.
The air temperature was 82° F.

TABLE 14
RESULTS OF QUALITY TESTS

| | | | | 8-Aug | 13-Aug | 17-Aug | 27-Aug | 3-Sep |
|---|---|---|---|---|---|---|---|---|
| | | | | 4 DAT | 9 DAT | 13 DAT | 23 DAT | 30 DAT |
| Trt. | Comp | Description | Rates #/MSF | Quality | Quality | Quality | Quality | Quality |
| 1 | 4122 | Compd. 40-3-4 SGN 215 | 3.0 | 5.5ab | 6.7ab | 7.8abc | 9.0a | 8.2a |
| 2 | 4123 | Compd. 39-3-4 SGN 165 | 3.0 | 6.0ab | 7.0ab | 8.5a | 9.0a | 8.0a |
| 3 | 4124 | Compd. Nurea-G 36-3-4 SGN 165 | 3.0 | 5.5ab | 7.0ab | 8.2ab | 9.0a | 7.7a |
| 4 | 4272 | Compd. Nurea-G 33-3-3 SGN 180 | 3.0 | 5.5ab | 7.3a | 8.5a | 9.0a | 7.7a |
| 5 | 4125 | Compd. AS-G 14-0-5 SGN 215 | 3.0 | 3.2c | 4.7c | 7.3bcd | 9.0a | 7.7a |
| 6 | 3064 | Scotts TB 29-3-4 SGN 140 | 3.0 | 5.7ab | 7.0ab | 8.3ab | 9.0a | 7.3a |
| 7 | 3066 | Urea Blend 38-3-4 SGN 215 | 3.0 | 4.8b | 6.7ab | 8.3ab | 9.0a | 7.7a |
| 15 | | Negative Control (No Fert) | 0.0 | 6.3a | 5.8b | 5.7fg | 5.0b | 5.3c |

Quality Rating (1-9 scale) w/1 = poor quality; 6 = consumer acceptable; 9 = excellent quality turf.
Note:
Mean seperation within a column followed by the same letter or letters are not significantly different using the Duncan's Multiple Range Test @ P = 0.05.
NS = not significant.
Aug. 4, 2004 - Test initiated.
Soil temperatures @ 1-2″ was 78° F. & 2-3″ was 80° F.
The air temperature was 82° F.

### Example 21

Quality, Color, Density and Yield of “Floratam” St. Augustinegrass Grown in South Florida

(A) Application of Fertilizer Compositions to Dry Turf

The tests presented in this example define and quantify the agronomic performance benefits on St. Augustinegrass, conferred by the extended release fertilizer compositions of the present invention, and are compared to urea fertilzer and selected commercial standard fertilizers. Performance criteria to include initial greening response, longevity of greening, and characterization of growth responses. The tests were performed by application to dry plots of “Floratam” St. Augustinegrass turf in Fort Lauderdale, Fla. Tests are described further in this example wherein fertilizer compositions were applied to wet plots of the grass turf.

Materials and Methods

Fertilizer treatments of the test compositions were applied to 4 replications of ‘Floratam’ St. Augustinegrass on May 19, 2004. Plot size was 3 ft×6 ft and set up as a randomized complete block. Test area was mowed at 3 inches (typical St. Augustinegrass mowing height) prior to fertilizer compositions applications and all treatments were applied to dry turf. No irrigation was applied for a period of 72 hours following application. Irrigation (0.25 inches) was applied generally 3 times a week unless a rain event voided irrigation. Summer re-application of compositions 4123, 3064, and 3066 (see below Table 15 for test treatment compositions) was made on Jul. 14, 2004. Turfgrass quality/color (scale of 1-10 with 10=dark green turf, 1=dead/brown turf, and 6=minimally acceptable turf), and density (scale of 1-10, with 10=most dense and 1=least dense) ratings were taken for the duration of the experiment. Chlorophyll meter readings (a measure, for example, of color) were taken throughout the study period to compare/enhance visual ratings. Turfgrass clippings (a measure, for example of yield) were taken for dry tissue weights approximately every 7-14 days. All data was subject to statistical analysis and significant means were identified.

TABLE 15
Test Treatments: Dry Turf

| Trt & | | lbs. N/1000 ft² |
|---|---|---|
| Composition No. | Description | Spring |
| 1. 4121 | Blend 38-3-4 SGN215 | 2.0 |
| 2. 4122 | Compd 40-3-4 Nurea SGN215 | 2.0 |
| 3. 4123 | Compd. 39-3-4 Nurea SGN165 | 2.0 |
| 4. 4124 | Compd. 35.8-3-4 Nurea-G SGN165 | 2.0 |
| 5. 4125 | Compd. AS-G 14-0-5 SGN215 | 2.0 |
| 6. 3064 | Scotts TB 29-3-4 SGN140 | 2.0 |
| 7. 3066 | Urea 38-3-4 SGN220 | 2.0 |
| 8. 3067 | Am. sulfate 21-0-0 SGN220 | 2.0 |
| 12. Control | untreated (no fertilizer applied) | |

The test fertilizer compositions were the following:

Composition No. 4121 (Nurea)
(96% Urea Melt+1% Corn Starch B810+4.5% Perlite) (Dry Basis)
NPK=44:0:0 ratio of nitrogen:phosphorus:potassium

Size=SGN 215 (2.15 mm) particle size (SGN=size guide number. Divide the SGN value by 100 to yield size in millimeters, e.g. SGN 215=2.15 mm particle size)

500 pound Batch

| | |
|---|---|
| 472.5 pounds | Urea |
| 19.7 pounds | Water |
| 5 pounds | Corn Starch B810 |
| 25 pounds | Perlite 3-S |

Weighed 472.5 pounds urea granules
Added 19.7 pounds of water
Heated material until the urea was molten
Added Corn Starch B810 to the melt and homogenized
Added steamed perlite to the melt and stirred
Added the mixture to a drum and granulated
Once the granular controlled release fertilizer was granulated, it was dry blended with granular diammonium phosphate and granular potassium chloride to produce an NPK=38:3:4 ratio of nitrogen:phosphorus:potassium
(Granular controlled release fertilizer+Diammonium Phosphate+Potassium Chloride)

500 pound Batch

| | |
|---|---|
| 435.2 pounds | Granular controlled release fertilizer (44:0:0) |
| 32.6 pounds | Diammonium Phosphate |
| 32.2 pounds | Potassium Chloride |

Added the granular controlled release fertilizer, granular diammonium phosphate, granular potassium chloride to a mixer and blended the three components together to produce a blended product
Composition No. 4122 (Nurea+NPK)
(96% Urea Melt+1% Corn Starch B810+6.4% Potassium Chloride+6.5% Diammonium Phosphate+5% Perlite) (Dry Basis)
NPK=40:3:4 ratio of nitrogen:phosphorus:potassium

Size=SGN 215 (2.15 mm) particle size (SGN=size guide number. Divide the SGN value by 100 to yield size in millimeters, e.g. SGN 215=2.15 mm particle size)

500 pound Batch

| | |
|---|---|
| 405.5 pounds | Urea |
| 16.9 pounds | Water |
| 5 pounds | Corn Starch B810 |
| 32.2 pounds | Potassium Chloride |
| 25 pounds | Perlite 3-S |
| 32.6 pounds | Diammonium Phosphate |

Weighed 405.5 pounds urea granules
Added 16.9 pounds of water
Heated material until the urea was molten
Added potassium chloride and mixed
Added Corn Starch B810 to the mixture and homogenized
Added steamed perlite to the melt and stirred
Added diammonium phosphate and stirred
Added the mixture to a drum and granulated
Composition No. 4123 (Nurea+NPK)
(96% Urea Melt+1% Corn Starch B810+6.4% Potassium Chloride+6.5% Diammonium Phosphate+5% Perlite) (Dry Basis)
NPK=39:3:4 ratio of nitrogen:phosphorus:potassium

Size=SGN 165 particle size (SGN=size guide number. Divide the SGN value by 100 to yield size in millimeters, e.g. SGN 165=1.65 mm particle size)

500 pound Batch

| | |
|---|---|
| 405.3 pounds | Urea |
| 16.9 pounds | Water |
| 5 pounds | Corn Starch B810 |
| 32.2 pounds | Potassium Chloride |
| 25 pounds | Perlite 3-S |
| 32.6 pounds | Diammonium Phosphate |

Weighed 405.3 pounds urea granules
Added 16.9 pounds of water
Heated material until the urea was molten
Added potassium chloride and mixed
Added Corn Starch B810 to the mixture and homogenized
Added steamed perlite to the melt and stirred
Added diammonium phosphate and stirred
Added the mixture to a drum and granulated
Composition No. 4124 (Present Invention Composition)
Nurea+NPK+Gypsum
(98% Urea Melt+1% Corn Starch B810+6.4% Potassium Chloride+6.5% Diammonium Phosphate+5% Perlite+8% Gypsum (calcium sulfate dihydrate)) (Dry Basis)
NPK=35.8:3:4 ratio of nitrogen:phosphorus:potassium

Size=SGN 165 (1.65 mm) particle size (SGN=size guide number. Divide the SGN value by 100 to yield size in millimeters, e.g. SGN 165=1.65 mm particle size)

500 pound Batch

| | |
|---|---|
| 365.3 pounds | Urea |
| 7.45 pounds | Water |
| 5 pounds | Corn Starch B810 |
| 32.2 pounds | Potassium Chloride |
| 25 pounds | Perlite 3-S |
| 32.6 pounds | Diammonium Phosphate |
| 40 pounds | Gypsum (calcium sulfate dihydrate) |

Weighed 365.3 pounds urea granules
Added 7.45 pounds of water
Heated material until the urea was molten
Added potassium chloride while homogenizing
Added Gypsum (calcium sulfate dihydrate) to the mixture while homogenizing
Added Corn Starch B810 to the mixture while homogenizing
Added steamed perlite to the melt and stirred
Added diammonium phosphate and stirred
Added the mixture to a drum and granulated
Composition No. 4125 (Present Invention Composition)
(70% Ammonium Sulfate Solution+1% Corn Starch B810+11.5% Potassium Sulfate+20% Gypsum (calcium sulfate dihydrate)
NPK=14:0:5

Size=SGN 215 (2.15 mm)

500 gram batch

| | |
|---|---|
| 333 grams | Ammonium Sulfate crystals |
| 143.2 grams | Water |
| 57.7 grams | Potassium Sulfate |
| 5 grams | Corn Starch B810 |
| 104 grams | Gypsum (calcium sulfate dihydrate) |

Added water and ammonium sulfate crystals together and heated the mixture to 200° F.
Added corn starch B810 and homogenized
Added potassium sulfate to the mixture and homogenized
Added Gypsum to the mixture and stirred
Added the materials to a pan granulator while applying heat to the granulator shell
Granulated the materials and screened to product size

Composition No. 3064 (Scott's Turfbuilder® Lawn Fertilizer)

Scott's Turfbuilder ® Lawn Fertilizer

NPK: 29-3-4
Total Nitrogen (N) 29%
5.3% Ammoniacal Nitrogen 13.0% Urea Nitrogen
9.8% Other Water Soluble Nitrogen* 0.9% Water Insoluble
Nitrogen
Available Phosphate (P₂0₅) 3%
Soluble Potash (K₂0) 4%
Sulfur (S) 6%
6.0% Combined Sulfur (S)
Iron (Fe) 1%
Manganese (MN Total) 0.5%
0.33% Water Soluble Manganese (MN)

Derived From: urea, methyleneurea, sulfate of potash, monoammonium phoshate, ferrous sulfate, manganese oxide, manganese sulfate, ammonium sulfate.
Contains 7.0% slowly available methylenediurea and dimethylenetriurea nitrogen.
Composition No. 3066 (Urea Composition)
(Blend of 80.1% Urea+6.5% Diammonium Phosphate+6.4% Potassium Chloride+7.0% Limestone)
NPK=38:3:4

Size=215 (2.15 mm)

500 pound Batch

| | |
|---|---|
| 400.3 pounds | Urea |
| 32.6 pounds | Diammonium Phosphate |
| 32.2 pounds | Potassium Chloride |
| 35 pounds | Limestone |

Added the granular urea, granular diammonium Phosphate, granular potassium chloride, and granular limestone to a mixer and blended the four components together to produce a blended product
Composition No. 3067 (Ammonium Sulfate)
Product Name: SULF-N 45 Ammonium Sulfate
Generic Names: Ammonium sulfate; Diammonium sulfate
Produced by Honeywell, Morristown, New Jersey
Colorless to dark brown granules
NPK=21:0:0:24 ratio of nitrogen:phosphorus:potassium:sulfur
Size=SGN 240 (2.40 mm) particle size (SGN=size guide number. Divide the SGN value by 100 to yield size in millimeters, e.g. SGN 240=2.40 mm particle size)
Negative Control Treatment: No Fertilizer
Results and Discussion:

After an initial delay for up to two weeks, there were significant treatment differences observed throughout the study period for all the parameters on most dates (see below Tables 16-19).

Turfgrass quality was improved compared to untreated controls (Table 16a-16b). From these results, Compositions 4124 and 3067 were best regarding turfgrass quality ratings over the experimental period (Tables 16a-16b).

Turf density was generally greater in fertilized treatments (Table 17). The application of Composition 4122 had the greatest density (Table 17).

Chlorophyll meter readings mimicked visual ratings showing no treatment effects for the first two rating dates following application of compositions (Table 18a).

Differences in dry clipping yields were observed for all sampling dates after treatment application (Tables 19a-19b). Most applications outperformed the untreated control through at least mid-summer and some provided more growth until near the end of the experimental period (Tables 19a-19b).

There are a number of fertilizer treatment compositions that can provide acceptable turfgrass quality in south Florida during intensive summer weather conditions.

TABLE 16a
Turfgrass quality/color ratings: May 18, 2004-Jun. 22, 2004

| Composition | 5/18 | 5/21 | 5/24 | 5/28 | 6/1 | 6/7 | 6/14 | 6/22 |
|---|---|---|---|---|---|---|---|---|
| 4121 | 7.4 | 7.3 | 7.9abc | 8.4ab | 7.8c | 7.9ab | 7.6a | 7.5ab |
| 4122 | 7.3 | 7.6 | 8.1ab | 8.6ab | 7.8c | 8.0a | 8.1a | 7.8ab |
| 4123 | 7.1 | 7.5 | 7.9abc | 8.3abc | 7.9bc | 7.9ab | 7.9a | 8.0ab |
| 4124 | 7.3 | 7.6 | 8.1ab | 8.5ab | 8.1abc | 8.3a | 8.1a | 8.3a |
| 4125 | 7.3 | 7.4 | 7.9abc | 8.1bc | 8.3ab | 7.8abc | 7.6a | 7.8ab |
| 3064 | 7.0 | 7.4 | 7.9abc | 8.5ab | 8.1abc | 8.0a | 7.8a | 8.0ab |
| 3066 | 7.3 | 7.5 | 8.1ab | 8.6ab | 7.9bc | 7.8abc | 7.8a | 8.0ab |
| 3067 | 7.5 | 7.8 | 8.4a | 8.9a | 8.4a | 7.9ab | 7.9a | 8.1ab |
| Control | 7.3 | 7.0 | 6.3d | 7.0d | 6.4e | 5.8d | 6.4b | 6.4c |
| Significance | ns | ns | ** | ** | ** | ** | ** | ** |

ns and ** = P > 0.10 and P < 0.01
Turfgrass quality/color ratings based on a 1-10 scale with 10 = dark green turf, 1 = dead/brown turf and 6 = minimally acceptable turf.
Means with the same letter within a column are not significantly different according to Duncan's Multiple Range Test.

TABLE 16b
Turfgrass quality/color ratings: Jul. 2, 2004-Sep. 7, 2004

| Compo- | | | | | | | | |
|---|---|---|---|---|---|---|---|---|
| sition | 7/2 | 7/14 | 7/21 | 7/26 | 8/9 | 8/17 | 8/23 | 9/7 |
| 4121 | 7.0bc | 7.1bc | 7.8bc | 7.6b | 7.3bc | 7.1bc | 7.1cd | 7.0cd |
| 4122 | 7.3abc | 7.4b | 7.5c | 7.4b | 7.3bc | 7.4bc | 7.4cd | 7.0cd |
| 4123 | 7.3abc | 7.4b | 7.6bc | 7.4b | 7.0bc | 7.3bc | 7.1cd | 6.9d |
| 4124 | 7.6a | 7.4b | 7.9bc | 7.5b | 7.5b | 7.5b | 7.3cd | 7.1bcd |
| 4125 | 7.4ab | 7.4b | 7.8bc | 7.3b | 7.3bc | 7.3bc | 7.3cd | 6.9d |
| 3064 | 7.3abc | 7.5ab | 7.9bc | 7.5b | 7.3bc | 7.5b | 7.5bcd | 7.0cd |
| 3066 | 7.3abc | 7.1bc | 7.9bc | 7.3b | 7.4bc | 7.5b | 7.1cd | 7.0cd |
| 3067 | 7.5a | 7.9a | 8.3ab | 7.6b | 7.3bc | 7.5b | 7.4cd | 7.1bcd |
| Control | 6.1d | 5.5e | 6.6d | 6.6c | 6.9c | 6.8c | 7.0d | 7.0cd |
| Signifi- | ** | ** | ** | ** | ** | ** | ** | ** |
| cance | | | | | | | | |

** = P < 0.01
Turfgrass quality ratings based on a 1-10 scale with 10 = dark green turf, 1 = dead/brown turf and 6 = minimally acceptable turf.
Means with the same letter within a column are not significantly different according to Duncan's Multiple Range Test.

TABLE 17
Turfgrass density ratings: May 21, 2004-Sep. 7, 2004

| Composition | 5/21 | 6/14 | 8/9 | 9/7 |
|---|---|---|---|---|
| 4121 | 6.6 | 7.3ab | 6.9c | 6.8ab |
| 4122 | 7.3 | 7.9a | 7.0bc | 6.9ab |
| 4123 | 6.8 | 7.5ab | 6.9c | 6.6b |
| 4124 | 6.9 | 7.8ab | 7.0bc | 6.5b |
| 4125 | 6.8 | 7.1b | 7.0bc | 6.5b |
| 3064 | 6.8 | 7.4ab | 7.0bc | 6.8ab |
| 3066 | 6.9 | 7.5ab | 7.0bc | 6.9ab |
| 3067 | 7.1 | 7.8ab | 7.1bc | 6.8ab |
| Control | 6.5 | 6.1c | 6.8c | 6.5b |
| Significance | ns | ** | ** | + |

ns, **, and + = P > 0.10, P < 0.01, and P < 0.10 respectively.
Turfgrass density ratings based on a 1-10 scale with 10 = most dense, 1 = least dense and 6 = minimally acceptable.
Means with the same letter within a column are not significantly different according to Duncan's Multiple Range Test.

TABLE 18a
Chlorophyll meter readings: May 18, 2004-Jun. 23, 2004

| Compositions | 5/18 | 5/21 | 5/24 | 5/28 | 6/1 | 6/7 | 6/14 | 6/23 |
|---|---|---|---|---|---|---|---|---|
| 4121 | 218 | 191 | 239cd | 358c-f | 401bc | 349bcd | 378a | 245a |
| 4122 | 252 | 214 | 289ab | 436ab | 442ab | 377bc | 370ab | 271a |
| 4123 | 235 | 214 | 268abc | 411b-e | 431ab | 372bc | 381a | 266a |
| 4124 | 256 | 232 | 280ab | 409b-e | 425ab | 387ab | 389a | 274a |
| 4125 | 235 | 214 | 255bcd | 390b-f | 463ab | 375bc | 400a | 263a |
| 3064 | 217 | 205 | 264abc | 429abc | 420ab | 368bc | 385a | 266a |
| 3066 | 253 | 205 | 266abc | 423a-d | 402bc | 375bc | 370ab | 261a |
| 3067 | 257 | 230 | 297a | 484a | 480a | 421a | 411a | 271a |
| Control | 250 | 204 | 226d | 230g | 229e | 241e | 254c | 188b |
| Significance | ns | ns | ** | ** | ** | ** | ** | ** |

ns and ** = P > 0.10 and P < 0.01
Means with the same letter within a column are not significantly different according to Duncan's Multiple Range Test.

TABLE 18b
Chlorophyll meter readings: Jul. 2, 2004-Sep. 7, 2004

| Compositions | 7/2 | 7/14 | 7/21 | 7/26 | 8/9 | 8/17 | 8/23 | 9/7 |
|---|---|---|---|---|---|---|---|---|
| 4121 | 365b | 251bc | 257cd | 245b | 259bc | 263bc | 266bc | 260bc |
| 4122 | 365a | 269ab | 257cd | 255b | 273bc | 278b | 271b | 252c |
| 4123 | 354b | 274ab | 267cd | 252b | 263bc | 283b | 263bc | 255bc |
| 4124 | 360b | 286ab | 261cd | 248b | 277b | 286b | 267bc | 259bc |
| 4125 | 415a | 280ab | 270cd | 246b | 259bc | 267bc | 242c | 243c |
| 3064 | 364b | 302a | 276cd | 256b | 259bc | 273bc | 257bc | 250c |
| 3066 | 357b | 273ab | 252d | 252b | 257bc | 272bc | 264bc | 245c |
| 3067 | 424a | 293ab | 289bc | 269b | 261bc | 276bc | 260bc | 255bc |
| Control | 229d | 206c | 205e | 201c | 232c | 245c | 244bc | 265abc |
| Significance | ** | ** | ** | ** | ** | ** | ** | * |

** and * = P < 0.01 and P < 0.05
Means with the same letter within a column are not significantly different according to Duncan's Multiple Range Test.

TABLE 19a
Dry clipping weights (grams): May 28, 2004-Jul. 22, 2004

| Composition | 5/28 | 6/4 | 6/11 | 6/18 | 6/25 | 7/2 | 7/14 | 7/22 |
|---|---|---|---|---|---|---|---|---|
| 4121 | 14.0abc | 18.9a | 27.0a | 21.3bc | 9.7ab | 21.2bcd | 12.5b | 9.7d |
| 4122 | 19.3ab | 19.3a | 26.2a | 20.9bc | 13.5a | 22.3bc | 12.6b | 10.1cd |
| 4123 | 24.4a | 22.5a | 31.0a | 23.1b | 11.2ab | 23.6b | 13.2b | 13.1bcd |
| 4124 | 21.6ab | 21.6a | 33.1a | 27.6a | 12.3a | 24.1b | 14.3b | 14.3a-d |
| 4125 | 15.6abc | 18.7a | 29.3a | 22.2bc | 10.0ab | 26.4b | 13.4b | 11.8bcd |
| 3064 | 21.9ab | 22.5a | 32.1a | 23.7ab | 11.6ab | 22.4bc | 12.9b | 11.9bcd |
| 3066 | 16.3abc | 18.6a | 28.0a | 20.6bc | 11.8ab | 22.4bc | 11.0bc | 13.3bcd |
| 3067 | 21.3ab | 26.2a | 33.9a | 24.9ab | 13.8a | 35.5a | 20.3a | 16.1ab |
| Control | 8.7c | 2.4c | 5.7c | 6.0e | 2.6c | 5.8f | 3.9e | 3.2e |
| Significance | * | ** | ** | ** | ** | ** | ** | ** |

* and ** = P < 0.05 and P < 0.01
Means with the same letter within a column are not significantly different according to Duncan's Multiple Range Test.

TABLE 19b
Dry clipping weights (grams): Jul. 26, 2004-Sep. 7, 2004

| Compositions | 7/26 | 8/2 | 8/18 | 8/23 | 9/7 |
|---|---|---|---|---|---|
| 4121 | 5.8cd | 9.8bc | 6.7bc | 24.4c | 8.6cde |
| 4122 | 4.8cd | 11bc | 28.2a | 34.8bc | 8.2cde |
| 4123 | 5.9cd | 11.1bc | 8.4abc | 32.7bc | 7.8cde |
| 4124 | 6.2cd | 9.4bc | 10.9abc | 33.0bc | 10.7bc |
| 4125 | 7.2cd | 23.2ab | 10abc | 26.8c | 7.7cde |
| 3064 | 4.6cd | 10bc | 9.7abc | 34.4bc | 8.6cde |
| 3066 | 6.9cd | 11.5bc | 9.2abc | 36.8abc | 6.6de |
| 3067 | 9.6c | 16.2abc | 10.4abc | 50.6ab | 9.3cd |
| Control | 2.5d | 5.4c | 3.5c | 21.3c | 5.5e |
| Significance | ** | * | + | ** | ** |

**, *, and + = P < 0.01, P < 0.05, and P < 0.10 respectively.
Means with the same letter within a column are not significantly different according to Duncan's Multiple Range Test.

(B) Application of Fertilizer Compositions to Wet Turf

The tests presented in this example define and quantify the agronomic performance benefits on St. Augustinegrass, conferred by the extended release fertilizer compositions of the present invention, and are compared to urea fertilzer and selected commercial standard fertilizers. Performance criteria to include initial greening response, longevity of greening, and characterization of growth responses. The tests were performed by application to wet plots of “Floratam” St. Augustinegrass turf in Fort Lauderdale, Fla.

Materials and Methods:

Treatments were applied once in the spring on May 19, 2004, at the below rates (see Table 20) to 3 replications of ‘Floratam’ St. Augustinegrass. Plot size was 1 m² and set up as a randomized complete block. Test area was mowed at 3 inches (typical St. Augustinegrass mowing height) prior to composition fertilizer applications and throughout the study period. All treatments were applied to wet foliage and no irrigation was applied for a period of 48 hours. Irrigation (0.25 inches) was applied generally 3 times a week unless a rain event voided irrigation. Turfgrass quality/color (scale of 1-10 with 10=dark green turf, 1=dead/brown turf, and 6=minimally acceptable turf), and injury (on a percent basis) were taken for the duration of the experiment. All data was subject to statistical analysis and significant means were identified.

TABLE 20
Test Treatments: Wet Turf

| Trt & | | lbs. N/1000 ft² |
|---|---|---|
| Composition No. | Description | Spring |
| 1. 4121 | Blend 38-3-4 SGN215 | 3.0 |
| 2. 4122 | Compd 40-3-4 Nurea SGN215 | 3.0 |
| 3. 4123 | Compd. 39-3-4 Nurea SGN165 | 3.0 |
| 4. 4124 | Compd. 35.8-3-4 Nurea-G SGN165 | 3.0 |
| 5. 4125 | Compd. AS-G 14-0-5 SGN215 | 3.0 |
| 6. 3064 | Scotts TB 29-3-4 SGN140 | 3.0 |
| 7. 3066 | Urea 38-3-4 SGN220 | 3.0 |
| 12. Control | untreated (no fertilizer applied) | |

The test fertilizer compositions were the following:

Composition No. 4121 (Nurea)
(96% Urea Melt+1% Corn Starch B810+4.5% Perlite) (Dry Basis)
NPK=44:0:0 ratio of nitrogen:phosphorus:potassium

Size=SGN 215 (2.15 mm) particle size (SGN=size guide number. Divide the SGN value by 100 to yield size in millimeters, e.g. SGN 215=2.15 mm particle size)

500 pound Batch

| | |
|---|---|
| 472.5 pounds | Urea |
| 19.7 pounds | Water |
| 5 pounds | Corn Starch B810 |
| 25 pounds | Perlite 3-S |

Weighed 472.5 pounds urea granules
Added 19.7 pounds of water
Heated material until the urea was molten
Added Corn Starch B810 to the melt and homogenized
Added steamed perlite to the melt and stirred
Added the mixture to a drum and granulated
Once the granular controlled release fertilizer was granulated, it was dry blended with granular diammonium phosphate and granular potassium chloride to produce an NPK=38:3:4 ratio of nitrogen:phosphorus:potassium
(Granular controlled release fertilizer+Diammonium Phosphate+Potassium Chloride)

500 pound Batch

| | |
|---|---|
| 435.2 pounds | Granular controlled release fertilizer (44:0:0) |
| 32.6 pounds | Diammonium Phosphate |
| 32.2 pounds | Potassium Chloride |

Added the granular controlled release fertilizer, granular diammonium phosphate, granular potassium chloride to a mixer and blended the three components together to produce a blended product
Composition No. 4122 (Nurea+NPK)
(96% Urea Melt+1% Corn Starch B810+6.4% Potassium Chloride+6.5% Diammonium Phosphate+5% Perlite) (Dry Basis)
NPK=40:3:4 ratio of nitrogen:phosphorus:potassium

Size=SGN 215 (2.15 mm) particle size (SGN size guide number. Divide the SGN value by 100 to yield size in millimeters, e.g. SGN 215=2.15 mm particle size)

500 pound Batch

| | | |
|---|---|---|
| 405.5 | pounds | Urea |
| 16.9 | pounds | Water |
| 5 | pounds | Corn Starch B810 |
| 32.2 | pounds | Potassium Chloride |
| 25 | pounds | Perlite 3-S |
| 32.6 | pounds | Diammonium Phosphate |

Weighed 405.5 pounds urea granules
Added 16.9 pounds of water
Heated material until the urea was molten
Added potassium chloride and mixed
Added Corn Starch B810 to the mixture and homogenized
Added steamed perlite to the melt and stirred
Added diammonium phosphate and stirred
Added the mixture to a drum and granulated
Composition No. 4123 (Nurea+NPK)
(96% Urea Melt+1% Corn Starch B810+6.4% Potassium Chloride+6.5% Diammonium Phosphate+5% Perlite) (Dry Basis)
NPK=39:3:4 ratio of nitrogen:phosphorus:potassium

Size=SGN 165 particle size (SGN=size guide number. Divide the SGN value by 100 to yield size in millimeters, e.g. SGN 165=1.65 mm particle size)

500 pound Batch

| | | |
|---|---|---|
| 405.3 | pounds | Urea |
| 16.9 | pounds | Water |
| 5 | pounds | Corn Starch B810 |
| 32.2 | pounds | Potassium Chloride |
| 25 | pounds | Perlite 3-S |
| 32.6 | pounds | Diammonium Phosphate |

Weighed 405.3 pounds urea granules
Added 16.9 pounds of water
Heated material until the urea was molten
Added potassium chloride and mixed
Added Corn Starch B810 to the mixture and homogenized
Added steamed perlite to the melt and stirred
Added diammonium phosphate and stirred
Added the mixture to a drum and granulated
Composition No. 4124 (Present Invention Composition)
Nurea+NPK+Gypsum
(98% Urea Melt+1% Corn Starch B810+6.4% Potassium Chloride+6.5% Diammonium Phosphate+5% Perlite+8% Gypsum (calcium sulfate dihydrate)) (Dry Basis)
NPK=35.8:3:4 ratio of nitrogen:phosphorus:potassium

Size=SGN 165 (1.65 mm) particle size (SGN=size guide number. Divide the SGN value by 100 to yield size in millimeters, e.g. SGN 165=1.65 mm particle size)

500 pound Batch

| | | |
|---|---|---|
| 365.3 | pounds | Urea |
| 7.45 | pounds | Water |
| 5 | pounds | Corn Starch B810 |
| 32.2 | pounds | Potassium Chloride |
| 25 | pounds | Perlite 3-S |
| 32.6 | pounds | Diammonium Phosphate |
| 40 | pounds | Gypsum (calcium sulfate dihydrate) |

Weighed 365.3 pounds urea granules
Added 7.45 pounds of water
Heated material until the urea was molten
Added potassium chloride and mixed while homogenizing
Added Gypsum (calcium sulfate dihydrate) to the mixture while homogenizing
Added Corn Starch B810 to the mixture while homogenizing
Added steamed perlite to the melt and stirred
Added diammonium phosphate and stirred
Added the mixture to a drum and granulated
Composition No. 4125 (Present Invention Composition)
(70% Ammonium Sulfate Solution+1% Corn Starch B810+11.5% Potassium Sulfate+20% Gypsum (calcium sulfate dihydrate)
NPK=14:0:5

Size=SGN 215 (2.15 mm)

500 gram batch

| | | |
|---|---|---|
| 333 | grams | Ammonium Sulfate crystals |
| 143.2 | grams | Water |
| 57.7 | grams | Potassium Sulfate |
| 5 | grams | Corn Starch B810 |
| 104 | grams | Gypsum (calcium sulfate dihydrate) |

Added water and ammonium sulfate crystals together and heated the mixture to 200° F.
Added corn starch B810 and homogenized
Added potassium sulfate to the mixture and homogenized
Added Gypsum to the mixture and stirred
Added the materials to a pan granulator while applying heat to the granulator shell
Granulated the materials and screened to product size

Composition No. 3064 (Scott's Turfbuilder® Lawn Fertilizer)

Scott's Turfbuilder ® Lawn Fertilizer

```
NPK: 29-3-4
Total Nitrogen (N) 29%
  5.3% Ammoniacal Nitrogen 13.0% Urea Nitrogen
  9.8% Other Water Soluble Nitrogen* 0.9% Water Insoluble Nitrogen
Available Phosphate (P₂0₅) 3%
Soluble Potash (K₂0) 4%
Sulfur (S) 6%
  6.0% Combined Sulfur (S)
Iron (Fe) 1%
Manganese (MN Total) 0.5%
0.33% Water Soluble Manganese (MN)
```

Derived From: urea, methyleneurea, sulfate of potash, monoammonium phoshate, ferrous sulfate, manganese oxide, manganese sulfate, ammonium sulfate.
Contains 7.0% slowly available methylenediurea and dimethylenetriurea nitrogen.
Composition No. 3066 (Urea Composition)
(Blend of 80.1% Urea+6.5% Diammonium Phosphate+6.4% Potassium Chloride+7.0% Limestone)
NPK=38:3:4

Size=215 (2.15 mm)

500 pound Batch

| | | |
|---|---|---|
| 400.3 | pounds | Urea |
| 32.6 | pounds | Diammonium Phosphate |
| 32.2 | pounds | Potassium Chloride |
| 35 | pounds | Limestone |

Added the granular urea, granular diammonium Phosphate, granular potassium chloride, and granular limestone to a mixer and blended the four components together to produce a blended product
Negative Control Treatment: No Fertilizer
Results and Discussion:

Spring turf quality ratings were observed on the second rating date after application (Table 21).

Treatment with Composition 3064 had the highest turf quality scores on May 24. Treatment with Composition 4125 was among those with the highest turf quality scores with Composition 3064 not far behind (Table 21). Composition 3066 showed good quality early on but decreased after May 28. Color ratings somewhat paralleled turf quality observations with treatment Composition 4125 have the best average color ratings (Table 22). Composition 3064 showed the generally least injury and after an initial higher injury rating, Composition 4125 showed low injury (Table 3).

TABLE 21
Turfgrass quality ratings.

| Compositions | 05/21 | 05/24 | 05/26 | 05/28 | 06/01 | 06/07 | 06/14 | 06/23 |
|---|---|---|---|---|---|---|---|---|
| 4121 | 7.0 | 6.3a-d | 6.8bcd | 7.3a-d | 7.5bc | 8.7ab | 7.2 | 8.3abc |
| 4122 | 7.0 | 6.5a-d | 7.3ab | 7.5abc | 7.3bcd | 8.0c-e | 7.3 | 7.8c |
| 4123 | 6.8 | 6.0b-e | 6.7bcd | 6.8cde | 7.3bcd | 8.3abc | 7.7 | 8.5abc |
| 4124 | 7.0 | 6.7abc | 7.0a-d | 7.3a-d | 7.7bc | 8.0c-e | 7.5 | 8.7abc |
| 4125 | 7.2 | 7.0ab | 7.8a | 8.2a | 8.0ab | 8.7ab | 7.5 | 9.0ab |
| 3064 | 7.0 | 7.2a | 7.5ab | 8.0ab | 7.8abc | 8.5abc | 7.5 | 8.5abc |
| 3066 | 7.3 | 7.0ab | 7.5ab | 8.0ab | 7.5bc | 7.7cde | 7.3 | 7.7c |
| Control | 6.8 | 5.8c-f | 6.2de | 6.0ef | 6.5e | 6.0f | 7.2 | 7.8c |
| Significance | ns | ** | ** | ** | ** | ** | ns | + |

ns, **, and + = P > 0.10, P < 0.01 and P < 0.10 respectively.
Turfgrass quality ratings based on a 1-10 scale with 10 = dark green turf, 1 = dead/brown turf and 6 = minimally acceptable turf.
Means with the same letter within a column are not significantly different according to Duncan's Multiple Range Test

TABLE 22
Turfgrass color ratings.

| Compo- | 05/ | | | | | | | |
|---|---|---|---|---|---|---|---|---|
| sitions | 21 | 05/24 | 05/26 | 05/28 | 06/01 | 06/07 | 06/14 | 06/23 |
| 4121 | 7.3 | 6.8abc | 7.2a-d | 7.8ab | 8.0b | 8.8ab | 7.8ab | 8.7 |
| 4122 | 7.2 | 7.0ab | 7.5abc | 8.2a | 7.8bc | 8.5abc | 7.5ab | 8.3 |
| 4123 | 7.3 | 6.7a-d | 7.0a-d | 7.0bc | 8.0b | 8.7ab | 7.7ab | 8.8 |
| 4124 | 7.0 | 7.2ab | 7.3a-d | 7.8ab | 8.3ab | 8.5abc | 8.0a | 8.8 |
| 4125 | 7.5 | 7.3ab | 8.0a | 8.7a | 8.5ab | 9.0a | 8.0a | 9.2 |
| 3064 | 7.5 | 7.5a | 7.7ab | 8.2a | 8.5ab | 8.8ab | 7.7ab | 9.0 |
| 3066 | 7.7 | 7.3ab | 7.7ab | 8.3a | 8.0b | 8.2bcd | 7.3b | 8.2 |
| Control | 6.7 | 6.0c-f | 6.3de | 6.2c | 6.7d | 6.5e | 7.3b | 8.3 |
| Signifi- | ns | ** | ** | ** | ** | ** | * | ns |
| cance | | | | | | | | |

ns, **, and * = p > 0.10, P < 0.01, and P < 0.05 respectively.
Turfgrass color ratings based on a 1-10 scale with 10 = dark green turf, 1 = brown turf, and 6 = minimally acceptable.
Means with the same letter within a column are not significantly different according to Duncan's Multiple Range Test.

TABLE 23
Percent injury on turfgrass.

| Compo- | 05/ | | | | | | | |
|---|---|---|---|---|---|---|---|---|
| sitions | 21 | 05/24 | 05/26 | 05/28 | 06/01 | 06/07 | 06/14 | 06/23 |
| 4121 | 13 | 22e | 17def | 18c-g | 7cde | 0c | 0 | 0 |
| 4122 | 20 | 25de | 20c-f | 13d-g | 10b-e | 0c | 0 | 0 |
| 4123 | 27 | 37b-e | 25b-e | 28b-e | 12b-e | 0c | 0 | 0 |
| 4124 | 22 | 28cde | 20c-f | 18c-g | 7cde | 0c | 0 | 0 |
| 4125 | 20 | 10e | 7f | 2g | 3de | 0c | 0 | 0 |
| 3064 | 12 | 10e | 7f | 7efg | 0e | 0c | 0 | 0 |
| 3066 | 10 | 17e | 8ef | 7efg | 5de | 10bc | 0 | 0 |
| Control | 17 | 33b-e | 8ef | 25c-f | 15b-e | 18ab | 0 | 0 |
| Signifi- | ns | ** | ** | ** | ** | ** | ns | ns |
| cance | | | | | | | | |

ns and ** = P > 0.10 and P < 0.01 respectively.
Means with the same letter within a column are not significantly different according to Duncan's Multiple Range Test.

### Example 22

Yield and Burn Potential on ‘Tifway’ Bermudagrass Grown in Central Alabama

This Example sets forth evaluations of the effect of nitrogen plus gypsum fertilizers and nitrogen rate of applications on burn and yield of Tifway bermudagrass managed as a home lawn.

Burn and yield tests were conducted at the Auburn University Turfgrass Research Unit (TGRU), located in Auburn, Alabama. For both experiments the soil type was a Marvyn loamy sand (80% sand). Turfgrass for the experiment was ‘Tifway’ bermudagass maintained as a home lawn, with a 1 inch mowing height. Irrigation was applied to supply 1 inch water per week, if necessary. Pest control (for weeds and insects) was applied as needed and as recommended during the study period. Plots were mowed three times per week (Monday, Wednesday and Friday) using a rotary mower. No additional fertilizer was applied to the plots during the study period.

For these burn tests, N sources were applied to Tifway bermudagrass at rates of 3 lbs N/1,000 ft². Selected sources are listed in Table 8, below. The fertilizer compositions were not watered in for three days after application, and were applied to dry turf. Collected data included relative turf burn (until effects of burn largely disappeared) and presence of any mottling or greenish discoloration. The burn studies were initiated on May 17, 2004 (spring study), Aug. 3, 2004 (summer study), and Sep. 10, 2004 (fall study). Treatments were slightly altered for the Fall study, as outlined in below Table 24.

Collected data included weekly clipping yield. Wet clippings were collected, returned to the laboratory and dried in a forced-air oven for yield determination. Clippings were collected from May 17, 2004 until Jul. 22, 2004, a total of 9 weeks after the first fertilizer application. Clippings were collected after the second fertilizer application from Aug. 11, 2004 until Sep. 20, 2004, a total of 6 weeks. The second period of data collection was shorter because a cold snap lightly frosted the turf, greatly reducing growth.

TABLE 24

Composition No.
Compositions applied to Tifway hybrid bermudagrass at rates of
3 lbs N 1,000 ft⁻² on August 3^{rd} and Sept. 10^{th}, 2004.
3064
3066
4121
4122
4123
4124
4125
Unfertilized control
Altered treatment design for the Fall study. Treatments applied on
Sep. 10, 2004 at rates of 4 lbs N 1,000 ft².
3066
4123
4124
4125
4272
Unfertilized control

The test fertilizer compositions were the following:
Composition No. 4121 (Nurea)
(96% Urea Melt+1% Corn Starch B810+4.5% Perlite) (Dry Basis)
NPK=44:0:0 ratio of nitrogen:phosphorus:potassium

Size=SGN 215 (2.15 mm) particle size (SGN=size guide number. Divide the SGN value by 100 to yield size in millimeters, e.g. SGN 215=2.15 mm particle size)

500 pound Batch

| | | |
|---|---|---|
| 472.5 | pounds | Urea |
| 19.7 | pounds | Water |
| 5 | pounds | Corn Starch B810 |
| 25 | pounds | Perlite 3-S |

Weighed 472.5 pounds urea granules
Added 19.7 pounds of water
Heated material until the urea was molten
Added Corn Starch B810 to the melt and homogenized
Added steamed perlite to the melt
Added the mixture to a drum and granulated
Once the granular controlled release fertilizer was granulated, it was dry blended with granular diammonium phosphate and granular potassium chloride to produce an NPK=38:3:4 ratio of nitrogen:phosphorus:potassium
(Granular controlled release fertilizer+Diammonium Phosphate+Potassium Chloride)

500 pound Batch

| | | |
|---|---|---|
| 435.2 | pounds | Granular controlled release fertilizer (44:0:0) |
| 32.6 | pounds | Diammonium Phosphate |
| 32.2 | pounds | Potassium Chloride |

Added the granular controlled release fertilizer, granular diammonium phosphate, granular potassium chloride to a mixer and blended the three components together to produce a blended product
Composition No. 4122 (Nurea+NPK)
(96% Urea Melt+1% Corn Starch B810+6.4% Potassium Chloride+6.5% Diammonium Phosphate+5% Perlite) (Dry Basis)
NPK=40:3:4 ratio of nitrogen:phosphorus:potassium

Size=SGN 215 (2.15 mm) particle size (SGN=size guide number. Divide the SGN value by 100 to yield size in millimeters, e.g. SGN 215=2.15 mm particle size)

500 pound Batch

| | | |
|---|---|---|
| 405.5 | pounds | Urea |
| 16.9 | pounds | Water |
| 5 | pounds | Corn Starch B810 |
| 32.2 | pounds | Potassium Chloride |
| 25 | pounds | Perlite 3-S |
| 32.6 | pounds | Diammonium Phosphate |

Weighed 405.5 pounds urea granules
Added 16.9 pounds of water
Heated material until the urea was molten
Added potassium chloride and mixed
Added Corn Starch B810 to the mixture and homogenized
Added steamed perlite to the melt and stirred
Added diammonium phosphate and stirred
Added the mixture to a drum and granulated
Composition No. 4123 (Nurea+NPK)
(96% Urea Melt+1% Corn Starch B810+6.4% Potassium Chloride+6.5% Diammonium Phosphate+5% Perlite) (Dry Basis)
NPK=39:3:4 ratio of nitrogen:phosphorus:potassium

Size=SGN 165 particle size (SGN=size guide number. Divide the SGN value by 100 to yield size in millimeters, e.g. SGN 165=1.65 mm particle size)

500 pound Batch

| | | |
|---|---|---|
| 405.3 | pounds | Urea |
| 16.9 | pounds | Water |
| 5 | pounds | Corn Starch B810 |
| 32.2 | pounds | Potassium Chloride |
| 25 | pounds | Perlite 3-S |
| 32.6 | pounds | Diammonium Phosphate |

Weighed 405.3 pounds urea granules
Added 16.9 pounds of water
Heated material until the urea was molten
Added potassium chloride and mixed
Added Corn Starch B810 to the mixture and homogenized
Added steamed perlite to the melt and stirred
Added diammonium phosphate and stirred
Added the mixture to a drum and granulated
Composition No. 4124 (Present Invention Composition)
Nurea+NPK+Gypsum
(98% Urea Melt+1% Corn Starch B810+6.4% Potassium Chloride+6.5% Diammonium Phosphate+5% Perlite+8% Gypsum (calcium sulfate dihydrate)) (Dry Basis)
NPK=35.8:3:4 ratio of nitrogen:phosphorus:potassium

Size=SGN 165 (1.65 mm) particle size (SGN=size guide number. Divide the SGN value by 100 to yield size in millimeters, e.g. SGN 165=1.65 mm particle size)

500 pound Batch

| | | |
|---|---|---|
| 365.3 | pounds | Urea |
| 7.45 | pounds | Water |
| 5 | pounds | Corn Starch B810 |
| 32.2 | pounds | Potassium Chloride |
| 25 | pounds | Perlite 3-S |
| 32.6 | pounds | Diammonium Phosphate |
| 40 | pounds | Gypsum (calcium sulfate dihydrate) |

Weighed 365.3 pounds urea granules
Added 7.45 pounds of water
Heated material until the urea was molten
Added potassium chloride while homogenizing
Added Gypsum (calcium sulfate dihydrate) to the mixture while homogenizing
Added Corn Starch B810 to the mixture while homogenizing
Added steamed perlite to the melt and stirred
Added diammonium phosphate and stirred
Added the mixture to a drum and granulated
Composition No. 4125 (Present Invention Composition)
(70% Ammonium Sulfate Solution+1% Corn Starch B810+11.5% Potassium Sulfate+20% Gypsum (calcium sulfate dihydrate)
NPK=14:0:5

Size=SGN 215 (2.15 mm)

500 gram batch

| | | |
|---|---|---|
| 333 | grams | Ammonium Sulfate crystals |
| 143.2 | grams | Water |
| 57.7 | grams | Potassium Sulfate |
| 5 | grams | Corn Starch B810 |
| 104 | grams | Gypsum (calcium sulfate dihydrate) |

Added water and ammonium sulfate crystals together and heated the mixture to 200° F.
Added corn starch B810 and homogenized
Added potassium sulfate to the mixture and homogenized
Added Gypsum to the mixture and stirred
Added the materials to a pan granulator while applying heat to the granulator shell
Granulated the materials and screened to product size
   Composition No. 4272 (Present Invention Composition)
   (98% Urea Melt+1% Corn Starch B810+6.4% Potassium Chloride+6.5% Diammonium Phosphate+5% Perlite+20% Gypsum (calcium sulfate dihydrate)) (Dry Basis)
   NPK=33:3:3

Size=SGN 180 (1.80 mm)

500 pound Batch

| | | |
|---|---|---|
| 305.3 | pounds | Urea |
| 6.23 | pounds | Water |
| 5 | pounds | Corn Starch B810 |
| 32.2 | pounds | Potassium Chloride |
| 25 | pounds | Perlite 3-S |
| 32.6 | pounds | Diammonium Phosphate |
| 100 | pounds | Gypsum (calcium sulfate dihydrate) |

Weighed 305.3 pounds urea granules
Added 6.23 pounds of water
Heated material until the urea was molten
Added potassium chloride and mixed
Added Corn Starch B810 to the mixture and homogenized
Added steamed perlite to the melt and stirred
Added diammonium phosphate and stirred
Added Gypsum (calcium sulfate dihydrate) to the mixture
Added the mixture to a drum and granulated

Composition No. 3064 (Scott's Turfbuilder® Lawn Fertilizer)

Scott's Turfbuilder ® Lawn Fertilizer

```
NPK: 29-3-4
Total Nitrogen (N 29%
  5.3% Ammoniacal Nitrogen 13.0% Urea Nitrogen
  9.8% Other Water Soluble Nitrogen* 0.9% Water Insoluble Nitrogen
Available Phosphate (P₂0₅) 3%
Soluble Potash (K₂0) 4%
Sulfur (S) 6%
  6.0% Combined Sulfur (S)
Iron (Fe) 1%
Manganese (MN Total) 0.5%
0.33% Water Soluble Manganese (MN)
```

Derived From: urea, methyleneurea, sulfate of potash, monoammonium phoshate, ferrous sulfate, manganese oxide, manganese sulfate, ammonium sulfate.
Contains 7.0% slowly available methylenediurea and dimethylenetriurea nitrogen.
Composition No. 3066 (Urea Composition)
(Blend of 80.1% Urea+6.5% Diammonium Phosphate+6.4% Potassium Chloride+7.0% Limestone)
NPK=38:3:4

Size=215 (2.15 mm)

500 pound Batch

| | | |
|---|---|---|
| 400.3 | pounds | Urea |
| 32.6 | pounds | Diammonium Phosphate |
| 32.2 | pounds | Potassium Chloride |
| 35 | pounds | Limestone |

Added the granular urea, granular diammonium Phosphate, granular potassium chloride, and granular limestone to a mixer and blended the four components together to produce a blended product
Composition No. 3067 (Ammonium Sulfate)
Product Name: SULF-N 45 Ammonium Sulfate
Generic Names: Ammonium sulfate; Diammonium sulfate
Produced by Honeywell, Morristown, New Jersey
Colorless to dark brown granules
NPK=21:0:0:24 ratio of nitrogen:phosphorus:potassium:sulfur
Size=SGN 240 (2.40 mm) particle size (SGN=size guide number. Divide the SGN value by 100 to yield size in millimeters, e.g. SGN 240=2.40 mm particle size)
Negative Control Treatment: No Fertilizer

The above compositions were made by the following process:

The slow release, granular fertilizer compositions were made in a one ton/hr pilot plant. Urea melt at 98% strength and containing approximately 0.40% urea formaldehyde was homogenized with cornstarch at 1%, KCl at 6.7%, and gypsum at 8%. The slurry was continuously pumped under metering conditions to a pugmill where exfoliated perlite at 4% was introduced to absorb much of the solution phase, followed by introduction of diammonium phosphate at 6.5% and recycled dust from a subsequent milling step. The resulting slurry was coarsely sprayed into a rotary drum granulator where granules were formed which were passed to a screen to remove oversize and undersize from the product size. The oversize was milled and then re-screened. The undersize was recycled back to the granulater, while the product size (165 SGN) was fed forward through a fluid bed dryer followed by a fluid bed cooler to dry the remaining moisture out of the product and cool it for successful storing.

The results of this burn study are shown in the following Tables 25, 26 and 27.

Results

Spring Burn Study

Tifway 419 Hybrid Bermudagrass

1 Inch Mowing Height

TABLE 25
Relative burn of hybrid bermudagrass as affected by fertilizer
composition. Fertilizers applied May 17, 2004, no water applied
for 24 hours. Burn is reported on a 1-9 scale, with a ‘1’ for
no burn and a ‘9’ for completely brown.

| | N Rate | | | | |
|---|---|---|---|---|---|
| | 3 lbs/1,000 sq. ft | | | | |
| | days after treatment | | | | |
| Composition | 1 | 2 | 4 | 7 | 14 |
| 3064 | 1.5a | 1.0 c | 1.0b | 1.0b | 1.0a |
| 3066 | 1.0a | 3.0ab | 2.3a | 2.5a | 1.0a |
| 4121 | 1.5a | 2.3bc | 2.8a | 2.5a | 1.0a |
| 4122 | 1.3a | 3.3ab | 2.8a | 3.0a | 1.3a |
| 4123 | 1.3a | 4.0a | 2.3a | 2.3a | 1.0a |
| 4124 | 1.3a | 1.8bc | 2.5a | 2.3a | 1.0a |
| 4125 | 1.5a | 1.5bc | 1.0b | 1.0b | 1.0a |

Within each column means followed by the same letter are not significantly different from one another at alpha = 0.10.

With the exception of Composition 4125 (AS-G, 14-0-5) relative burn of the bermudagrass increased as N rate increased. Most of the plots had recovered from any burn by 2 weeks after treatment (3 lb rate). Only Composition 3064 produced burn ratings that were consistently equal to the unfertilized control. Relative burn from the remaining Compositions 3066, 4121, 4122, 4123 and 4125 was often similar, and no one composition was consistently significantly different from the others.

Summer Burn Study

Tifway 419 Hybrid Bermudagrass

1 Inch Mowing Height

TABLE 26
Relative burn of hybrid bermudagrass as affected by Composition.
Fertilizers applied Aug. 3, 2004, no water applied for 24 hours. Burn
is reported on a 1-9 scale, with a ‘1’ for no burn and a
‘9’ for completely brown.

| | N Rate | | | | | | |
|---|---|---|---|---|---|---|---|
| | 3 lbs 1,000 sq. ft | | | | | | |
| | days after treatment | | | | | | |
| Composition | 1 | 2 | 3 | 5 | 7 | 7 (mottle)^{†} | 14 |
| 3064 | 1.3b | 1.0c | 1.3d | 1.0b | 1.0b | 1.0b | 1.3a |
| 3066 | 1.8ab | 2.8ab | 3.3a | 3.5a | 1.8ab | 1.0b | 1.0a |
| 4121 | 2.3ab | 3.3a | 3.0ab | 3.0a | 1.8ab | 1.8a | 1.0a |
| 4122 | 2.0ab | 3.3a | 3.0ab | 3.3a | 2.3a | 1.7a | 1.0a |
| 4123 | 1.8ab | 3.0ab | 3.0ab | 3.3a | 1.8ab | 1.3ab | 1.0a |
| 4124 | 2.8a | 2.8ab | 2.8b | 3.0a | 2.3a | 1.3ab | 1.0a |
| 4125 | 1.5ab | 2.3b | 2.0c | 1.0b | 1.0b | 1.0b | 1.0a |
| 4272 | 1.8ab | 2.3b | 1.8c | 1.8b | 1.0b | 1.3ab | 1.0a |

7 (mottle)^{†} - this is the presence of a yellow-green mottling color caused by fertilizer application. Rated on a 1-9 scale, with a ‘9’ for heavy mottling; ‘1’ for none.
Within each column means followed by the same letter are not significantly different from one another at alpha = 0.10.

As in the spring trial, materials producing limited burn were Composition 3064 and Composition 4125 (AS-G), with burn ratings in those plots often not different from that of the unfertilized control. Differences due to plot burn disappeared by 14 days after application. At 1 week after application the Compositions 3066 (Urea), 4121 (Blend 38-3-4), 4122 (Compd 40-3-4), and 4123 (Compd 39-3-4) all had significant burn damage.

Fall Burn Study

Tifway 419 Hybrid Bermudagrass

TABLE 27
Relative burn of hybrid bermudagrass as affected by composition.
Fertilizers applied Sep. 10, 2004, no water applied for 24 hours.
Burn is reported on a 1-9 scale, with a ‘1’ for no burn and
a ‘9’ for completely brown.

| | N Rate | | | | | |
|---|---|---|---|---|---|---|
| | 4 lbs N/1,000 sq. ft | | | | | |
| | days after treatment | | | | | |
| N Source | 1 | 2 | 3 | 5 | 7 | 14 |
| 3066 | 4.0 a | 4.8 a | 4.3 ab | 5.5 ab | 3.3 ab | 2.3 a |
| 4123 | 2.8 ab | 3.0 b | 5.3 a | 5.0 abc | 3.5 a | 2.5 a |
| 4124 | 2.0 b | 2.5 bc | 4.5 ab | 4.5 bc | 3.0 ab | 2.3 a |
| 4125 | 2.0 b | 2.3 bc | 5.3 a | 6.3 a | 2.5 ab | 2.0 a |
| 4272 | 1.5 b | 1.8 bc | 3.3 b | 4.0 bc | 2.0 b | 1.8 a |
| 10% nitamin | 1.5 b | 1.5 c | 3.5 b | 3.5 c | 2.8 ab | 2.5 a |
| 20% nitamin | 1.8 b | 2.3 bc | 3.3 b | 4.0 bc | 2.0 b | 1.8 a |

7 (mottle)^{†} - this is the presence of a yellow-green mottling color caused by fertilizer application. Rated on a 1-9 scale, with a ‘9’ for heavy mottling; ‘1’ for none.
Within each column means followed by the same letter are not significantly different from one another at alpha = 0.10.

Every composition applied in this example produced burn that was significantly greater than that observed in the unfertilized control (avg=1.0). Least damaged was turf fertilized with the Composition 4272 (Nurea-G 33-3-3). While these differences were not always significant they were consistent.

Turf damage was still present at the 14 DAT ratings, but this more a factor of slow turf growth than continued burn from N release. This Fall study was started in September, and as the bermudagrass entered dormancy it slowed growth, preventing its' recovery from burn.

TABLE 28
Dry weight of clippings (grams per plot) as affected by N source and
N rate and sampling date. Compositions applied at 2 lbs N 1,000 ft⁻².
Compositions applied on May 17, 2004 and Aug. 3, 2004.

| | date of clipping harvest | | | | | |
|---|---|---|---|---|---|---|
| Composi- | grams dry weight per plot | | | | | |
| tions | May 24 | June 2 | June 9 | June 16 | June 23 | June 29 |
| 3064 | 31 a | 24 a | 8.6 bc | 33 a | 26 c | 34 c |
| 3066 | 37 a | 25 a | 10.6 ab | 20 b | 34 abc | 42 abc |
| 3067 | 27 a | 25 a | 11.6 a | 28 ab | 36 abc | 49 a |
| 4121 | 34 a | 29 a | 11.4 a | 25 ab | 26 c | 40 abc |
| 4122 | 31 a | 21 a | 8.6 bc | 20 b | 26 c | 37 abc |
| 4123 | 25 a | 22 a | 9.3 abc | 17 b | 29 bc | 35 bc |
| 4124 | 36 a | 28 a | 11.0 a | 25 ab | 42 ab | 48 ab |
| 4125 | 26 a | 22 a | 7.4 c | 26 ab | 46 a | 47 abc |

| | date of clipping harvest | | | | | |
|---|---|---|---|---|---|---|
| | grams dry weight per plot | | | | | |
| Compositions | July 7 | July 14 | July 22 | total - 1 | Aug 11 | Aug 18 |
| 3064 | 29 bc | 35 a | 27 ab | 248 abc | 25 a | 22 ab |
| 3066 | 44 a | 39 a | 23 ab | 274 ab | 21 abc | 13 c |
| 3067 | 25 bc | 43 a | 23 ab | 267 abc | 17 bcd | 15 bc |
| 4121 | 27 bc | 39 a | 24 ab | 256 abc | 19 abc | 21 ab |
| 4122 | 26 bc | 28 a | 22 ab | 219 bc | 24 ab | 26 a |
| 4123 | 22 c | 32 a | 21 b | 210 c | 15 cd | 18 bc |
| 4124 | 40 ab | 45 a | 30 a | 303 a | 16 cd | 17 bc |
| 4125 | 29 bc | 36 a | 23 ab | 263 a | 9.9 d | 15 bc |

| | date of clipping harvest | | | | |
|---|---|---|---|---|---|
| | grams dry weight per plot | | | | |
| Compositions | Aug 25 | Sept 3 | Sept 10 | Sept 20 | total - 2 |
| 3064 | 62 abc | 27 a | 44 ab | 27 a | 207 a |
| 3066 | 63 abc | 28 a | 56 a | 21 abc | 203 a |
| 3067 | 73 ab | 28 a | 51 ab | 23 abc | 207 a |
| 4121 | 65 abc | 24 a | 36 bc | 20 abc | 185 a |
| 4122 | 56 bc | 26 a | 35 bc | 24 abc | 182 a |
| 4123 | 54 c | 18 a | 53 a | 18 bc | 175 a |
| 4124 | 75 a | 27 a | 58 a | 24 ab | 217 a |
| 4125 | 56 bc | 25 a | 22 c | 16 c | 144 b |

Within each column means followed by the same letter are not significantly different from one another at alpha = 0.10.
Total = summation of weekly clipping yields for each treatment (within that fertilizer application period)

TABLE 29
Dry weight of clippings (grams per plot) as affected by composition
and sampling date. Fertilizers applied at 1 lb N 1,000 ft⁻².
Fertilizers applied on May 17, 2004 and Aug. 3, 2004.

| | date of clipping harvest | | | | | |
|---|---|---|---|---|---|---|
| | grams dry weight per plot | | | | | |
| Composition | May 24 | June 2 | June 9 | June 16 | June 23 | June 29 |
| 3064 | 18 a | 20 b | 7.9 a | 12 a | 19 a | 28 a |
| 3066 | 21 a | 27 a | 6.6 a | 13 a | 14 a | 21 b |
| 4123 | 16 a | 19 b | 5.6 a | 10 a | 15 a | 22 b |
| | date of clipping harvest | | | | | |
| | grams dry weight per plot | | | | | |
| Composition | July 7 | July 14 | July 22 | total - 1 | Aug 11 | Aug 18 |
| 3064 | 22 a | 30 a | 15 a | 172 a | 7.5 a | 13 a |
| 3066 | 16 a | 17 a | 13 a | 148 a | 10.4 a | 11 a |
| 4123 | 18 a | 24 a | 14 a | 144 a | 7.3 a | 12 a |

| | date of clipping harvest | | | | |
|---|---|---|---|---|---|
| | grams dry weight per plot | | | | |
| Composition | Aug 25 | Sept 3 | Sept 10 | Sept 20 | total - 2 |
| 3064 | 52 a | 22 a | 37 a | 17 a | 150 a |
| 3066 | 43 a | 22 a | 30 a | 19 a | 135 a |
| 4123 | 45 a | 22 a | 38 a | 18 a | 142 a |

Within each column means followed by the same letter are not significantly different from one another at alpha = 0.10.

### CONCLUSIONS

1. None of the evaluated compositions had substantially different responses in dry weight of clippings. Of the compositions, none behaved (over time) significantly different than Compositions 3064 (Scott's Turf Builder), 3066 (Urea), or 3067 (ammonium sulfate).

2. Significant increases in turf growth (as measured by clipping yield) were determined for 8 weeks). These responses were most prevalent at the higher N rate (2 lb), and not the lower (1 lb).

While only a few exemplary embodiments of this invention have been described in detail, those skilled in the art will recognize that there are many possible variations and modifications which may be made in the exemplary embodiments while yet retaining many of the novel and advantageous features of this invention. Accordingly, it is intended that the following claims cover all such modifications and variations.

What is claimed is:

1. An extended release fertilizer comprising:
particles of an absorbent material containing capillaries/voids between 10-200 microns in cross-sectional diameter which is impregnated in an amount of 40-95% of the capillaries/voids volume with an agriculturally beneficial material, at least including calcium sulfate and said beneficial material being selected from the group consisting of fertilizers, insecticides, herbicides and fungicides, and said particles of absorbent material being agglomerated into granules.

2. The controlled release agricultural absorbent based product of claim 1 wherein said fertilizer is selected from the group consisting of nitrogen compounds, phosphorous compounds and potassium compounds.

3. The controlled release agricultural absorbent based product of claim 1 wherein the particles are agglomerated into granules having a size of 0.2-25 mm in diameter.

4. The controlled release agricultural absorbent based product of claim 1 wherein the particles are agglomerated into granules having a size of 1-4 mm in diameter.

5. The controlled release agricultural absorbent based product of claim 1 wherein the absorbent material is selected from the group consisting of expanded perlite, shredded newspaper, saw dusts, cotton lint, ground corn cobs, corn cob flower, Metrecz absorbent and diatomaceous earth.

6. The controlled release agricultural absorbent based product of claim 1, wherein the absorbent is impregnated in an amount of 70-95% wt of the agricultural beneficial material.

7. The controlled release agricultural absorbent based product of claim 1, wherein the absorbent particles are 100-1500 microns in diameter.

8. The controlled release agricultural absorbent based product of claim 1, wherein the calcium sulfate is present in an amount of 1-40% wt.

9. The controlled release agricultural absorbent based product of claim 1, wherein the calcium sulfate compound is selected from the group consisting of calcium sulfate dihydrate, anhydrous calcium sulfate, and hemihydrate calcium sulfate.

10. The controlled release agricultural absorbent based product of claim 2, wherein the nitrogen compound is selected from the group consisting of urea, ammonia, ammonium nitrate, ammonium sulfate, calcium nitrate, diammonium phosphate, monoammonium phosphate, potassium nitrate and sodium nitrate.

11. The controlled release agricultural absorbent based product of claim 2, wherein the phosphorous compounds are selected from the group consisting of diammonium phosphate, monoammonium phosphate, monopotassium phosphate, dipotassium phosphate, tetrapotassium pyrophosphate, and potassium metaphosphate.

12. The controlled release agricultural absorbent based product of claim 2, wherein the potassium compound is selected from the group consisting of potassium chloride, potassium nitrate, potassium sulfate, monopotassium phosphate, dipotassium phosphate, tetrapotassium pyrophosphate, and potassium metaphosphate.

13. The controlled release agricultural absorbent based product of claim 1, wherein the fertilizer contains nitrogen, phosphorous and potassium compounds in a ratio selected from the group consisting of 29-3-4, 16-4-8, 10-10-10, 15-5-10, 15-0-15, 22-3-14, 20-28-5 and 12-6-6.

14. A controlled release agricultural product comprising:
a mixture of a control release holding substance selected from the group consisting of plant starches, protein gels, glues, gumming compositions, crystallizing compounds, gelling clays and synthetic gel forming compounds; and
an agriculturally beneficial, at least including calcium sulfate, said agriculturally beneficial material being selected from the group consisting of fertilizers, insecticides, herbicides and fungicides, said agricultural product being in a particulate form, agglomerated into granules.

15. The controlled release agricultural product of claim 14 wherein the holding substance is 4-8% wt of the agricultural product.

16. The controlled release agricultural product of claim 14 wherein the holding substance is a starch selected from the group consisting of corn starch, rice starch, potato starch, wheat starch, tapioca starch, starch containing D-glucopyranose polymers, amylose and amylopectin. starch acetates, starch esters, starch ethers, starch phosphates

17. The controlled release agricultural product of claim 14 wherein the interspatial blocker is corn starch or wheat starch.

18. The controlled release agricultural product of claim 14 wherein the starches are modified by acetylation, chlorination, acid hydrolysis or enzymatic action.

19. The controlled release agricultural product of claim 14 wherein the holding substance is a starch selected from the group consisting of starch acetates, starch esters, starch ethers and starch phosphates.

20. The controlled release agricultural product of claim 14 wherein the holding substance is a gelatin made by hydrolysis of collagen.

21. The controlled release agricultural product of claim 14 wherein the holding substance is a glue made from a material selected from the group consisting of collagen, casein, blood and vegetable protein.

22. The controlled release agricultural product of claim 14 wherein the holding substance is a gumming composition selected from the group consisting of cellulosics, rubber latex, gums, terpene resins, mucilages, asphalts, pitches and hydrocarbon resins.

23. The controlled release agricultural product of claim 14 wherein the holding substance is a crystallizing compound selected from the group consisting of sodium silicate, phosphate cements, calcium-oxide cements and hydraulic cements.

24. The controlled release agricultural product of claim 14 wherein the holding substance is a synthetic gel forming compound selected from the group consisting of polysulfide sealants, polyethylene, isobutylene, polyamides, polyvinyl acetate, epoxy, phenolformaldehyde, urea formaldehyde, polyvinyl butyral, cyanoacrylates and silicone cements.

25. The controlled release agricultural product of claim 14 wherein the interspatial blocker is a gelling clay.

26. The controlled release agricultural product of claim 14, wherein the fertilizer is secondary nutrients selected from the group consisting of sulfur, calcium and magnesium.

27. The controlled release agricultural product of claim 14, wherein the calcium sulfate is present in an amount of 1-40% wt.

28. The controlled release agricultural product of claim 14, wherein the calcium sulfate compound is selected from the group consisting of calcium sulfate dihydrate, anhydrous calcium sulfate, and hemihydrate calcium sulfate.

29. The controlled release agricultural product of claim 14, wherein the fertilizer is micronutrients selected from the group consisting of boron, copper, iron, manganese, molybdenum and zinc.

30. The controlled release agricultural product of claim 14, wherein the fertilizer is selected from the group consisting of nitrogen compounds, phosphorous compounds and potassium compounds.

31. The controlled release agricultural product of claim 30, wherein the nitrogen compounds are selected from the group consisting of urea, ammonia, ammonium nitrate, ammonium sulfate, calcium nitrate, diammonium phosphate, monoammonium phosphate, potassium nitrate and sodium nitrate.

32. The controlled release agricultural product of claim 30, wherein the phosphorous compounds are selected from the group consisting of diammonium phosphate, monoammonium phosphate, monopotassium phosphate, dipotassium phosphate, tetrapotassium pyrophosphate, and potassium metaphosphate.

33. The controlled release agricultural product of claim 30, wherein the potassium compound is selected from the group consisting of potassium chloride, potassium nitrate, potassium sulfate, monopotassium phosphate, dipotassium phosphate, tetrapotassium pyrophosphate, and potassium metaphosphate.

34. The controlled release agricultural product of claim 30, wherein the fertilizer contains nitrogen, phosphorous and potassium compounds in a ratio selected from the group consisting of 29-3-4, 16-4-8, 10-10-10, 15-5-10, 15-0-15, 22-3-14, 20-28-5 and 12-6-6.

35. The controlled release agricultural product of claim 14, wherein the fertilizer is a growth regulator selected from the group consisting of potassium azide, 2 amino-4-chloro-6-methylpyrimidine, N-2,5-dicorphenyl succinamide, 4-amino-1, and 2,4-triazole hydrochloride.

36. The controlled release agricultural product of claim 14, wherein the fertilizer is a nitrification regulator selected from the group consisting of 2-chloro-6 trichloromethyl)pyridine, sulfathiazole, dicyandiamide, thiourea, and guanylthiourea.

37. The controlled release agricultural product of claim 14, wherein the insecticide is 0,0-diethyl O-(2-isopropyl-6 methyl-4 pyrimidinyl) phosphorothioate).

38. An extended release fertilizer comprising:
particles of an absorbent material containing capillaries/voids between 10-200 microns in cross-sectional diameter which is impregnated in an amount of 40-95% of the capillaries/voids volume with an agriculturally beneficial material, said beneficial material being selected from the group consisting of fertilizers, insecticides, herbicides and fungicides; and
said particles of absorbent material being agglomerated with particles of calcium sulfate into granules.

39. The controlled release agricultural absorbent based product of claim 38 wherein said fertilizer is selected from the group consisting of nitrogen compounds, phosphorous compounds and potassium compounds.

40. The controlled release agricultural absorbent based product of claim 38 wherein the particles are agglomerated into granules having a size of 0.2-25 mm in diameter.

41. The controlled release agricultural absorbent based product of claim 38 wherein the particles are agglomerated into granules having a size of 1-4 mm in diameter.

42. The controlled release agricultural absorbent based product of claim 38 wherein the absorbent material is selected from the group consisting of expanded perlite, shredded newspaper, saw dusts, cotton lint, ground corn cobs, corn cob flower, Metrecz absorbent and diatomaceous earth.

43. The controlled release agricultural absorbent based product of claim 38, wherein the absorbent is impregnated in an amount of 70-95% wt of the agricultural beneficial material.

44. The controlled release agricultural absorbent based product of claim 38, wherein the absorbent particles are 100-1500 microns in diameter.

45. The controlled release agricultural absorbent based product of claim 38, wherein the calcium sulfate is present in an amount of 1-40% wt.

46. The controlled release agricultural absorbent based product of claim 38, wherein the calcium sulfate compound is selected from the group consisting of calcium sulfate dihydrate, anhydrous calcium sulfate, and hemihydrate calcium sulfate.

47. The controlled release agricultural absorbent based product of claim 39, wherein the nitrogen compound is selected from the group consisting of urea, ammonia, ammonium nitrate, ammonium sulfate, calcium nitrate, diammonium phosphate, monoammonium phosphate, potassium nitrate and sodium nitrate.

48. The controlled release agricultural absorbent based product of claim 39, wherein the phosphorous compounds are selected from the group consisting of diammonium phosphate, monoammonium phosphate, monopotassium phosphate, dipotassium phosphate, tetrapotassium pyrophosphate, and potassium metaphosphate.

49. The controlled release agricultural absorbent based product of claim 39, wherein the potassium compound is selected from the group consisting of potassium chloride, potassium nitrate, potassium sulfate, monopotassium phosphate, dipotassium phosphate, tetrapotassium pyrophosphate, and potassium metaphosphate.

50. The controlled release agricultural absorbent based product of claim 38, wherein the fertilizer contains nitrogen, phosphorous and potassium compounds in a ratio selected from the group consisting of 29-3-4, 16-4-8, 10-10-10, 15-5-10, 15-0-15, 22-3-14, 20-28-5 and 12-6-6.

51. A controlled release agricultural absorbent based product comprising:
particles of exfoliated perlite as an absorbent material, containing capillaries/voids between 10-200 microns in cross-sectional diameter, which is impregnated in an amount of 40-95% of the capillaries/voids volume with a mixture of an interspatial blocker and an agriculturally beneficial material, at least including calcium sulfate, said beneficial material being selected from the group consisting of fertilizers, insecticides, herbicides and fungicides and said particles of absorbent material being agglomerated into granules.

52. A controlled release agricultural product comprising urea and calcium sulfate dihydrate in granular form.

53. The controlled release agricultural product of claim 52, wherein the product further contains an agriculturally beneficial material being selected from the group consisting of fertilizers, insecticides, herbicides and fungicides

54. The controlled release agricultural product of claim 52, wherein the calcium sulfate dihydrate is present in an amount of 1-40% wt.

55. The controlled release agricultural product of claim 53 wherein said fertilizer is selected from the group consisting of nitrogen compounds, phosphorous compounds and potassium compounds.

56. A controlled release agricultural product comprising ammonium sulfate and calcium sulfate dihydrate in granular form.

57. The controlled release agricultural product of claim 56, wherein the product further contains an agriculturally beneficial material being selected from the group consisting of fertilizers, insecticides, herbicides and fungicides

58. The controlled release agricultural product of claim 56, wherein the calcium sulfate dihydrate is present in an amount of 1-40% wt.

59. The controlled release agricultural product of claim 57 wherein said fertilizer is selected from the group consisting of nitrogen compounds, phosphorous compounds and potassium compounds.

60. A controlled release agricultural product comprising urea, ammonium sulfate and calcium sulfate dihydrate in granular form.

61. The controlled release agricultural product of claim 60, wherein the product further contains an agriculturally beneficial material being selected from the group consisting of fertilizers, insecticides, herbicides and fungicides

62. The controlled release agricultural product of claim 60, wherein the calcium sulfate dihydrate is present in an amount of 1-40% wt.

63. The controlled release agricultural product of claim 61 wherein said fertilizer is selected from the group consisting of nitrogen compounds, phosphorous compounds and potassium compounds.

64. A process for preparing a controlled release agricultural absorbent based product comprising the following steps:
introducing a predetermined amount of water to particles of absorbent material containing capillaries/voids between 10-200 microns in cross-sectional diameter, to result in absorption of water within the absorbent material;
heating the absorbent particles and water to transform the water within the absorbent particles to steam;
introducing the heated absorbent particles to an agriculturally beneficial material, at least including calcium sulfate, and said beneficial material being selected from the group consisting of fertilizers, insecticides, herbicides and fungicides for blending to essentially saturate the absorbent particles with the agriculturally beneficial material; and
granulating the combination of agriculturally beneficial material and saturated absorbent particles to solidify and harden the mixture within the absorbent particles and outside the particles, resulting in the agglomeration of absorbent particles into granules.

65. The process of claim 64 further comprising the step of drying said granules.

66. The process of claim 64 wherein undersized particles result from the screening step and are recycled back to the granulator where they agglomerate among themselves and among the incoming combination of agriculturally beneficial material and saturated absorbent particles.

67. The process of claim 64 wherein the combination of agriculturally beneficial material and saturated absorbent particles is introduced into the granulator by spraying means.

68. The process of claim 64 wherein the absorbent material is particles of perlite and the step of heating the absorbent particles and water to transform the water within the absorbent particles to steam, acts to exfoliate the perlite for improved subsequent adsorption of the agriculturally beneficial material.

69. A process for preparing a controlled release agricultural absorbent based product comprising the following steps:
introducing a predetermined amount of water to particles of absorbent material containing capillaries/voids between 10-200 microns in cross-sectional diameter, to result in absorption of water within the absorbent material;
heating the absorbent particles and water to transform the water within the absorbent particles to steam;
mixing an interspatial blocker material and an agriculturally beneficial material, at least including calcium sulfate, and said beneficial material being selected from the group consisting of fertilizers, insecticides, herbicides and fungicides;
introducing the heated absorbent particles to the mixture of agriculturally beneficial material and interspatial blocker for blending to essentially saturate the absorbent particles with the mixture of agriculturally beneficial material and interspatial blocker; and
granulating the combination of agriculturally beneficial material, interspatial blocker and saturated absorbent particles to solidify and harden the mixture within the absorbent particles and outside the particles, resulting in the agglomeration of absorbent particles into granules.

70. The process of claim 69 further comprising the step of drying said granules.

71. The process of claim 69 wherein the absorbent material is particles of perlite and the step of heating the absorbent particles and water to transform the water within the absorbent particles to steam, acts to exfoliate the perlite for improved subsequent adsorption of the agriculturally beneficial material.

72. The process of claim 69, wherein the steps of combining water and the absorbent particles and then heating the combined absorbent particles and water to transform the water within the absorbent particles to steam are replaced by the step of directly introducing hot steam to the absorbent particles in order to produce absorbent particles containing steam.

73. A process for preparing a controlled release agricultural product comprising the following steps:
mixing a control release holding substance selected from the group consisting of plant starches, protein gels, glues, gumming compositions, crystallizing compounds, gelling clays and synthetic gel forming compounds with an agriculturally beneficial material in an aqueous solution or molten state, at least including calcium sulfate, said agriculturally beneficial material being selected from the group consisting of fertilizers, insecticides, herbicides and fungicides;
blending the mixture of agriculturally beneficial material and holding substance; and
granulating the combination of agriculturally beneficial material and holding substance to solidify and harden the mixture, resulting in granules.

74. The process of claim 73 further comprising the step of drying said granules.

75. The process of claim 73 wherein the holding substance is a starch selected from the group consisting of corn starch, rice starch, potato starch, wheat starch, tapioca starch, starch containing D-glucopyranose polymers, amylose and amylopectin. starch acetates, starch esters, starch ethers, starch phosphates

76. The process of claim 73 wherein the holding substance is corn starch or wheat starch.

77. The process of claim 73 wherein the starches are modified by acetylation, chlorination, acid hydrolysis or enzymatic action.

78. The process of claim 73 wherein the holding substance is a starch selected from the group consisting of starch acetates, starch esters, starch ethers and starch phosphates.

79. The process of claim 73 wherein the holding substance is a crystallizing compound selected from the group consisting of sodium silicate, phosphate cements, calcium-oxide cements and hydraulic cements.

80. The process of claim 73 wherein the holding substance is a synthetic gel forming compound selected from the group consisting of polysulfide sealants, polyethylene, isobutylene, polyamides, polyvinyl acetate, epoxy, phenolformaldehyde, urea formaldehyde, polyvinyl butyral, cyanoacrylates and silicone cements.

81. The process of claim 73 wherein the calcium sulfate is present in an amount of 1-40% wt.

82. The process of claim 73 wherein the calcium sulfate compound is selected from the group consisting of calcium sulfate dihydrate, anhydrous calcium sulfate, and hemihydrate calcium sulfate.

83. The process of claim 73 wherein the combination of agriculturally beneficial material and holding substance is heated while blending.

84. The process of claim 73 wherein the granulated combination of agriculturally beneficial material and holding substance is screened to result in granules of a predetermined diameter.

85. The process of claim 73 wherein the combination of agriculturally beneficial material and holding substance is introduced into the granulator by spraying means.

86. The process of claim 73 wherein the heating of the absorbent particles and water occurs in a heat exchanger.

87. The process of claim 73 wherein the combination of agriculturally beneficial material and holding substance are solidified and hardened by a loss of heat and/or increase of concentration of the agriculturally beneficial material and/or formation of a chemical hydrate within the granule

88. A process for preparing a controlled release agricultural product comprising the following steps:
mixing solutions or melts of an agriculturally beneficial material with calcium sulfate; and
cooling and granulating the resulting mixture to a granular solid, wherein the calcium sulfate is dispersed within the granular solid, being inter-crystallized within the solid.

89. The process of claim 88 wherein the agriculturally beneficial material is ammonium sulfate, urea, or mixtures thereof.
